(19) United States
(12) Patent Application Publication
(10) Pub. No.: US 2019/0020578 A1
(43) Pub. Date: Jan. 17, 2019

(54) Routing System

(71) Applicants: Clemens Beckmann, Köln (DE); Karin Pientka, Bonn (DE); Lutz Fischer, Bonn (DE); Lars Krämer, Bonn (DE); Jens Vygen, Bonn (DE); Stephan Held, Niederkassel (DE); Dirk Müller, Bornheim (DE)

(72) Inventors: Clemens Beckmann, Köln (DE); Karin Pientka, Bonn (DE); Lutz Fischer, Bonn (DE); Lars Krämer, Bonn (DE); Jens Vygen, Bonn (DE); Stephan Held, Niederkassel (DE); Dirk Müller, Bornheim (DE)

(21) Appl. No.: 15/648,630

(22) Filed: Jul. 13, 2017

Related U.S. Application Data
(63) Continuation of application No. PCT/EP2017/067550, filed on Jul. 12, 2017.

(51) Int. Cl. H04L 12/717; H04L 12/721; H04L 12/707; H04L 12/751

(52) U.S. Cl. CPC H04L 45/42; H04L 45/14; H04L 45/22; H04L 45/245; H04L 45/12; H04L 45/24; H04L 45/02

(57) ABSTRACT

A method for routing is disclosed. The method involves obtaining information on a plurality of to-be-transported entities (TBTEs) that are each associated with a respective pick-up position and a respective drop-off position; determining a set of one or more transport routes (TRs), each of the TRs associated with a respective transport entity (TE) and defining a respective sequence of waypoints, wherein the set of TRs is determined to at least fulfil a criterion that, for each of the TBTEs, the pick-up position and drop-off position are associated with respective waypoints of the same respective TR or the pick-up position is associated with a respective waypoint of one TR and the drop-off position is associated with a respective waypoint of another TR that is connected with the one TR; and providing respective representations of at least a part of the TRs to the respective TEs associated with the TRs.

### CROSS-REFERENCE TO RELATED PATENT APPLICATION

This patent application is a continuation of PCT/EP2017/067550, filed Jul. 12, 2017, the entire teachings and disclosure of which are incorporated herein by reference thereto.

### FIELD OF THE DISCLOSURE

The invention relates to the field of routing, in particular to methods, apparatuses, systems and computer programs for determining transport routes (TR) for a plurality of transport entities (TEs) that handle pick-up and drop-off of a plurality of to-be-transported entities (TBTEs).

### BACKGROUND

Nowadays, several application fields can be identified where routing, which is understood in this specification as a process of determining TRs for respective TEs (e.g. vehicles) that handle pick-up and drop-off TBTEs, has to be performed for large numbers of TBTEs. Exemplary application fields are parcel delivery, where the TBTE are parcels, or passenger transportation, where the TBTEs are persons.

### SUMMARY OF SOME EXAMPLE EMBODIMENTS OF THE INVENTION

One of the major problems of routing is the computational complexity involved in the determining of the TRs. As an example, when assuming that n positions have to be visited by a TR, (n−1)!/2 different possibilities/sequences of positions exist for this TR (so-called Travelling-Salesman-Problem, TSP). For instance, in the application field of parcel delivery, a usual number of parcels to be delivery via a single TR per day amounts n=200. For delivery of these parcels, 1.97×10³⁷² different TRs exist. Finding the optimum TR among these various possibilities is computationally infeasible with existing hardware. Even worse, before finding a TR for a defined set of TBTEs (e.g. all parcels to be delivered on one day), the TBTEs of an even larger set of TBTEs have to be assigned to respective sets of TBTEs that are then handled by respective TEs. This increases the computational complexity even further.

If routing shall be deployed in real-world scenarios, thus heuristic approaches are required that reasonably trade computational complexity against optimality of the solution produced.

Therein, the produced TRs preferably should, besides fulfilling various types of restrictions such as for instance geographic/traffic restrictions, load capacity restrictions of the TEs and/or time restrictions of the TBTEs, aim at low energy consumption and/or pollution caused by the TEs.

Further preferably, the routing should be flexible and support ad-hoc addition of TBTEs and/or change of their characteristics even after the TRs have already been determined and possibly started.

It is thus inter alia an object of the invention to provide a routing approach that addresses one or more of these problems.

Example embodiments of the invention provide solutions to one or more of these problems. In particular, a routing approach is provided with one or more of the following characteristics:
Applicability in real-world scenarios with limited computing time (in the order of less than 2 minutes on a state-of-the-art server processor, such as for instance an Intel Xeon E5-2699 v4 with 2.2-3.6 GHz, for determining TRs for 1000 TBTEs);
Production of short and/or energy-optimized TRs and/or of TRs that are range-optimized for the respective transport entity that conducts the respective TR;
Provision for ad-hoc (e.g. at least close to real-time) addition of TBTEs to an already determined set of TRs and/or ad-hoc (e.g. at least close to real-time) change of characteristics of TBTEs that are already considered in an already determined set of TRs (in the order of a few seconds (e.g. less than 10 seconds) on a state-of-the-art server processor, such as for instance an Intel Xeon E5-2699 v4 with 2.2-3.6 GHz);
Support of secondary TRs that branch off from a main TR and flexibly deploy different TEs than the main TR (in particular TEs from a third party, such as TEs organized via crowd-sourcing), which becomes possible by exchanging at least some of the TBTEs of the main TR between a TE of the main TR and a respective TE of the secondary TR;
Flexible consideration, in the routing process, of a current position and a type of a TE and of a willingness of the TE or of an entity associated with the TE to conduct a potential TR, in particular to allow for secondary TRs;
Consideration, in the routing process, of information related to actual presence of TBTEs or of persons associated with TBTEs at planned pick-up and/or drop-off positions, to reduce the probability that pick-ups or drop-offs are unsuccessful and need to be made up for later by new TRs;
   First Aspect: Routing with Isolated or Connected TRs

According to a first exemplary aspect of the invention, a method for routing is disclosed, the method performed by one or more apparatuses and comprising:
obtaining information on a plurality of TBTEs that are each associated with a respective pick-up position and a respective drop-off position;
determining, for the plurality of TBTEs and based on routing information, a set of one or more TRs, each of the TRs of the set of TRs associated with a respective TE and defining a respective sequence of waypoints, wherein the set of TRs is determined to at least fulfil a criterion that, for each of the TBTEs of the plurality of TBTEs, the pick-up position and drop-off position are associated with respective waypoints of the same respective TR of the set of TRs or the pick-up position is associated with a respective waypoint of one TR of the set of TRs and the drop-off position is associated with a respective waypoint of another TR of the set of TRs that is directly connected or connected via one or more other TRs of the set of TRs with the one TR; and
providing respective representations of at least a part of the TRs of the set of one or more TRs to the respective TEs associated with the TRs of the set of TRs or to respective devices associated with the respective TEs, in particular to cause that the TEs follow or are operated, by respective operators, to follow the respective TRs of the set of TRs.

The method may for instance be performed by a single apparatus, which may for instance be a server or another type of computer. Equally well, the method may be jointly performed by a plurality of apparatuses together forming a system, e.g. by a plurality of servers of a server cloud or by a plurality of cores of a computer or server. The one or more apparatuses may comprise means for obtaining the information on the plurality of TBTEs, means for the determining of the set of one or more TRs, and means for providing respective representations of at least a part of the TRs to the respective TEs or respective devices associated with the respective TEs.

The TBTEs may for instance be objects, such as shipments (e.g. parcels), or persons, e.g. passengers of a transportation system. For each TBTE, a respective pick-up position is defined where the TBTE shall be picked up, and a respective drop-off position is defined where the TBTE shall be dropped off (e.g. delivered in case of a shipment). The pick-up position and drop-off position of a TBTE may for instance be associated with the TBTE via a data set in which an identifier of the TBTE as well as the pick-up and drop-off positions are contained. The information on the plurality of TBTEs may for instance comprise a plurality of respective such data sets for each of the TBTEs. This information may for instance be obtained from one or more other apparatuses, e.g. received via a communication network, such as for instance the Internet. The information on the plurality of TBTEs may for instance be obtained from an administration system where requests for pick-up and/or delivery of TBTEs are received and/or processed. In case of the TBTEs being shipments, the respective pick-up positions or the respective drop-off positions of at least some (or all) of the TBTEs may for instance be a position of a logistics depot, such as for instance a shipment hub of a logistics system.

For the plurality of TBTEs, and based on routing information, a set of one or more TRs is determined. This may for instance be triggered by the obtaining of the (complete) information on the plurality of TBTEs. Each of the TRs is associated with a respective TE, which may for instance be an apparatus (in particular a vehicle or robot) or a person. The TE is meant to follow the TR, including sequentially visiting the waypoints and stopping at waypoints if required, so that pick-ups and drop-offs of TBTEs can take place, for instance supported by a respective operator of the TE. For instance, the TE may be an autonomously or semi-autonomously moving apparatus, e.g. a vehicle or robot, and may be controlled by the representation of at least a part of the TR provided to it. In this case, for instance also the pick-up or drop-off process may be performed by the apparatus and accordingly controlled by the representation of at least a part of the TR provided to it. Alternatively, the TE may be controlled by an operator (e.g. a driver or pilot), wherein the operator is caused by the representation of at least a part of the TR (that is for instance presented to him/her after reception at a device associated with him/her) to follow the TR.

Different TRs of the set of one or more TRs may be associated with different types of TEs.

The routing information may for instance comprise map information at least identifying a road network, for instance with associated driving restrictions (e.g. one-way drives, etc.). The routing information may further comprise real-time traffic information, e.g. on current traffic jams or road construction. The routing information may for instance have been specifically pre-processed to be used in the determining of the set of one or more TRs. Consideration of the routing information may for instance safeguard that the TRs are based on existing roads and can be followed in reality without violating traffic regulations. The routing information may for instance be a base graph (e.g. obtained from a commercial map provider) and one or more sets of restrictions that may for instance be specific for the types of TEs. The routing information may for instance be independent of the respective pick-up and/or drop-off positions of the plurality of TBTEs.

Each TR defines a sequence of waypoints. The waypoints may for instance comprise a start position (e.g. of a depot), an end position (e.g. of a depot), one or more positions associated with respective pick-up positions (which may include the depot position), one or more positions associated with respective drop-off positions (which may include the depot position), exchange points, etc. A TR may for instance comprise or a first sub-sequence of one or more waypoints associated with pick-up positions, followed by a second sub-sequence of one or more waypoints associated with drop-off positions, or vice versa. This is however not mandatory, in particular sequences in which waypoints associated with pick-up positions and waypoints associated with drop-off positions are mixed (e.g. a pick-up waypoint followed by two drop-off waypoints followed by two pick-up waypoints followed by a drop-off waypoint etc.) are well possible. A TR may for instance comprise more waypoints than the waypoints that are associated with pick-up positions and/or drop-off positions. A pick-up position or a drop-off position of a TBTE may be associated with a waypoint in a way that the respective position is or is at least close to (e.g. less than 100 m) the waypoint. This may account for the fact that a TE associated with a TR may not be able to exactly reach each pick-up position or drop-off position, and may thus have to stop in a certain distance therefrom, for instance if the pick-up or drop-off position is a position at the end of a road that is not allowed to be accessed by the TE, so that an operator of the TE has to stop at the beginning of the road (which constitutes the waypoint then).

A TR may not only define the sequence of waypoints, but also define a timing, for instance a timing of at least one of the waypoints, e.g. a time or time window when pick-up or drop-off is possible at the pick-up/drop-off position associated with the waypoint (e.g. since the TBTE (e.g. a passenger) or an entity associated with the TBTE (e.g. a shipment) is only at this time or in this time window at the pick-up/drop-off position associated with the waypoint).

A TR may for instance also comprise information, for at least some (or all) of its waypoints, on the one or more TBTEs having respective pick-up positions or drop-off positions associated with the respective waypoint. For instance, with each waypoint (associated with a pick-up and/or drop-off position), respective identifiers of the TBTEs having respective pick-up and/or drop-off positions associated with the respective waypoint may be stored.

A TR may for instance further comprise navigation instructions indicating on how each waypoint of the sequence of waypoints may be reached. This navigation instructions may for instance be used by an autonomous or semi-autonomous TE to follow the route, or may be presented via a navigation device associated with the TE (e.g. since it is contained in the TE or since it is used by an operator of the TE) to an operator of the TE to cause the operator to control the TE to follow the TR.

Representations of at least a part of the TRs of the set of TRs may be provided together with information on where/when (e.g. at the latest) to pick up and/or drop off which TBTE for each respective TR. The representations are provided to TEs or to devices associated with TEs (e.g. associated via an operator/driver of the TE), e.g. to a handheld scanner or a mobile phone of an operator/driver associated with the TE.

The set of one or more TRs determined by the determining may fulfil one or more criteria. According to one of the one or more criteria, for each of the TBTEs of the plurality of TBTEs, one of the following two cases has to hold:
the pick-up position and drop-off position are associated with respective waypoints of the same respective TR of the set of TRs or
the pick-up position is associated with a respective waypoint of one TR of the set of TRs and the drop-off position is associated with a respective waypoint of another TR of the set of TRs that is directly connected or connected via one or more other TRs of the set of TRs with the one TR.

In the first case, a TBTE is picked up and dropped off by the same TE. In the second case, at least two different TEs (associated with respective TRs) are used for pick-up and drop-off of the TBTE. In the second case, for instance three different TEs may be involved. A first TE, associated with a first TR, is responsible for pick-up of the TBTE, a second TE, associated with a second TR directly connected to the first TR, receives the TBTE from the first TE, for instance at an exchange position that is a waypoint of both the first TR and the second TR, and a third TE, associated with a third TR directly connected to the second TR, receives the TBTE from the second TE, for instance at an exchange position that is a waypoint of both the second TR and the third TR. In this example, the first TR and third TR are thus indirectly connected via the second TR.

Since the determining of the set of one or more TRs is based on the routing information, it is ensured that the TRs are based on traffic channels (e.g. roads) that actually exist and can be used without violating traffic regulations.

The determining of the set of one or more TRs may comprise several processing stages that will be explained in further detail below, for instance a map pre-processing stage (or at least a part thereof), a clustering stage, a post-optimization stage and a merging stage.

Respective representations of at least a part of the TRs of the set of one or more TRs are then provided (e.g. transmitted via a communication network, e.g. by pushing or pulling) to the respective TEs associated with the TRs of the set of TRs or to respective devices (e.g. navigation devices) associated with the respective TEs (e.g. associated with the respective operators of the TEs and thus also with the TEs with which the respective operators are associated).

The respective representation of at least a part TR may for instance be a respective representation of the entire TR, or of only a part thereof. For instance, a representation of the TR may be provided on a waypoint-per-waypoint basis. In this way, in particular if the TRs are expected to change frequently even after they have started, a transfer of unnecessary (since later outdated) information can be avoided. A representation of a new chunk of the TR (e.g. concerning the next waypoint, or concerning a pre-defined or adaptively determined number of next waypoints) may for instance be provided according to a schedule that is based on the TR timing, and/or based on information on a progress of the TE on the TR, and/or based on information on a position of the TE, and/or based on a request from the TE or its operator.

The respective representation of at least a part of the TR may for instance be in a format (e.g. the GPX format) that is understandable by the recipient, and may for instance at least partially be re-formatted into this format from a format in which the respective TR was determined. The respective representation of at least a part of the TR may for instance comprise a representation of at least a part of the sequence of waypoints defined by the TR, timing information, TBTE identifier information and/or navigation information, as already described above.

The respective representations of at least a part of the TRs of the set of TRs (e.g. respective representations of respective parts of each of the TRs or respective representations of each of the TRs) are in particular provided to the respective TEs associated with the TRs of the set of TRs or to the respective devices associated with the respective TEs to cause that the TEs follow or are operated, by respective operators (e.g. located in the respective TEs, e.g. drivers/pilots), to follow the respective TRs of the set of TRs (for instance because the TEs, based on the respective representations of at least a part of the TRs, autonomously/semi-autonomously follow the respective TRs or because respective operators of the TEs are presented, based on the respective representations of at least a part of the TRs, navigation instructions for following the respective routes and thus operate the TEs accordingly).

In this way, the respective representations of at least a part of the TRs thus function as control instructions for the TEs or their operators and cause the TRs to be conducted. The optimization criteria guiding the determining of the set of one or more TRs, e.g. to achieve short TRs, energy-efficient TRs, low-pollution TRs and/or TRs allowing a large range of the TEs thus have a direct impact, via the TEs, on the real word.

The determining of the set of one or more TRs takes place rather quickly, in less than 2 minutes even for large numbers of TBTEs in the order of 1000 (as reference architecture, an Intel Xeon E5-26994 v4 with 2.2-3.6 GHz is used).

### Second Aspect: (Ad-Hoc) Adaptation of Routing to Account for Further Information

According to a second exemplary aspect of the invention, the method according to the first aspect of the invention further comprises:
obtaining further information;
determining, under consideration of the further information, a new set of one or more TRs by changing one or more TRs of the set of TRs and/or by adding one or more TRs, each associated with a respective TE and defining a respective sequence of waypoints, to the set of TRs;
providing at least respective representations of at least a part of the one or more changed TRs and/or of the one or more added TRs to the respective TEs associated with the one or more changed TRs and/or the one or more added TRs or to respective devices associated with the respective TEs.

The new set of one or more TRs is thus determined based on the (previously determined, as per the first aspect of the invention) set of one or more TRs, and is thus not computed completely anew. This allows accounting for added TBTEs or changed characteristics of TBTEs with short computation times and thus enables real-time operation. In particular, the determining of the new set of one or more TRs may take place in real time, e.g. only takes a few seconds (e.g. less than 10 seconds) per one further TBTE or per one TBTE having one or more changed characteristics.

The new set of one or more TRs may in particular be determined while one or more TRs of the set of TRs (in particular one or more (or even all) of the one or more changed TRs) have already begun (i.e. are already conducted by respective TEs) and not yet ended. For instance, the steps of obtaining the further information, determining the new set of one or more TRs and providing at least respective representations of at least a part of the one or more changed TRs and/or of the one or more added TRs to the respective TEs associated with the one or more changed TRs and/or the one or more added TRs are performed after at least one (or even all; e.g. the earliest-starting one) of the TRs of the set of TRs has begun and/or before at least one (or even all; e.g. the latest-ending one) TR of the set of TRs has ended.

The further information obtained in the method according to the second aspect of the invention may for instance comprise:
information on one or more further TBTEs that are each associated (e.g. via a data set) with a respective pick-up position and a respective drop-off position,
change information affecting at least one TBTE of the plurality of TBTEs, and/or
information for updating the routing information.

The information on the one or more further TBTEs and/or the change information may for instance result from ad-hoc requests that occur while the TRs of the set of TRs are already being conducted.

The determining of the new set of TRs may for instance be based on the updated routing information. In particular, the information for updating the routing information may be the sole trigger of the determination of the new set of one or more TRs. The updated routing information may for instance take into account actual traffic conditions (e.g. traffic jams, road obstructions, etc.).

The plurality of TBTEs and the one or more further TBTEs; or the plurality of TBTEs including the at least one TBTE affected by the change information; or the plurality of TBTEs including the at least one TBTE affected by the change information and the one or more further TBTEs may for instance constitute a new plurality of TBTEs, and the new set of one or more TRs is determined for the new set of TBTEs to at least fulfil a criterion that, for each of the TBTEs of the new plurality of TBTEs, the pick-up position and drop-off position are associated with respective waypoints of the same respective TR of the new set of TRs or the pick-up position is associated with a respective waypoint of one TR of the new set of TRs and the drop-off position is associated with a respective waypoint of another TR of the new set of TRs that is directly connected or connected via one or more other TRs of the new set of TRs with the one TR.

In the method according to the first or second aspect of the invention, at least one (e.g. all) of the TBTEs (e.g. those of the plurality of TBTEs and/or those of the new plurality of TBTEs) is associated with one or more respective timing constraints (e.g. a respective pick-up time window and/or a respective drop-off time window), and the set of one or more TRs (and/or the new set of one or more TRs) is determined to further fulfil a criterion that the one or more respective timing constraints of the at least one TBTE that is associated with one or more respective timing constraints are met

For instance, at least those TRs of the set of TRs (or of the new set of TRs) that are involved in the pick-up, transport and/or drop-off of the at least one TBTE that is associated with one or more respective timing constraints have respective timing information associated with them. This may for instance be a timing for one, some or all waypoints of these TRs (e.g. for at least the pick-up/drop-off waypoints).

In the method according to the first or second aspect of the invention, at least one (e.g. all) of the TEs may have a respective limited load capacity, and the set of one or more TRs may be determined to further fulfil a criterion that the respective limited load capacity of the at least one of the TEs is not exceeded when the at least one of the TEs conducts the respective TR it is associated with. The load capacity may indicate which weight, in addition to its own weight in empty (unloaded) state, a TE may transport.

### Third Aspect: Transport-Entity-Side Processing

According to a method according to a third exemplary aspect of the invention, the method according to the first or second aspect of the invention further comprises:
receiving, at at least one (or several or all) TE of the TEs associated with the TRs of the set of TRs, or at the respective device associated with the at least one TE, the respective representation of at least a part of the respective TR associated with the at least one TE, and
controlling, based on the received respective representation of at least a part of the respective TR, the at least one TE to (e.g. autonomously or semi-autonomously) follow the respective TR (e.g. by driving/flying/swimming/walking according to the respective TR, e.g. changing directions, stopping at waypoints, even when an operator still can override the actions of the apparatus (semi-autonomous), or
presenting, based on the received respective representation of at least a part of the respective TR, to a respective operator of the at least one TE, navigation instructions for following the respective TR, in particular at least via a respective navigation device of the at least one TE.

The method according to the third aspect of the invention may for instance be performed by the one or more apparatuses that perform the method according to the first or second aspect of the invention as already described above, and in addition by the at least one TE (that e.g. performs the receiving and controlling) or by the respective device associated with the at least one TE (that e.g. performs the receiving and presenting).

An according reception and controlling or presenting may also take place with respect to the respective representations of at least a part of the one or more changed TRs and/or of the one or more added TRs provided to the respective TEs associated with the one or more changed TRs and/or the one or more added TRs or to the respective devices associated with the respective TEs.

Fourth Aspect: Data Structure with Characteristic Values for Optimum Transfer Point-to-Transfer Point Routes

According to a fourth aspect of the invention, the method according to the first, second or third aspect of the invention has the further features
that a plurality of transfer points comprises, as the transfer points, at least respective positions associated with the respective pick-up positions of the TBTEs and respective positions associated with the respective drop-off positions of the TBTEs, and
that the determining of the set of one or more TRs is based on a data structure that comprises, for each of a plurality of pairs of transfer points (e.g. any possible pair) from the plurality of transfer points, a respective characteristic value of a respective optimized route between a respective first transfer point and a respective second transfer point of the pair of transfer points.

The positions associated with the respective pick-up/drop-off positions may for instance be the pick-up/drop-off positions themselves, or positions that are close by (e.g. less than 100 m), for instance since the pick-up/drop-off positions themselves are not directly accessible with a TE. The plurality of transfer points may for instance comprise further transfer points that are not associated with pick-up or drop-off positions of TBTEs, e.g. merging positions, exchange positions, etc. The routes may be directed, i.e. a route for a transfer point pair (a1, a2) may have another characteristic value than a route for the transfer point pair (a2, a1).

The method according to the fourth aspect of the invention, as far as it is based on the method of the second aspect, may for instance have the following further features;
that the further information considered in the determining of the new set of one or more TRs comprises the information on the one or more further TBTEs and/or the change information,
that the change information indicates that one or more TBTEs of the plurality of TBTEs have been assigned a respective new pick-up position and/or a respective new drop-off position, and
that the determining of the new set of one or more TRs is based on a new data structure, wherein the new data structure is determined by adding, to the already available data structure that is not computed anew, for each pair of transfer points of at least one additional pair of transfer points, a respective characteristic value of a respective optimized route between a respective first transfer point and a respective second transfer point of the pair of transfer points, wherein one respective transfer point of the at least one additional pair of transfer points stems from the plurality of transfer points and a respective other transfer point of the pair of transfer points stems from a set of transfer points that at least comprises a respective position associated with the respective pick-up position and a respective position associated with the respective drop-off position of the one or more further TBTEs and/or a respective position associated with the respective new pick-up position and/or a respective position associated with the respective new drop-off position of the one or more TBTEs that have been assigned a respective new pick-up position and/or a respective new drop-off position.

Therein, the transfer points of the set of transfer points were for instance not yet included in the plurality of transfer points.

The optimization for the data structure (and/or the new data structure) may for instance be according to an optimization criterion, which may be a single or a joint optimization criterion, i.e. may be directed to optimizing one or more parameters. The optimization criterion may for instance be a shortest or a fastest route, or a fastest route under consideration of environmental constraints (e.g. no passing of environmental zones), or a route with smallest energy consumption or pollution caused, etc. The characteristic value of the optimized route may for instance quantify the result of the optimization, e.g. may the length of the route in case the optimization criterion is the shortest route.

The data structure and the new data structure are for instance optimized path tables for all pairs of transfer points (in case of the data structure: from the plurality of transfer points; in case of the new data structure: from the plurality of transfer points enriched with transfer points of further-TBTEs and/or TBTEs having been assigned new pick-up/drop-off positions). The data structure and the new data structure may for instance be used as basis for determining TRs, in particular according to an optimization criterion to which the characteristic values pertain.

The characteristic values of the data structure and the new data structure may for instance have been determined using a Dijkstra algorithm based on a graph, such as the fourth graph described below.

The data structure and the new data structure are for instance based on a map (and possibly also on traffic information), e.g. in the form of a graph. The new data structure can for instance be further enriched with additional characteristic values for transfer point pairs as long as the map/traffic information does not change or does not change significantly.

The re-use of the data structure in the new data structure is particularly advantageous since it allows for a fast (in particular real-time) determining of the new set of TRs, without having to compute the new data structure from scratch.

In the method according to the fourth aspect of the invention, the TRs of the set of one or more TRs may for instance be associated with at least two different types of TEs, and the data structure may be specific for one of the types of TEs and be used at least for determining those TRs of the set of one or more TRs that are associated with a TE of this type. If the method comprises the further features of the second aspect of the invention, this may equally hold for the TRs of the new set of one or more TRs and the new data structure.

A respective specific data structure (and a respective specific new data structure) may also be available for one or more (e.g. each) of the other types of TEs and be used for determining those TRs of the set of one or more TRs (and of the new set of one or more TRs) that are associated with a TE of the respective type.

Types of TEs may for instance be trucks (e.g. above 3.5 t load capacity), vans (below 3.5 t load capacity), cars, motorcycles/scooters, bicycles, persons. The type of a TE may for instance depend on one or more of a load capacity, type of energy consumed (e.g. powered by fossil fuel or not), emissions classification, classification according to road traffic regulations (e.g. the German “Straßenverkehrsordnung”), etc.

The use of a transport-entity-type-specific data structure (and new data structure) allows optimizing TR determination in particular in inhomogeneous transport scenarios where different types of TEs are deployed.

The data structure that is specific for one of the types of TEs may for instance be determined based on a fourth graph (GkT) that is obtainable by applying a restriction set (Rk) that is specific for the one of the types of TEs to a third graph (GT), wherein the third graph (GT) is obtainable from a first graph (G) by projecting the transfer points of the plurality of transfer points to respective closest edges of a largest strongly connected component (L) of a second graph (Gallrestr), in particular by subdividing the respective closest edges at respective projection points or assigning the transfer points to respective edge points of the respective closest edges, wherein the second graph (Gallrestr) is obtainable by applying a union of restriction sets to a first graph (G), each of said restriction sets being specific for a respective type of the types of TEs (and the restriction sets including the restriction set that is specific for the one of the types of TEs), wherein the first graph (G) is representative of map data.

Applying restrictions to a graph results in a restricted graph that contains the restrictions, so that no keeping-track of prohibited sequences in the restricted graph is necessary when searching paths in the restricted graph. Restrictions may for instance be applied by introducing clones of existing points affected by restrictions and connecting these clones to other points of the graph under consideration of the restrictions.

The second graph and the largest strongly connected component can advantageously be used several times for the determining of sets of one or more TRs (and also new sets of one or more TRs) as long as the map data does not change. This saves significant processing time required for determining the set of one or more TRs (or the new set of one or more TRs).

This way of constructing the data structure (and also the new data structure) that is specific for the one of the types of TEs ensures that the transfer points of the plurality of transfer points are only assigned to graph nodes (that already exist or are newly created) that can be reached from any other node, irrespective of the type of TE used. Nevertheless, the fourth graph is specific for the one of the types of TEs since only the restriction set specific for the one of the type of TEs has been applied to the third graph. The fourth graph thus reflects the restriction set specific for the one of the type of TEs, but comprises, as transfer points, only those that can be reached by any other transfer points irrespective of the type of TE. The respective fourth graphs for different types of TEs, and consequently the respective data structures derived from these respective fourth graphs (in the same manner as described for the (single) data structure above) are thus made compatible for later processing steps. In particular, it becomes possible to have, among the set of one or more TRs, a main TR (e.g. conducted by a truck) and one or more secondary TRs (e.g. conducted by vans or bicycles) that branch off from main TRs and take over at least some of the TBTEs transported by the TE of the main TR up to the branch-off point, wherein the branch-off point is a transfer point that can be reached by both the TE of the main TR and the TE of the secondary TR irrespective of the types of TEs. If the largest strongly connected component of the second graph would not be considered in the derivation of the fourth graph, proper branch-off points (transfer points) would have to be identified in the secondary TR identification process (described further below) for each candidate secondary TR that is examined, tremendously increasing the computational overhead. The concept of using transfer points that are compatible with/reachable by any TE is equally advantageous if the determining of the set of one or more TRs (and the determining of the new set of one or more TRs) considers merging of two or more candidate TRs (as will be further described below), since such merging can then advantageously be performed at the transfer points irrespective of the types of the TEs that conduct the two or more candidate TRs.

This way of constructing the data structure (and/or the new data structure) that is specific for the one of the types of TEs thus significantly contributes to reduce the computational complexity of the determining of the (new) set of one or more TRs, in particular if the determining of the (new) set of one or more TRs includes checking of secondary-route branch-off possibilities and/or checking for merging possibilities. Both checkings may result in one or more TRs of the (new) set of TRs being connected at one or more respective transfer points.

### Fifth Aspect: Clustering of TBTEs

According to a fifth aspect of the invention, the method according to the first, second, third or fourth aspect of the invention has the further feature that the determining of the set of one or more TRs comprises:
clustering the plurality of TBTEs into one or more clusters so that each of the one or more clusters comprises a respective (e.g. disjunct) sub-set of TBTEs of the plurality of TBTEs,
   wherein each of the one or more clusters is associated with a respective set of one or more respective TRs, each associated with a respective TE and defining a respective sequence of waypoints, wherein in case the respective set of one or more respective TRs comprises two or more respective TRs, each TR of the two or more respective TRs is connected with at least one other respective TR of the two or more respective TRs,
   wherein for each cluster of the one or more clusters, the respective set of one or more respective TRs associated with the cluster at least fulfils a criterion that, for each of the TBTEs of the sub-set of TBTEs comprised by the cluster, the pick-up position and drop-off position are associated with respective waypoints of the same respective TR of the set of one or more respective TRs associated with the cluster or the pick-up position is associated with a respective waypoint of one respective TR of the set of one or more respective TRs associated with the cluster and the drop-off position is associated with a respective waypoint of another respective TR of the set of one or more respective TRs associated with the cluster that is directly connected or connected via one or more other respective TRs of the set of one or more respective TRs associated with the cluster with the one respective TR, and
   wherein the TRs of the respective sets of one or more respective TRs associated with the one or more clusters constitute the TRs of the set of one or more TRs produced by the determining of the set of one or more TRs or are considered in the determining of the set of one or more TRs.

The clustering thus targets to identify subsets of TBTEs that shall be handled by the same set of one or more directly or indirectly connected TRs, wherein each TR is associated with a respective TE.

For each cluster of the one or more clusters, the respective set of one or more respective TRs associated with the cluster may for instance at least fulfil a further criterion that the respective TRs are conductable by the respective TEs associated with the respective TRs without violating traffic laws (and e.g. that the TRs are based on traffic channels (e.g. roads) that actually exist).

For each cluster of the one or more clusters, the respective set of one or more respective TRs associated with the cluster may for instance at least fulfil a further criterion that a respective load capacity of the respective TEs associated with the respective TRs is not exceeded when conducting the respective TRs.

For each cluster of the one or more clusters, the respective set of one or more respective TRs associated with the cluster at least fulfils a further criterion that one or more respective timing constraints of at least one TBTE that is associated with one or more respective timing constraints are met.

The clustering of the plurality of TBTEs into one or more clusters may for instance comprise:
generating one or more clusters, and, for each of the one or more clusters, performing: selecting a respective TBTE of the plurality of TBTEs, assigning this respective TBTE to the cluster, generating a respective TR having respective positions associated with the pick-up and drop-off position of this respective TBTE as waypoints, and associating the respective TR with the cluster;
for each of the remaining TBTEs of the plurality of TBTEs:
   checking if one or more already generated clusters exist to which the TBTE can respectively be assigned in a way
      that respective positions associated with its pick-up position and drop-off position are or become waypoints of an already generated TR associated with the respective cluster or that a position associated with its pick-up position is or becomes a waypoint of an already generated first route associated with the respective cluster and a position associated with its drop-off position is or becomes a waypoint of a second already generated TR associated with the respective cluster and connected directly or indirectly via one or more other already generated TRs associated with the respective cluster to the first TR, and
      that the respectively concerned already generated TRs associated with the respective cluster, i.e.:
         the already generated TR, or
         the first already generated TR and the second already generated TR if connected directly, or
         the first already generated TR, the second already generated TR and the one or more other already generated TRs indirectly connecting the first already generated TR and the second already generated TR,
      are still considered valid when being modified to account for the TBTE (e.g. by adding not yet-positions associated with pick-up/drop-off positions as waypoints in the TR, and/or by associating already or added positions associated with pick-up/drop-off positions with information on the TBTE, e.g. timing constraints and/or transfer delays);
   if the checking yields a positive result, adding the TBTE to that cluster of the one or more clusters for which it was determined that the TBTE can be assigned, according to an optimization criterion, in an optimum way, and modifying the one or more concerned already generated TRs associated with this cluster to account for the TBTE;
   if the checking yields a negative result, generating a new cluster, assigning the TBTE to the new cluster, generating a TR having respective positions associated with the pick-up and drop-off position of the TBTE as waypoints, and associating the TR with the new cluster.

In the step of generating one or more clusters, for instance only one cluster may be generated. Alternatively, a pre-defined number of clusters or a number of clusters that is determined according to a pre-defined rule, may be generated. The TBTE may for instance be randomly chosen from the plurality of TBTEs, or may be selected according to a selection heuristic. If several clusters are generated in the step of generating one or more clusters, the respective TBTEs selected for each of these several clusters may for instance be selected in a way that e.g. their respective pick-up positions or their respective drop-off positions are far away from each other (e.g. maximally away from each other). Alternatively, if several clusters are generated in the step of generating one or more clusters, the respective TBTEs selected for each of these several clusters may for instance be selected according to a result of selection algorithm.

Therein, the optimization criterion may for instance pertain to the TR (associated with the respective cluster) that would have to be modified to account for the TBTE. The optimization criterion may for instance be a total distance comprised by a TR, a time it takes to conduct a TR, an amount of energy (e.g. fuel consumption or electric power) consumed by a TE when conducting a route, and/or costs involved with a TR (which may inter alia depend on the type of TE, e.g. if the tour is conducted by a third-party, e.g. a crowder), to name but a few examples.

A criterion for a concerned TR to be considered valid may for instance be that a load capacity of the TE associated with the TR is not exceeded when the TE conducts the TR. An alternative or additional criterion of a concerned TR to be considered valid may for instance be that timing constraints associated with the TBTEs having a pick-up and/or drop-off position associated with a waypoint of the TR are met when the TR is conducted.

The clustering approach according to example embodiments of the invention leads to all TBTEs of the plurality of TBTEs to be assigned to one or more TRs. It may not obtain the globally optimum solution, which is one among n²ⁿ possible solutions, with n denoting the number of TBTEs, and thus impossible to calculate even in case of moderate numbers of n, even when applying advanced integer programming techniques. However, since approximation algorithms only exist for unrealistic special cases, fast (e.g. polynomial-time) and well-performing heuristic algorithms are needed.

The heuristic clustering approach chosen according to the fifth aspect of the invention has the vast advantage that after a single run of the clustering algorithm, already a valid solution (i.e. w.r.t. map restrictions and—if —load capacity restrictions of the TEs and/or time restrictions associated with the TBTEs (e.g. pick-up and/or delivery time windows) is available for all TBTEs, which solution can directly be applied to the TEs in the field. This is an entirely new way of addressing the technical problem of enabling clustering for larger numbers of TBTEs to be used in real-time or close-to-real-time applications. Further optional steps can be applied to further optimize the solution, but the approach has been tuned for fast processing time and thus allows the entire clustering, which generally constitutes the most time-demanding task, already with today's standard off-the-shelf hardware in only a couple of minutes for numbers of TBTEs in the range of n=1000. If a fixed time budget is available for the determining of the (new) set of one or more TRs (which determining includes the clustering), a first portion of the time budget can be used for the clustering, yielding a valid solution as described above that is ready to use, and any remaining time can be spent for optional further optimization of the solution. This constitutes a particularly advantageous feature of the clustering algorithm according to the fifth aspect of the invention and, for the first time, allows performing the determining of a (new) set of one or more TRs for a large numbers of TBTEs in the order of 1000 or more in less than 2 minutes.

In the clustering algorithm described above, if the checking yields a positive result, in addition to modifying the one or more concerned already generated TRs associated with this cluster to account for the TBTE, the following may be carried out:
determining, according to an evaluation criterion, a first quality measure for the one or more already generated and possibly modified TRs associated with this cluster;
determining an alternative assignment of the pick-up positions and drop-off positions of all TBTEs of the sub-set of TBTEs comprised by this cluster to one or more TRs, in which the one or more TRs are considered valid (e.g. not exceeding the respective capacity load of the respective TE, and/or not exceeding timing constraints associated with the TBTEs), and determining, according to the evaluation criterion, a second quality measure for the one or more TRs yield by the alternative assignment; and
if the second quality measure is better than the first quality measure, associating the one or more TRs yield by the alternative assignment with this cluster, and keeping the association of the one or more already generated and possibly modified TRs with this cluster otherwise.

Determining an alternative assignment of the pick-up positions and drop-off positions of all TBTEs of the sub-set of TBTEs comprised by this cluster to one or more TRs may contribute to further improving the quality of the TRs.

Determining an alternative assignment of the pick-up positions and drop-off positions of all TBTEs of the sub-set of TBTEs comprised by this cluster to one or more TRs may for instance comprise determining (e.g. by applying a Travelling-Salesman-Problem (TSP) algorithm, in particular an asymmetric-TSP algorithm) a single TR comprising, as waypoints, positions respectively associated with the pick-up and drop-off positions of all TBTEs of the sub-set of TBTEs comprised by this cluster, wherein if one or more of the TBTEs are associated with one or more respective timing constraints, these timing constraints are ignored in the determining of the single TR; and attempting, under consideration of the timing constraints, if existent, to transform this single TR into a main TR and one or more secondary TRs that begin at, end at or traverse respective waypoints of the main TR and are associated with respective TEs that are meant to exchange, at the respective waypoint, one or more TBTEs with a TE that is associated with the main TR. In such a scenario, the main TR may be denoted as main-tour, and the one or more secondary TRs may be denoted as sub-tours. The main TR and the one or more secondary TRs are TRs that are considered valid (e.g. at least with respect to the timing constraint, if present, and/or with respect to load capacities of the respective TEs associated with the TRs).

In a further exemplary embodiment of the method according to the fifth aspect of the invention, the clustering of the plurality of TBTEs into one or more clusters comprises:
determining a plurality of secondary TRs, each comprising respective waypoints that are associated with either a respective pick-up position or a respective drop-off position of one or more respective TBTEs from the plurality of TBTEs;
determining one or more main TRs, each comprising, as respective waypoints, either a respective start position or a respective end position of one or more of said secondary TRs and thus being with these one or more secondary TRs;
assigning, for each of the one or more main TRs, those TBTEs having either their pick-up position or their drop-off position associated with a waypoint of a secondary TR connected to the respective main TR to a respective one of said one or more clusters.

The clusters are thus derived based on secondary TRs, which are suitably connected to main TRs, and those TBTEs that are associated with waypoints of secondary TRs connected to the respective same main TR are then understood to form a cluster. In this way, a clustering of all TBTEs of the plurality of TBTEs into one or more clusters is achieved, and also an assignment of the pick-up/drop-off positions of the TBTEs to main TRs and secondary TRs is available for each cluster. This approach may be particularly advantageous if each of the secondary TRs is respectively allowed to have either pick-up waypoints or drop-off waypoints, but no mixture thereof. For instance, the corresponding one or more drop-off waypoints (i.e. waypoints associated with drop-off positions of TBTEs) for a secondary TR having only one or more pick-up waypoints (i.e. waypoints associated with pick-up positions of these TBTEs) may then lie on the main TR to which this secondary TR is connected, or on one or more other secondary TRs connected to this main TR. Similarly, the one or more corresponding pick-up waypoints for a secondary TR having only one or more drop-off waypoints may then lie on the main TR to which this secondary TR is connected, or on one or more other secondary TRs connected to this main TR. In particular, scenarios are conceivable where the main TR comprises a pick-up waypoint (e.g. a depot) (or alternatively a drop-off waypoint, e.g. a depot) that is associated with the pick-up positions (or alternatively the drop-off positions) of a plurality of TBTEs, and the respective drop-off positions (or alternatively the pick-up positions) of these TBTEs are all associated with waypoints of secondary TRs connected to the main TR. Both the main TR and the secondary TRs may then comprise respective exchange waypoints where the secondary TRs are connected to the main TR. These exchange waypoints, which constitute the start or end positions of the secondary TRs, may then additionally be pick-up waypoints (or alternatively drop-off waypoints) or not

The main TR with its connected secondary TRs of each cluster may then again constitute a valid solution, i.e. may satisfy restrictions such as for instance load capacity restrictions and/or timing constraints of the TBTEs. Furthermore, the main/secondary TRs may be optimized according to one or more optimization criteria, e.g. for shortest routes, fastest routes, low energy consumption, low pollution, etc.

Both the secondary TRs and the main TR may be determined by using an error avoiding greedy algorithm. Therein, for the secondary TRs, for instance smaller load capacities of the TEs may be prescribed than for the TEs of the main TR.

### Sixth Aspect: Main TRs and Secondary TRs

According to a sixth aspect of the invention, the method according to the first, second, third, fourth or fifth aspect of the invention has the further features that the set of one or more TRs comprises or is derived under consideration of a main TR, which is associated with a TE and defines a sequence of waypoints, and one or more secondary TRs that respectively define sequences of waypoints, begin at, end at or traverse respective waypoints of the main TR, are associated with respective TEs that are meant to exchange, at the respective waypoints of the main TR, one or more TBTEs with the TE that is associated with the main TR, and that the respective pick-up positions and the respective drop-off positions of the one or more TBTEs are associated with respective waypoints of the main TR or of any of the one or more secondary TRs.

Traversal of a waypoint of the main TR is in particular understood to mean that the secondary TR and the main TR have a common waypoint that is neither the start waypoint nor the end waypoint of the secondary TR

The position associated with the pick-up position can for instance be on the first secondary TR, and the position associated with the drop-off position can for instance be on second secondary TR, and are interconnected by the main TR, so that the TBTE needs to be reloaded two times. The main TR may nevertheless have, for at least one TBTE, both a respective position associated with a respective pick-up position and a respective position associated with a respective drop-off position as respective waypoints. The secondary TRs may be attached to the main TR at respective waypoints that are associated with pick-up and/or drop-off positions and/or at respective waypoints that are neither associated with a pick-up position nor a drop-off position.

The TBTEs may for instance be associated with one or more time constraints, and these time constraints may then at least be met by the combination of the main TR and the one or more secondary routes. The main TR and the one or more secondary TRs are in particular considered valid (e.g. do not exceed respective load capacities of the TEs and/or obey all map constraints and other constraints specific for the type of TEs).

The secondary TRs may for instance only be for drop-off or only for pick-up; the main TR may then respectively perform the pick-up or drop-off, respectively, e.g. the main TR may only comprise pick-up waypoints and waypoints connected to secondary (drop-off-only) TRs, or drop-off waypoints and waypoints connected to secondary (pick-up-only) TRs.

The approach according to the sixth aspect of the invention of allowing transfer of TBTEs between a main TR and one or more secondary TRs allows to reduce the sum of the lengths of the TRs involved as compared to the length of a single TR or to the sum of lengths of multiple disjunct TRs that would respectively take care of the same TBTEs as the combination of the main route and the one or more secondary TRs. Reduction of the overall length of the TRs corresponds to reduction of the energy consumption of the TEs and, in case of TEs powered by fossil fuels, also to reduction of the pollution caused. Furthermore, this approach according to the sixth aspect of the invention allows more flexibility in adapting a type of TE to the respective pick-up and/or drop-off position, equally well contributing to reduced power consumption and, in case of TEs powered by fossil fuels, to reduced pollution. For instance, a TE with a larger load capacity (e.g. a truck or large bus) may be used for the main TR (that e.g. performs most or all of the pick-ups, e.g. from a central depot in case of parcels as TBTEs or from an airport or railway station in case of persons as TBTEs) while the respective TEs associated with the secondary TRs (that e.g. perform most or all of the drop-offs) have smaller load capacities (e.g. vans, cars or bicycles), but are therefore better suited to access certain areas (e.g. city centers with narrow streets and/or lack of even short-time stopping or parking positions). Secondary TRs may for instance be conducted by TEs that are engaged via a crowd-based approach, e.g. via an app that is installed on the smartphone of participating operators (e.g. drivers) of TEs, which operators are also denoted as “crowders”.

According to a first embodiment of the sixth aspect of the invention, the main TR and the one or more secondary TRs are derived from at least a portion of an already determined TR, wherein all TBTEs that had respective pick-up positions and respective drop-off positions associated with respective waypoints of the at least a portion of the already determined TR have the respective pick-up positions now associated with respective waypoints of the main TR or of the one or more secondary TRs, and have the respective drop-off positions now associated with respective waypoints of the main TR or of the one or more secondary TRs.

This derivation of the main TR and the one or more secondary TRs can for instance be deployed in the clustering algorithm described above with respect to the fifth aspect of the invention to further enhance the quality of the solution achieved.

For instance, the at least a portion of the already determined TR comprises n waypoints t₀, t₁, . . . , tₙ₋₁, tₙ that are either associated with a respective pick-up position of one or more of said all TBTEs and/or with a respective drop-off position of one or more of said all TBTEs, with n being an integer number, and a derivation of the main TR and the one or more secondary TRs from the at least a portion of an already determined TR may then for instance comprise:
for each j=1, . . . , n, determine and store an—according to an optimization criterion—optimum solution for a main TR and one or more secondary TRs that handle all pick-up and drop-offs of respective TBTEs that were associated with t₀, t₁, . . . , tⱼ₋₁, tⱼ in the at least a portion of the already determined TR,
   up to tⱼ₋₁ (by main TR or by one or more secondary TRs), the solution being denoted as Aⱼ; and
   up to tⱼ (by main TR or by one or more secondary TRs), the solution being denoted as Bⱼ;
wherein, to compute Aⱼ and Bⱼ, all i∈{0, . . . , j−1} are tried and then:
   Aⱼ results from
      Aᵢ and a secondary TR handling tᵢ, . . . , tⱼ₋₁, or
      Bᵢ and a secondary TR handling tᵢ₊₁, . . . , tⱼ₋₁ (if nonempty).
   Bⱼ results from
      Aᵢ and a secondary TR handling tᵢ, . . . , tⱼ, or
      Aᵢ and a secondary TR handling tᵢ . . . , tⱼ₋₁ and the main TR handling tᵢ, or
      Bᵢ and a secondary TR handling tᵢ₊₁, . . . , tⱼ, or
      Bᵢ and a secondary TR handling tᵢ₊₁, . . . , tⱼ₋₁ (if nonempty) and the main TR handling tⱼ.

This algorithm is based on concepts of dynamic programming and produces a computationally highly efficient and also—under the assumptions made, in particular that only one secondary TR is allowed to branch-off per waypoint of the main TR, that no secondary TRs branch off from other secondary TRs, and that secondary TRs start at respective waypoints of the main tour—optimum solution. The above algorithm is also extendable to allow for several secondary TRs branching off from the same respective main TR waypoint. This would require adding a further dynamic program to take care of these multiple secondary TRs.

In the above algorithm, at least one of said all TBTEs may be associated with one or more respective time constraints that have to be met. Then for each j=1, . . . , n, for instance not only the—according to the optimization criterion—optimum solution for a main TR and one or more secondary TRs that handle(s) all pick-up and drop-offs of respective TBTEs that were associated with t₀, t₁, . . . , tⱼ₋₁, tⱼ in the at least a portion of the already determined TR is stored up to tⱼ₋₁ (Aⱼ) and up to tⱼ (Bⱼ), but respective sets Aⱼ and Bⱼ of non-dominated (or pareto-optimum) solutions. The optimum solution for each j=1 . . . n for Aⱼ and Bⱼ is then found under consideration of these sets rather than from single solutions Aⱼ and Bⱼ.

A solution is for instance considered dominated by another solution if the former is worse with respect to the optimization (e.g. more expensive) and also finally arrives at a later time.

According to a second embodiment of the sixth aspect of the invention, the main TR and the one or more secondary TRs are obtained as follows:
determining a plurality of secondary TRs that at least comprises said one or more secondary TRs, and
determining the main TR as a TR that comprises, as waypoints, either a respective start position or a respective end position of each of said one or more secondary TRs.

The start/end position of the one or more secondary TRs may for instance be associated with pick-up and/or delivery positions. They may for instance further be associated with time constraints, wherein the time constraints may then for instance be considered when determining the main route. If the secondary TRs respectively only comprise pick-up waypoints, the main TR may for instance advantageously comprise the respective end positions (e.g. a respective position associated with the last respective pick-up positions of the secondary TRs) as waypoints. If the secondary TRs respectively only comprise drop-off waypoints, the main TR may for instance advantageously comprise the respective start positions (e.g. a respective position associated with the first respective drop-off positions of the secondary TRs) as waypoints. In both cases, instead of end/start positions of the secondary TRs that are associated with pick-up/drop-off positions respectively, dedicated exchange positions may be used that are not associated with pick-up/drop-off positions and only serve the purpose of allowing exchange of TBTEs between a TE that is associated with the main TR and respective TEs that are associated with the one or more secondary TRs.

The secondary TRs may for instance be determined by an error-avoiding greedy algorithm (e.g. as described for the clustering in the context of the fifth aspect of the invention above, however without allowing secondary TRs, and/or for instance with smaller load capacities for the TEs). The main TR may for instance be determined by an error-avoiding greedy algorithm with the start/end positions of the secondary TRs as inputs. Actually more secondary TRs than the one or more TRs may be determined, and also more than one main TR may be determined, but the one or more secondary TRs are only associated with the one main TR.

### Seventh Aspect: Waypoint Exchange Between TRs/Merging

According to a seventh aspect of the invention, the method according to any of the first to sixth aspect of the invention has the further feature that the determining of the set of one or more TRs comprises:
removing, from a first already determined TR, at least one waypoint that is associated with at least a respective pick-up or drop-off position of a respective TBTE, and making the at least one waypoint a waypoint of a second already determined TR while keeping the waypoint's association with the respective pick-up or drop-off position of the respective TBTE, and
if at least one of the at least one waypoint is associated with one of a respective pick-up position and a respective drop-off position of a respective TBTE and the other one of the respective pick-up position and the respective drop-off position remains associated with a respective waypoint of the first already determined TR, allowing the respective TBTE to be exchanged between a first TE associated with the first TR and a second TE associated with the second TR at a joint exchange waypoint that is selected or newly created in both the first TR and the second TR

The first already determined TR (after removal of the at least one waypoint) and the second already determined TR (after addition of the at least one waypoint) may for instance constitute TRs of the set of one or more TRs determined by the determining or may be considered in the determining of the set of one or more TRs.

Transfer of one or more waypoints from the first to the second TR may for instance, according to an optimization criterion, yield a better result, e.g. overall shorter or faster or more energy-efficient resulting TRs.

Additionally or alternatively, at least one waypoint that is associated with at least a respective pick-up or drop-off position of a respective TBTE may be removed from the second already determined TR and made a waypoint of the first already determined TR while keeping the waypoint's association with the respective pick-up or drop-off position of the respective TBTE. Accordingly, then at least one of the at least one waypoint removed from the second already determined TR may necessitate a joint exchange waypoint (e.g. a joint exchange waypoint that equals or is different from the already mentioned joint exchange waypoint) if at least one of the at least one waypoint is associated with one of a pick-up position and a drop-off position of a respective TBTE and the other one of the respective pick-up position and the respective drop-off position remains associated with a respective waypoint of the second already determined TR

In an extreme case, the first already determined TR may have all of its waypoints removed any may then no longer be necessary/existent

This approach according to the seventh aspect of the invention constitutes an optimization of already determined TRs that contributes to e.g. reduce the length of the TRs and thus to reduce the amount of energy consumed (and in case of TEs powered by fossil fuels, the amount of pollution caused).

### Eighth Aspect: Local Pre-Clustering

According to an eighth aspect of the invention, the method according to any of the first to seventh aspect of the invention has the further feature that the determining of the set of one or more TRs comprises:
pre-clustering two or more positions that are respective pick-up positions of one or more TBTEs of the plurality of TBTEs and/or respective drop-off positions of one or more TBTEs of the plurality of TBTEs into a local cluster,
   wherein, in the determining of the TRs of the set of one or more TRs, a single position associated with the local cluster is then used rather than the individual two or more positions.

The two or more positions are for instance pick-up and/or drop-off positions of the same or different TBTEs that are within a pre-defined geographical area (e.g. pre-defined based on respective postal addresses of the pick-up/drop-off position) or within an area with a pre-defined size (e.g. less than 100 m). A position associated with the local cluster (e.g. a center position, or one of the two or more positions, or another position, e.g. the first address of the street in which all of the two or more positions are located) is then used, e.g. for the map pre-processing (fourth aspect of the invention) and/or clustering (fifth aspect of the invention) already described above.

The local pre-clustering approach according to the eighth aspect of the invention significantly reduces the complexity of the routing process, since less individual pick-up/drop-off positions need to be considered in the computationally complex portions of the routing process (in particular in the clustering part already described above with respect to the fifth aspect of the invention), and thus contributes to making the routing process applicable in real-time scenarios.

Ninth Aspect: Re-Routing with Inquiry

According to a ninth aspect of the invention, the method according to the second aspect of the invention or according to any of the third to eighth aspect of the invention as long as being based on the second aspect, has the further features:
the further information at least comprises the change information affecting the at least one TBTE of the plurality of TBTEs,
the change information is representative of a new position to which an original position, which is the pick-up position or the drop-off position associated with the at least one TBTE, has been changed, and/or of a new timing constraint to which an original timing constraint associated with the at least one TBTE has been changed,
the method further comprises, before the obtaining of the further information, determining or learning that a position, which is a position of a person associated with the at least one TBTE or is a position of the at least one TBTE itself, is not within a pre-defined area associated with the original position; and
the obtaining of the further information comprises receiving or establishing the new position and/or the new timing constraint.

The ninth aspect of the invention is particularly advantageous since it provides a technical solution to the problem of absence of TBTEs (e.g. passengers) or persons associated with TBTEs (e.g. shipments like e.g. parcels) at the time of pick-up or drop-off. To avoid such situations, it is checked whether the TBTE or a person associated with the TBTE is within a pre-defined area associated with the position that is originally selected for pick-up or drop-off. If this is not the case, either a new pick-up/drop-off position or new timing constraint for the pick-up/drop-off is received. This new position and/or new timing constraint may for instance have been defined by the TBTE or the person associated with the TBTE, or may have been defined by another entity. The new position and/or new timing constraint are then considered when determining a new set of one or more TRs (as per the second aspect of the invention). Thus in effect, a re-routing takes place to avoid absence scenarios.

The determining that the position is not within pre-defined area may comprise obtaining the position, e.g. via an app of a mobile device of a person that is the TBTE (e.g. a passenger) or is associated therewith (e.g. as recipient or sender of a shipment), or via a server (e.g. of communication system used by the mobile device of the person), e.g. if the person has consented to having its position tracked by the server, and checking whether the obtained position is within the pre-defined area associated with the original position. The pre-defined area can for instance be expressed as a pre-defined radius around the original position, or based on a pre-defined geographic area or a pre-defined area that is defined by at least a part of the postal address of the original position, e.g. an area comprising all addresses having the same zip code like the address of the original position, or the same street name, or falling within a pre-defined range of street numbers of the same street

The learning that a position is not within a pre-defined area may comprise receiving a notification, e.g. from an app (e.g. an app with monitoring functionality) of a mobile device of a person that is the TBTE (e.g. a passenger) or is associated therewith (e.g. as recipient or sender of a shipment), or from a monitoring server, that the person has moved outside the pre-defined area associated with the original position.

The determining that the position is not within the pre-defined area is for instance performed after the TR that comprises a waypoint associated with the original position has been determined and/or already started.

The determining that the position is not within the pre-defined area is for instance performed before a TE associated with the TR that comprises a waypoint associated with the original position has reached the waypoint or, after having visited the previous waypoint in the sequence of waypoints defined by the TR, starting to approach the waypoint associated with the original position.

The determining that a position is not within a pre-defined area associated with the original position may for instance be performed when a waypoint of the TR that is (e.g. immediately) preceding a waypoint of the TR associated with the original position is or has been reached. This could then be understood as “stop-to-stop routing”, where it is ensured at a waypoint if the next waypoint shall be approached or not

The new position and/or the new timing constraint may for instance be received or established after it has been learned, in response to an inquiry (e.g. directed to the person or to a mobile device of the person), that the original position and/or the original timing constraint shall be changed.

The new position may for instance be the obtained position.

The original position may for instance be the pick-up position, and the person associated with the at least one TBTE may then be a person that provides the at least one TBTE for pick-up, or the original position may for instance be the drop-off position, and the person associated with the at least one TBTE may then be a person to which the at least one TBTE shall be provided.

### Tenth Aspect: Presence-Related Routing

According to a first embodiment of a tenth aspect of the invention, the method according to any of the first to ninth aspect of the invention has the further feature that the determining of the set of one or more TRs comprises:
dividing a plurality of transfer points that comprises respective pick-up positions of at least some of the TBTEs and/or respective drop-off positions of at least some of the TBTEs, into a plurality of transfer point groups,
determining respective presence-related information for the transfer point groups, wherein the presence-related information of a transfer point group is related to presence of persons, which are or are associated with respective TBTEs associated with the respective transfer points, at the respective transfer points of the transfer point group or in an (e.g. predefined) area associated with the transfer point group;
determining a TR that at least visits respective positions associated with the transfer points of the plurality of transfer points under consideration of the respective presence-related information of the transfer point groups, wherein the determined TR is a TR of the set of TRs or serves as a basis for determining one or more TRs of the set of TRs.

According to a second embodiment of the tenth aspect of the invention, the method according to the second aspect of the invention or according to any of the third to tenth aspect of the invention as far as it is based on the second aspect of the invention has the further feature that the determining of the new set of one or more TRs comprises:
dividing a plurality of transfer points that comprises respective pick-up positions of at least some of the TBTEs and/or respective drop-off positions of at least some of the TBTEs, into a plurality of transfer point groups,
determining respective presence-related information for the transfer point groups, wherein the presence-related information of a transfer point group is related to presence of persons, which are or are associated with respective TBTEs associated with the respective transfer points, at the respective transfer points of the transfer point group or in an (e.g. pre-defined) area associated with the transfer point group;
determining a TR that at least visits respective positions associated with the transfer points of the plurality of transfer points under consideration of the respective presence-related information of the transfer point groups, wherein the determined TR is a transfer route of the new set of TRs or serves as a basis for determining one or more TRs of the new set of TRs.

The methods according to the tenth aspect of the invention provide a technical solution for the problem that TBTEs (e.g. passengers) or persons associated with TBTEs (e.g. shipments like parcels) are not at the time of pick-up or drop-off. To reduce the probability of such scenarios, presence-related information is determined (in particular before the determining of the set of one or more TRs or before determining of the new set of one or more TRs) and considered when determining the set of one or more TRs (first embodiment) or when determining the new set of one or more TRs (second embodiment). Presence related information relates to presence (in particular current presence) of persons at transfer points (e.g. pick-up or drop-off positions) or in an associated with the transfer point group. A person may for instance be considered to be either at a respective transfer point (e.g. within a pre-defined area associated with the transfer point) or not. Similarly, a person may for instance be considered to be either in an area associated with the transfer point group or not by grouping several transfer points into a transfer point group, a presence measure can then be provided, for instance in the form that a certain percentage of the persons associated with the transfer points are currently at their respective transfer point or in the area associated with the transfer point group. This presence measure may then be considered in the routing process, i.e. when determining the set of one or more TRs or the new set of one or more TRs, for instance by serving transfer points of transfer groups with higher presence measures earlier than transfer points of transfer groups with lower presence measures. This approach yields best results when the time delay between determining of the presence measures and the start of the TRs is comparably low, e.g. less than an hour. Considering presence-related information may be particularly beneficial when determining new sets of one or more TRs (as in the second aspect of the invention), in particular when TRs are generated or adapted to account for further TBTEs or to account for changes of characteristics of TBTEs that have already been considered in TRs.

In the following, further features of the first and second embodiment of the tenth aspect will be described. Therein, if the set of one or more TRs and/or the new set of one or more TRs are concerned, the notation “the (new) set of one or more TRs” will be used.

The transfer point groups may for instance be formed under consideration of geographical and timing constraints, e.g. those transfer points that are within the same area (e.g. have the same zip code or zip code and street combination) and have similar/temporally adjacent timing constraints may be put into the same transfer point group. The at least some of the TBTEs may for instance be all the respective TBTEs of a cluster of the one or more clusters as created according to the fifth aspect of the invention.

The determining of the presence-related information may for instance take place within a time window of less than 3, 2, 1, 0.5 or 0.25 hours before the determining of the (new) set of TRs is completed or the earliest TR of the (new) set of TRs starts.

The determining of the respective presence-related information for the transfer point groups may for instance comprise determining or learning whether respective positions of the persons, which are or are associated with the respective TBTEs associated with the respective transfer points of the transfer point group, are respectively within a respective pre-defined area associated with the respective transfer points of the transfer point group, or in an area associated with the transfer point group. The area associated with the transfer point group may for instance be the same for all transfer points of a transfer point group. It may for instance be an area that comprises all transfer points of the transfer point group.

The determining that a position of a person is not within a respective pre-defined area associated with the transfer point or transfer point group may comprise obtaining the position, e.g. via an app of a mobile device of the person, or via a server (e.g. of a communication system used by the mobile device of the person), and checking whether the obtained position is within the pre-defined area.

The presence-related information of a transfer point group may for instance be a ratio between the number of persons for which it has been determined or learned that their respective position is within the respective pre-defined area associated with the respective transfer point or with the transfer point group and the total number of transfer points of the transfer point group.

The respective presence-related information of the transfer point groups may for instance be considered in the determining of the transfer route that at least visits the transfer points of the plurality of transfer points by planning transfer points of transfer point groups having respective higher presence-related information as earlier waypoints in the TR than transfer points of transfer point groups having respective smaller presence-related information.

The method according to the first embodiment of the tenth aspect of the invention may for instance further comprise:
determining or learning that a position, which is a position of a person associated with a TBTE or is a position of the TBTE itself, is not within an area associated with one of the transfer point groups that comprises a transfer point associated with the TBTE, or is not within a pre-defined area associated with the transfer point;
receiving or establishing a new transfer point and/or a new timing constraint for the TBTE, wherein the new transfer point is either a new pick-up position or a new drop-off position for the TBTE;
determining, under consideration of the new pick-up position or the new drop-off position of the TBTE and/or the new timing constraint, a new set of one or more TRs by changing one or more TRs of the set of TRs and/or by adding one or more TRs, each associated with a respective TE and defining a respective sequence of waypoints, to the set of TRs; and
providing at least respective representations of at least a part of the one or more changed TRs and/or of the one or more added TRs to the respective TEs associated with the one or more changed TRs and/or the one or more added TRs.

The determining that the position is not within the area or the pre-defined area may comprise obtaining the position, e.g. via an app of a mobile device of a person that is or is associated with the TBTE, or via a server (e.g. of a communication system used by the mobile device of the person), and checking whether the obtained position is within the area or the pre-defined area. The pre-defined area can for instance be expressed as a pre-defined radius around the transfer point, or based on a pre-defined geographic area or a pre-defined area that is defined by at least a part of the postal address of the transfer point, e.g. an area comprising all addresses having the same zip code like the address of the transfer point, or the same street name, or falling within a pre-defined range of street numbers of the same street. The area of a transfer point group may for instance be an area associated with the transfer point group, for instance in a way that the area comprises all transfer points of the group and/or in a way that the area is defined by a post address (e.g. a zip code, or a zip code plus a street name) that is part of all respective postal addresses of the transfer points of the group.

The learning that a position is not within the area or within the pre-defined area may comprise receiving a notification, e.g. from an app (e.g. an app with monitoring functionality) of a mobile device of the person that is or is associated with the TBTE, or from a monitoring server, that the person has moved outside the area or the pre-defined area.

The new transfer point and/or the new timing constraint may for instance be received or established after it has been learned, in response to an inquiry, that the transfer point and/or a timing constraint associated with the TBTE shall be changed. The inquiry may for instance be directed to the person or to a mobile device of the person.

The new transfer point may for instance be the obtained position.

The plurality of TBTEs including the TBTE with the new pick-up position or the new drop-off position and/or the new timing constraint may for instance constitute a new plurality of TBTEs, and the new set of one or more TRs is then for instance determined for the new set of TBTEs to at least fulfil a criterion that, for each of the TBTEs of the new plurality of TBTEs, the pick-up position and drop-off position are associated with respective waypoints of one respective TR of the new set of TRs or are respective waypoints of two respective TRs of the new set of TRs which two respective TRs are directly connected or connected via one or more other TRs of the new set of TRs, and—in case a new timing constraint has been received or established—a further criterion that the new timing constraint is met

### Eleventh Aspect: On-Demand Deployment of TEs

According to a first embodiment of an eleventh aspect of the invention, the method according to any of the first to tenth aspect of the invention has the further feature that the determining of the set of one or more TRs comprises:
obtaining information on a position of a TE;
obtaining or determining a type of the TE;
determining, under consideration of the position of the TE and the type of the TE, a TR that is associated with the TE and defines a sequence of waypoints, wherein respective pick-up positions of one or more of the TBTEs and/or respective drop-off positions of one or more of the TBTEs are associated with waypoints of the TR;
inquiring whether the TE or an entity associated with the TE accepts that the TR is conducted by the TE;
   wherein the TR, in case its conductance by the TE is accepted, constitutes one of the TRs of the set of TRs or serves as a basis for determining one or more transfer routes of the set of transfer routes.

According to a second embodiment of the eleventh aspect of the invention, the method according to the second aspect of the invention or according to any of the third to tenth aspect of the invention as far as it is based on the second aspect of the invention has the further feature that the determining of the new set of one or more TRs comprises:
obtaining information on a position of a TE;
obtaining or determining a type of the TE;
determining, under consideration of the position of the TE and the type of the TE, a TR that is associated with the TE and defines a sequence of waypoints, wherein respective pick-up positions of one or more of the TBTEs and/or respective drop-off positions of one or more of the TBTEs are associated with waypoints of the TR;
inquiring whether the TE or an entity associated with the TE accepts that the TR is conducted by the TE;
   wherein the TR, in case its conductance by the TE is accepted, constitutes one of the TRs of the new set of TRs or serves as a basis for determining one or more transfer routes of the new set of transfer routes.

The method according to the eleventh aspect of the invention allows for the deployment of TEs as flexible resources in the routing process, in particular while keeping communication with the TEs to a minimum. As already explained with respect to the sixth aspect of the invention, it is generally advantageous to branch off secondary TRs from main TRs, which becomes possible by exchanging at least some of the TBTEs at the branch-off point between a TE associated with the main TR and the TE associated with the secondary TR. Secondary TRs can advantageously be delegated to subcontractors or crowders on an on-demand basis. The subcontractors or crowders constitute an example of an entity associated with the TE being inquired, or of the TE itself. The eleventh aspect of the invention inter alia proposes to assume, in the routing, that a TE, of which the position and type is known, is available for deployment, and to determine a TR for this TE accordingly. Only then the TE or an entity associated with the TE is actually inquired on whether the TR is accepted. The actual communication (e.g. of an apparatus or system that performs the method according to the eleventh aspect of the invention) with the entity associated with the TE or the TE itself may thus be limited to this inquiry, in which the details of the TR can already be presented, and which may be responded to with a simple accepting or declining message. The position of the TE may for instance be automatically determined and reported by an app on a mobile device of the entity associated with the TE or of the TE itself, without requiring further interaction at the mobile device (e.g. after once a consent to such monitoring has been expressed). This may happen periodically or on request (e.g. a request from an apparatus or system that performs the method according to the eleventh aspect of the invention). The type of the TE may for instance be derived from a plurality of positions or a movement pattern obtained from the mobile device, or from sensor information obtained from the mobile device (again preferably without any interaction at the mobile device). Alternatively, the type may be provided, e.g. from the app on the mobile device. From the perspective of the TE or an entity associated with the TE, an app on a mobile device of the TE or the entity associated with the TE may allow to define the type of the TE, may allow to consent to continuous or on-demand position monitoring, and/or may allow to TR inquiries and to accept or decline such inquiries.

In the following, further features of the first and second embodiment of the tenth aspect will be described. Therein, if the set of one or more TRs and/or the new set of one or more TRs are concerned, the notation “the (new) set of one or more TRs” will be used.

Information on the position of the TE may for instance be obtained (e.g. received) via an app of a mobile device of a person being or being associated with the TE, or from the TE itself, or via a server of a communication system that is used by the mobile device or by the TE.

The type of the TE may for instance be received from the TE or from a mobile device of a person being or being associated with the TE, or derived from received information, e.g. from a velocity, position in a map and/or trace in a map.

The TR may for instance be a secondary TR that is branched off from a (main) TR, or a main TR that is at least partially merged or combined with another (main) TR.

The TE may for instance be a TE (e.g. a small lorry or van, car, motorbike, scooter, bicycle, etc.) of a crowder or a crowder itself.

The method according to the eleventh aspect of the invention, if based on the method according to the second aspect of the invention, may for instance have the further feature that at least one of the one or more TBTEs whose respective pick-up positions and/or drop-off positions are associated with waypoints of the TR is directly or indirectly affected or represented by at least a part of the further information that is obtained and considered in the determining of the new set of one or more TRs.

Therein, for instance at least one of the one or more TBTEs whose respective pick-up positions and/or drop-off positions are associated with waypoints of the TR is at least one of the one or more further TBTEs or is at least one of the at least one TBTE affected by the change information.

### Twelfth Aspect: Energy-Efficient Routing

According to a twelfth aspect of the invention, the method according to any of the first to eleventh aspect of the invention has the further feature that in the determining of the set of TRs, at least one routing restriction is applied that targets to reduce an energy consumption and/or to increase a range of at least one TE associated with a respective TR of the set of TRs.

The reduction of the energy consumption may also improve the range a TE can cover without being stationarily powered anew (e.g. by fueling or loading) in particular in case of electrically powered TEs.

The at least one routing restriction may for instance be specific for a type of the at least one TE, in particular for a type of energy required for movement of the TE.

The at least one routing restriction may for instance at least partially be considered when determining the respective optimized routes between the respective first transfer points and the respective second transfer points of the pairs or transfer points for which respective characteristic values are comprised in the data structure, as described with respect to the fourth aspect of the invention above. For instance, if the routing restriction is to avoid ascents with a gradient above a pre-defined threshold, the routes between the two transfer points of each pair of transfer points may for instance be optimized according to this criterion. If the routing restriction is to avoid ascents with a gradient above a pre-defined threshold in particular when the TE has a loading condition that is above a pre-defined threshold, the routes between the two transfer points of each pair of transfer points may for instance be optimized to avoid ascents to the extent possible. The loading condition may then be considered when determining, based on the data structure, the set of one or more TRs.

It may also be advantageous to have, for each pair of transfer points, respective characteristic values of two or more respective optimized routes between the respective first transfer point and the respective second transfer point of the pair, which routes have been optimized according to respective different optimization criteria. The data structure may then have, for each pair, two or more characteristic values, each representative of a respective route optimized according to a respective optimization criterion. One optimization criterion may for instance avoid ascents with a gradient above a pre-defined threshold, while another optimization criterion may for instance target at shortest routes. This data structure could alternatively be stored as plural data structures, each specific for one optimization criterion.

The data structure(s) including the results specific for different optimization criteria may then be jointly considered in the determining of the set of one or more TRs, e.g. in a way that as long as a TE is projected to have a loading condition above a pre-defined threshold, the data structure specific for the optimization criterion avoiding ascents with a gradient above a pre-defined threshold is applied, and as soon as the projected loading condition is below the pre-defined threshold, the data structure specific for the optimization criterion targeting shortest routes is applied.

Instead of (or in addition to) avoiding ascents with a gradient above a pre-defined threshold, it may be avoided to have, along a route, positive altitude differences above a pre-defined threshold. An altitude difference is considered as the difference between the respective altitudes of two positions of the route. A positive altitude difference indicates a change from a lower altitude to a higher altitude.

At least two different routing restrictions may for instance be applied for two different types of TEs, respectively.

The at least one routing restriction may for instance take into account ascents (in particular with a gradient above a pre-defined threshold) and/or positive altitude differences (in particular above a pre-defined threshold) in the TR associated with the at least one TE and a respective loading condition of the at least one TE at least during the ascents and/or during the positive altitude differences of the TR associated with the at least one TE.

The at least one routing restriction may for instance require one or more of the following:
avoiding or reducing ascents, in particular with a gradient above a pre-defined threshold, in the TR associated with the at least one TE;
avoiding or reducing positive altitude differences (in particular above a pre-defined threshold), in the TR associated with the at least one TE;
avoiding or reducing ascents, in particular with a gradient above a pre-defined threshold, in the TR associated with the at least one TE at least when the at least one TE has a respective loading condition during the ascents that is above a pre-defined threshold;
avoiding or reducing positive altitude differences (in particular above a pre-defined threshold), in the TR associated with the at least one TE at least when the at least one TE has a respective loading condition during the occurrence of the positive altitude differences that is above a pre-defined threshold;
favoring descents, in particular with a gradient above a pre-defined threshold, in the TR associated with the at least one TE;
favoring descents, in particular with a gradient above a pre-defined threshold, in the TR associated with the at least one TE when the at least one TE has a respective loading condition at the descents that is above a pre-defined threshold;
favoring negative altitude differences (in particular above a pre-defined threshold), in the TR associated with the at least one TE;
favoring negative altitude differences (n particular above a pre-defined threshold), in the TR associated with the at least one TE when the at least one TE has a respective loading condition at the negative altitude differences that is above a pre-defined threshold; avoiding or reducing stop-and-go situations in the TR associated with the at least one TE.

For all aspects of the invention presented above (referred to as the “respective aspect” below), the following is disclosed:
A computer program according to the respective aspect of the invention, the computer program when executed by a processor causing an apparatus or system to perform or control the method according to the respective aspect of the invention.
A computer readable storage medium according to the respective aspect of the invention, in which the computer program according to the respective aspect of the invention is stored. The computer readable storage medium could for example be a disk or a memory or the like. It may for instance be tangible and/or non-transitory. The computer program could be stored in the computer readable storage medium in the form of instructions encoding the computer-readable storage medium. The computer readable storage medium may be intended for taking part in the operation of a device, like an internal or external memory (e.g. a Read-Only Memory (ROM)) or hard disk of a computer, or be intended for distribution of the program, like an optical disc.
An apparatus according to the respective aspect of the invention, which is configured to perform or comprises respective means for performing or controlling the method according to the respective aspect of the invention. The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means.
An apparatus according to the respective aspect of the invention, comprising at least one processor and at least one memory including computer program code, the at least one memory and the computer program code configured to, with the at least one processor, cause an apparatus (e.g. the apparatus according to the respective aspect of the invention) at least to perform or control the method according to the respective aspect of the invention.
A system according to the respective aspect of the invention, the system comprising a plurality of apparatuses and configured to perform or comprises respective means for performing or controlling the method according to the respective aspect of the invention.

The disclosed apparatus according to any aspect of the invention may be a module or a component for a device, for example a chip. Alternatively, the disclosed apparatus according to any aspect of the invention may be a device, for instance a server or other electronic device. The disclosed apparatus according to any aspect of the invention may comprise only the disclosed components (e.g. means) or may further comprise one or more additional components.

Furthermore, a TE is disclosed, configured to be used in a system according to any of the first to twelfth aspect of the invention, in particular one of the TEs associated with a TR and configured to receive and process a respective representation of at least a part of the TR it is associated with.

Furthermore, a device associable with a TE is disclosed, the device configured to be used in a system according to any of the first to twelfth aspect of the invention, in particular a device associable with one of the TEs that are respectively associated with a TR of the set of one or more TRs and configured to receive and process a respective representation of at least a part of the TR the TE is associated with.

It is to be understood that the presentation of the invention in this section is merely by way of examples and non-limiting.

Other features of the invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

In the figures show:

FIG. 1 shows a schematic block diagram of an example embodiment of a system according to any of the first to twelfth aspect of the invention;

FIG. 2 shows a schematic block diagram of example embodiment of an apparatus according to any of the first to twelfth aspect of the invention;

FIG. 3 shows a flowchart showing an example embodiment of a method according to the first aspect of the invention;

FIG. 4 shows a flowchart showing an example embodiment of a method according to the second aspect of the invention;

FIG. 5 shows a flowchart showing an example embodiment of substeps performed in step 302 of FIG. 3 and step 402 of FIG. 4;

FIG. 6 shows a flowchart showing an example embodiment of a bottom-up clustering method according to the fifth aspect of the invention;

FIGS. 7a-7e show examples for inclusion of a new TBTE into already determined TRs of a cluster according to step 604 of FIG. 6;

FIG. 8 shows a flowchart showing a further example embodiment of a clustering method according to the fifth aspect of the invention;

FIGS. 9a-9c show examples for the application of the clustering method of FIG. 8 to a plurality of TBTEs;

FIGS. 10a-10c show an example for a transformation of a TR into a main TR and a couple of secondary TRs according to the sixth aspect of the invention;

FIG. 11a-11b show an example for an exchange of waypoints between a first TR and a second TR according to the seventh aspect of the invention;

FIG. 12 shows a flowchart showing an example embodiment of a method according to the ninth aspect of the invention;

FIG. 13 shows a flowchart showing an example embodiment of a method according to the tenth aspect of the invention;

FIG. 14 shows a flowchart showing an example embodiment of a method according to the eleventh aspect of the invention; and

FIG. 15 shows a schematic block diagram showing functional blocks of a system according to the twelfth aspect of the invention.

### DETAILED DESCRIPTION OF EXAMPLE EMBODIMENTS OF THE INVENTION

Example embodiments of the invention pertain to routing, i.e. to determining a set of one or more TRs that handle pick-ups and drop-offs for a plurality of TBTEs, which may either be objects or persons. A particular focus of the invention is to provide a routing solution that is computationally efficient to allow real-time or close-to real-time application, yet providing high quality of the TRs. Furthermore, ad-hoc inclusion of further TBTEs and/or change of characteristics of TBTEs that have already been considered in the TRs are supported. Different optimization criteria can be chosen for the routes, inter alia to achieve short routes and/or energy-efficient routes. Representations of at least parts of the TRs are provided to TEs and cause the TEs to conduct (e.g. follow) the TRs. Example aspects of the invention have already been presented in detail in the SUMMARY portion of this specification, wherein the disclosure of the SUMMARY portion shall be understood to apply to and complement the disclosure in the DETAILED DESCRIPTION portion of the specification.

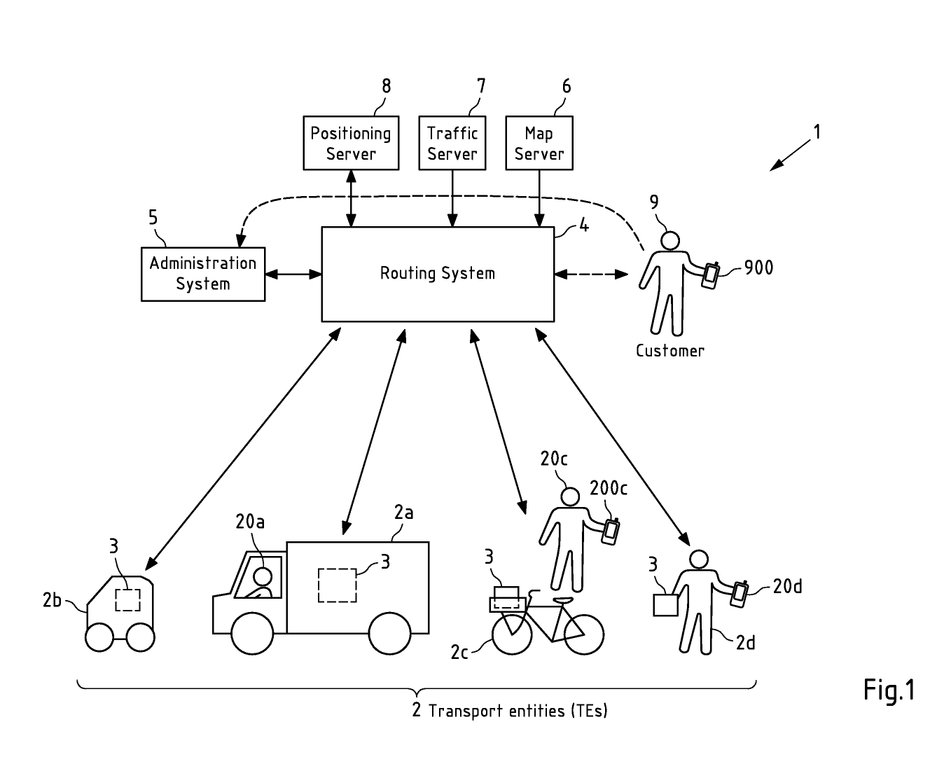

FIG. 1 is a schematic block diagram of an example embodiment of a system 1 according to any of the first to twelfth aspect of the invention. System 1 comprises, as main components, a routing system 4, e.g. in the form of a server or server cloud, a plurality of TEs 2a, 2b, 2c and 2d, commonly also referred to with reference numeral 2, a plurality of TBTEs 3 and a customer 9. The TBTEs 3 are illustrated as objects, e.g. shipments (for instance parcels), but may equally well be persons. For instance, customer 9 may rea TBTE.

It is the aim of system 1 to determine a set of one or more TRs, with one respective TR per TE, so that TBTEs from a plurality of TBTEs 3 can be transported from respective pick-up positions to respective drop-off positions. The pick-up position of a TBTE may for instance be at a depot (e.g. an outbound hub of a logistics (e.g. delivery) company) or train station/airport, for example, and the drop-off position may be an individual address of a customer 9. Equally well, the drop-off position may for instance be at a depot (e.g. an inbound hub of a logistics (e.g. delivery) company) or train station/airport, and the pick-up position may be an individual address of a customer 9. In this way, for instance a parcel as example for a TBTE may be ordered by customer 9 e.g. in an online-shop, and may then—on the “last mile”—be delivered to the customer 9 with a depot (to which the parcel has been delivered as an intermediate station) as a pick-up position and the individual address of customer 9 as drop-off (or delivery) position, wherein the TR comprises the pick-up position and the drop-off position as respective waypoints and is conducted by a TE 2. Equally well, customer 9 may have a parcel that was erroneously ordered by customer 9 and shall be sent back to an online-shop, for instance. In this “first-mile” scenario, the pick-up position would be the individual address of customer 9, and the drop-off position would the position of a depot, where a plurality of parcels including the parcel is further processed to cause its delivery back to the online-shop.

The pick-up position and the drop-off position of a TBTE 3 may not have to be directly combined by a single TR. In example embodiments of the invention, the pick-up position and the drop-off position may be associated with different TRs, which TRs have however to be directly or indirectly (e.g. via at least one or more further TRs) connected. Two TRs are considered to be directly connected if they share a waypoint, which is denoted as exchange waypoint, and may or may not be additionally associated with a pick-up position or a drop-off position of a TBTE 3. Two TRs are considered to be indirectly connected if a TBTE 3 can be transported from one of the two TRs to another of the two TRs via a chain of TRs that are respectively directly connected at respective exchange waypoints, e.g. the first to the second, the second to the third, etc. At the exchange waypoints, a TBTE 3 changes the TE 2, e.g. from a first TE 2 associated with a first TR to a second TE 2 associated with a second TR. TRs can be main TRs or secondary TRs that e.g. branch off from main TRs, respectively.

In system 1, information on TBTEs 3 (e.g. pick-up position, drop-off position, details of a person associated with the TBTE (e.g. his/her address, e.g. in the form of a postal address or an identifier allowing to track a position of the person), and/or respective timing constraints for pick-up and/or delivery) are maintained at administration system 5. This information may for instance stem from a customer 9 that orders collection of a to-be-returned parcel at his individual address (as pick-up position) and specifies the address where the to-be-returned shipment shall be sent, optionally with a time constraint specifying a time period when pick-up at the customer's address is possible/desired), or may be taken (e.g. by scanning, e.g. at a parcel shop or in-bound hub where the parcel is processed during its delivery) from address information that has been marked on parcels by a sender of the parcel (e.g. the online shop of the above example).

The administration system is configured to provide information on a plurality of TBTEs 3 to routing system 4, e.g. via a networked connection. This information may for instance be in the form of requests for transport of the respective TBTEs. Based on this information, and on further information obtained from a positioning server 8 (e.g. information on a position of a customer or TE, e.g. useable in the ninth to eleventh aspect of the invention), a traffic server 7 (providing real-time traffic information) and a map server 6 (providing map material comprising e.g. road data), e.g. respectively via a networked connection, the routing system 4 determines a set of one or more TRs for TEs 2 to ensure respective pick-up and drop-off of this plurality of TBTEs 3. The information provided from servers 6-8 is jointly referred to as routing information herein. Positioning server 8 may apply one or more techniques for determining positions of e.g. persons, TEs 2, etc., for instance positioning based on cell-based (mobile radio communication) positioning, reporting of positions determined by devices themselves (e.g. via GPS or WiFi-based positioning) to positioning server 8, etc.).

Respective representations of at least a part of these TRs are provided to the TEs 2 or to devices 220c or 20d associated with respective TEs 2c or 2d (in the case of TE 2c, the association is a respective operator/driver of TE 2c that uses device 200c). In particular, each of the TEs 2 receives only a representation of at least a part of the TR that is associated with the respective TE 2. The representation may contain the entire TR, or only parts thereof, e.g. with respect to one or more next waypoints, for example. The representations of at least a part of the TRs may be provided to the TEs 2 via wireless connection, e.g. based on cellular radio or WiFi, to name but some examples. The TEs 2 then follow the TRs.

If the TE 2 is a TE 2b capable of autonomous or semi-autonomous movement (e.g. driving/flying/swimming/walking), the representation of the at least a part of the TR causes the TE 2b to automatically follow the TR (and stop at the pick-up/drop-off waypoints of the TR). In case of the TE 2 being a TE 2a driven by an operator 20a (e.g. a driver or pilot), the representation of the at least a part of the TR is presented to operator 20a to cause him to follow, with his TE 2a, the route. Similarly, in case of TE 2c, the representation of the at least a part of the TR is presented to operator 20c (e.g. a driver or pilot), however via a device 200c, and in this way causes operator 20c to follow, with his TE 2c, the TR. If the TE 2 is a person 2d, the representation of the at least a part of the TR is presented to person 2d (e.g. a driver or pilot), however via a device 20d associated with the person, and in this way causes person/TE 2d to follow the TR.

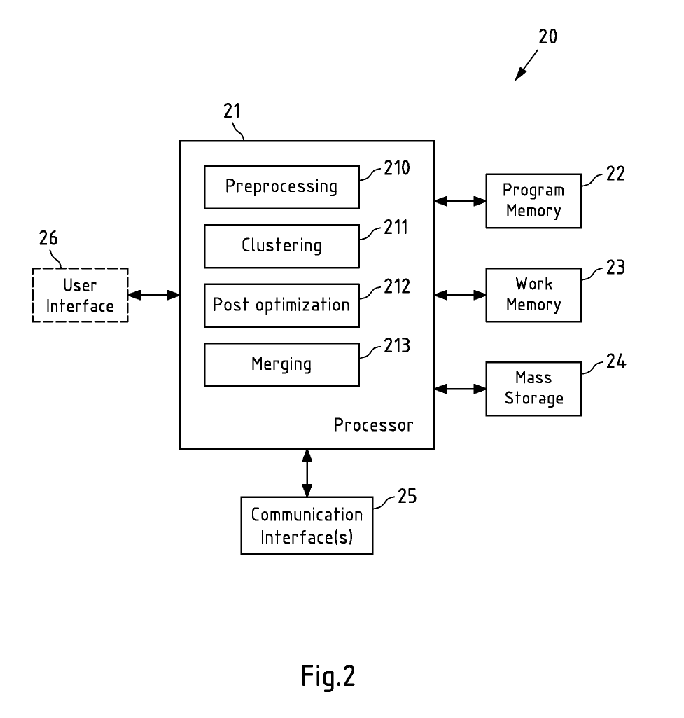

FIG. 2 is a schematic block diagram of example embodiment of an apparatus according to any of the first to twelfth aspect of the invention. Apparatus 20 may for instance form at least a part (e.g. a functional unit or module) of the routing system 4 (FIG. 1). Apparatus 20 may equally well represent the functional units of a system that comprises several apparatuses to implement the functionality of routing system 4.

Apparatus 20 comprises at least one processor 21 and at least one program memory 22 including computer program code, the at least one memory 22 and the computer program code configured to, with the at least one processor 21, cause an apparatus (for instance apparatus 20, or another apparatus that comprises apparatus 20) at least to perform the method according to any aspect of the invention. Processor 21 for instance executes the computer program code stored in program memory 22. Processor 21 for instance accesses program memory 22 via a bus. The computer program stored in program memory 22 is an example of a computer program according to the respective aspect of the invention, i.e. a computer program that when executed by processor 21 causes apparatus 20 (or an apparatus that comprises apparatus 20) to perform the actions of the method according to the respective aspect of the invention.

Program memory 22 may also be included into processor 21. This memory may for instance be fixedly connected to processor 21, or be at least partially removable from processor 22, for instance in the form of a memory card or stick. Program memory 22 may for instance be non-volatile memory. It may for instance be a FLASH memory (or a part thereof), any of a ROM, PROM, EPROM and EEPROM memory (or a part thereof) or a hard disc (or a part thereof), to name but a few examples. Memory may also comprise an operating system for processor 22. Program memory 22 may also comprise a firmware for apparatus 20.

In the apparatus 20, further a work memory 23 may be present, for instance in the form of a volatile memory. It may for instance be a Random Access Memory (RAM) or Dynamic RAM (DRAM), to give but a few non-limiting examples. It may for instance be used by processor 21 when executing an operating system and/or computer program.

A mass storage 24 may for instance be used to store large amounts of data, such as for instance map data obtained (e.g. regularly) from map server 6 (FIG. 1).

Processor 21 (and also any other processor mentioned in this specification) may be a processor of any suitable type. Processor 21 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 21 may for instance be an application processor that runs an operating system.

Some or all of the components of the apparatus 20 may for instance be connected via a bus. Some or all of the components of the apparatus 20 may for instance be combined into one or more modules.

Apparatus 20 further comprises one or more communication interface(s) 25 that allow apparatus 20 to communicate with remote devices. The communication interface(s) may for instance comprise an interface for networked (e.g. wirebound) communication (e.g. with administration system 1, map server 6, traffic server 7 and positioning server 8) and/or an interface for wireless (e.g. radio-based or optical) communication (e.g. with the TEs 2, with devices 200c or 20d or customer 9 or device 900).

Apparatus 20 further comprises an optional user interface 26 (e.g. a keyboard and monitor) for allowing interaction of an operator with apparatus 20.

Processor 20 may comprise the following functional units: a preprocessing unit 210, a clustering unit 211, a post-optimization unit (may be optional) and a merging unit 213 (may be optional). The functionality of these units will be further described below.

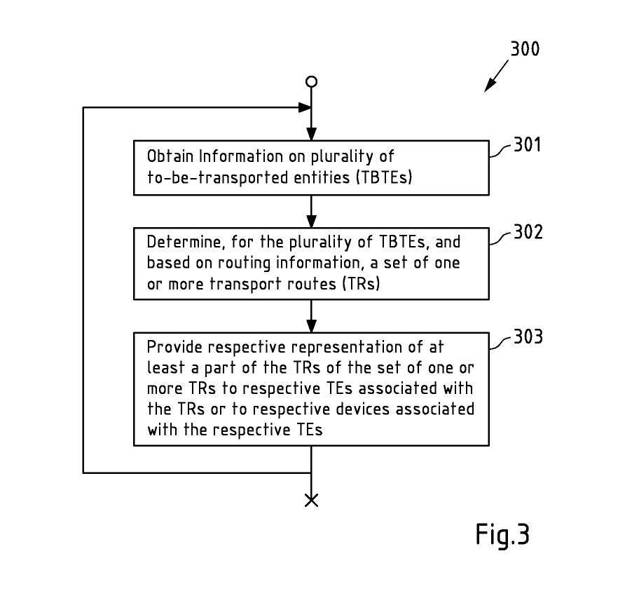

FIG. 3 is a flowchart 300 showing an example embodiment of a method according to the first aspect of the invention (on which also the further aspects of the invention are based on). This method may for instance be performed by routing system 4 and/or apparatus 20.

In a step 301, information on a plurality of TBTEs 3 is received. In a step 302, for the plurality of TBTEs 3, and based on routing information, a set of one or more TRs is determined. In step 303, a respective representation of a least a part of the TRs is provided to the TEs 2 associated with the TRs or to devices associated with the TEs 2. After step 303, the flowchart 300 returns to step 301.

The steps 301-303 of flowchart 300 may for instance be performed once per day to determine the set of one or more TRs for one day, or twice a day (e.g. early in the morning and at noon) to respectively determine sets of TRs for the morning and the afternoon, to name but an example.

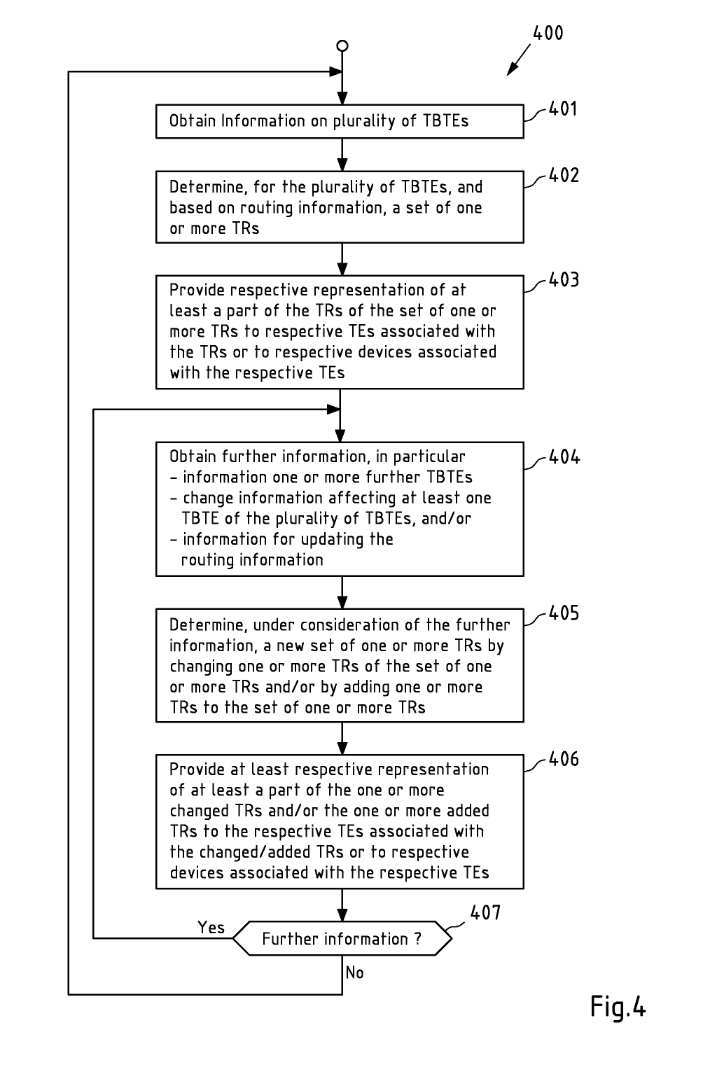

FIG. 4 is a flowchart 400 showing an example embodiment of a method according to the second aspect of the invention. This method may for instance be performed by routing system 4 and/or apparatus 20.

The steps 401-403 correspond to steps 301-303 of the flowchart 300 of FIG. 3. Flowchart 400 however also allows definition and consideration of changes to characteristics (e.g. pick-up/drop-off positions and/or timing constraints) of TBTEs 3 for which TRs already have been determined in step 302, and addition and consideration of further TBTEs 3. This happens after the set of one or more TRs has already been determined, e.g. in the course of a day for which the set of one or more TRs has been determined and while at least some of these TRs have already started.

To this end, in step 404, further information is obtained, e.g. information on one or more further TBTEs 3 (e.g. from administration system 5 or customer 9), change information affecting at least one TBTE 3 of the plurality of TBTEs (e.g. from administration system 5 or customer 9), and/or information for updating the routing information (e.g. from servers 6, 7 or 8 of FIG. 1).

In step 405, then, under consideration of the further information, a new set of one or more TRs is determined by changing one or more TRs of the set of one or more TRs (determined in step 402) and/or adding one or more TRs to the set of one or more TRs (determined in step 402). The new set of one or more TRs may thus comprise at least a part of the already determined set of one or more TRs, except the changed/added TRs. The further information may thus only affect one or more of the already determined TRs, but not necessarily all of them. It is also conceivable that none of the already determined TRs is affected, and that instead a new TR has to be generated to take account of the further information.

In step 406, then at least respective representations of at least a part of the one or more changed TRs and/or the one or more added TRs are provided to the respective TEs 2 associated with the changed/added TRs or to respective devices 200c, 20d associated with the respective TEs 2.

In a step 407, it is checked if further information is available. If this is the case, the flowchart 400 jumps to step 404 to obtain this further information. Otherwise, the flowchart 400 jumps to step 401 as shown in FIG. 4 or terminates.

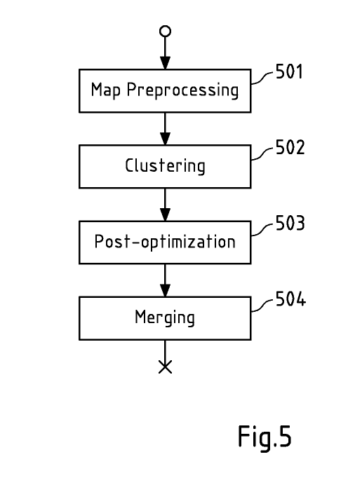

FIG. 5 is a flowchart 500 showing an example embodiment of substeps performed in step 302 of FIG. 3 and step 402 of FIG. 4.

The flowchart 500 comprises a map pre-processing substep 501, a clustering substep 502, a post-optimization substep 503, and a merging substep 504. One or more of these substeps may be optional in example embodiments of the invention.

The map pre-processing step 501 has already been discussed with respect to the fourth aspect of the invention. This pre-processing may comprise the following:
Defining a set T that at least comprises all positions t (pick-up positions and all drop-off positions) of all TBTEs of the plurality of TBTEs.
Reading a base graph G:=(V, E) and restrictions Rₖ for k∈K (with K denoting the number of different TE types). The base graph may for instance be read from a map database (e.g. map server 6 of FIG. 1). The restrictions may for instance represent prohibited sequences of edges e∈E of the graph cannot be used by the specific TE type k. Rₖ may for instance also be read from a database, e.g. map server 6 of FIG. 1.
Applying the unity of the restrictions U_{k∈K} Rₖ to the base graph G to obtain the graph Gₐₗₗᵣₑₛₜᵣ.
Computing the largest strongly connected component L in Gₐₗₗᵣₑₛₜᵣ (e.g. ensuring that each point of the graph Gₐₗₗᵣₑₛₜᵣ can be reached from each other point).
Projecting each transfer point t∈T to a closest edge e in L and applying this projection to G to obtain a graph G^{T}. Projecting is accomplished by subdividing an edge e at the projection point or snapping to a close endpoint of e.
For each k∈K, applying the restriction Rₖ to G^{T} to obtain Gₖ^{T}.
For each k∈K, finding the shortest path w.r.t. speed in Gₖ^{T} from t₁ to t₂ for all pairs (t₁, t₂) from T with t₁≠t₂. Alternatively, other single or joint optimization criteria may be applied than optimizing for shorted path, e.g. optimizing for path with lowest energy consumption, etc.

As also already explained above, the pre-computed graph Gₐₗₗᵣₑₛₜ and the largest strongly connected component L can be used for determining a set of one or more TRs several times, as long as the base graph G (map data) and the restrictions Rₖ do not change.

Furthermore, considering the largest strongly connected component when projecting the transfer points onto G, it is ensured in later processing stages (in particular in clustering 502, post-optimization 503 and merging 504) that TE specific restrictions do not have to be individually considered when attempting to connect, branch-off or merge TRs, which significantly contributes to reducing the computational complexity and thus to reduce the run-time.

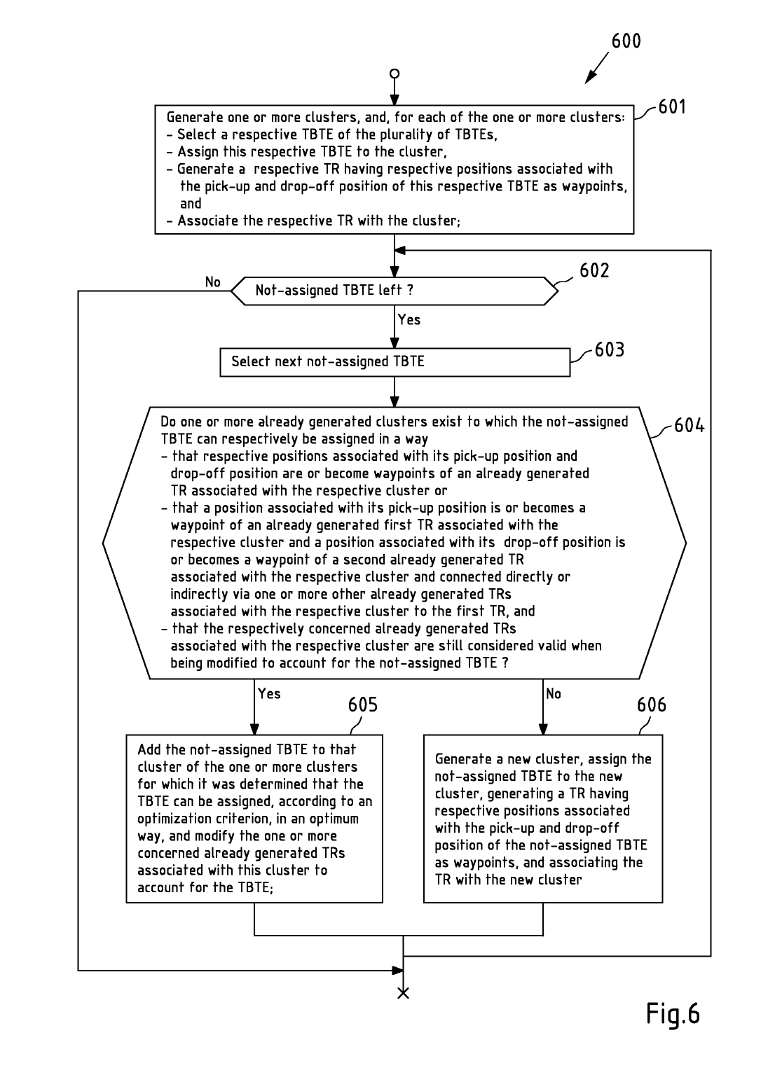

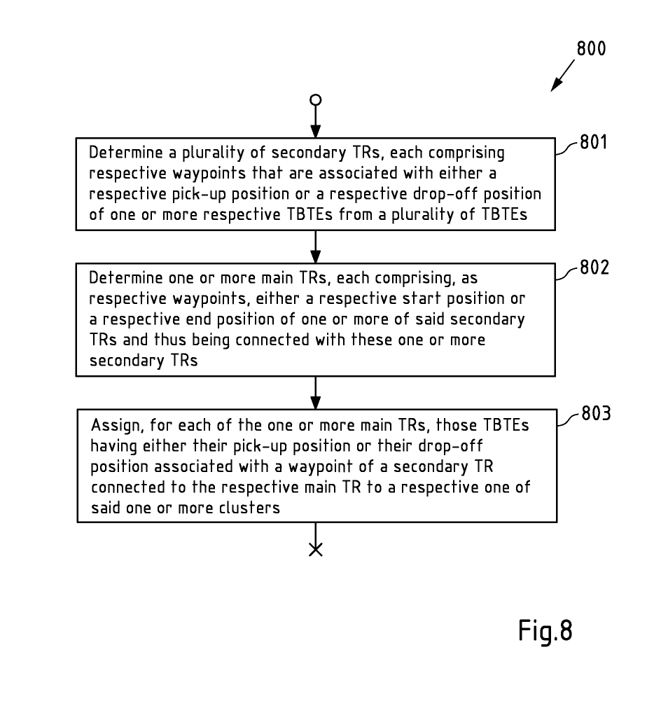

The clustering 502 may for instance be performed in two different ways, either in a bottom-up approach, which is explained with reference to FIG. 6 below, or as an approach that determines secondary TRs first and then connects them via main TRs, as will be described with reference to FIG. 8 below.

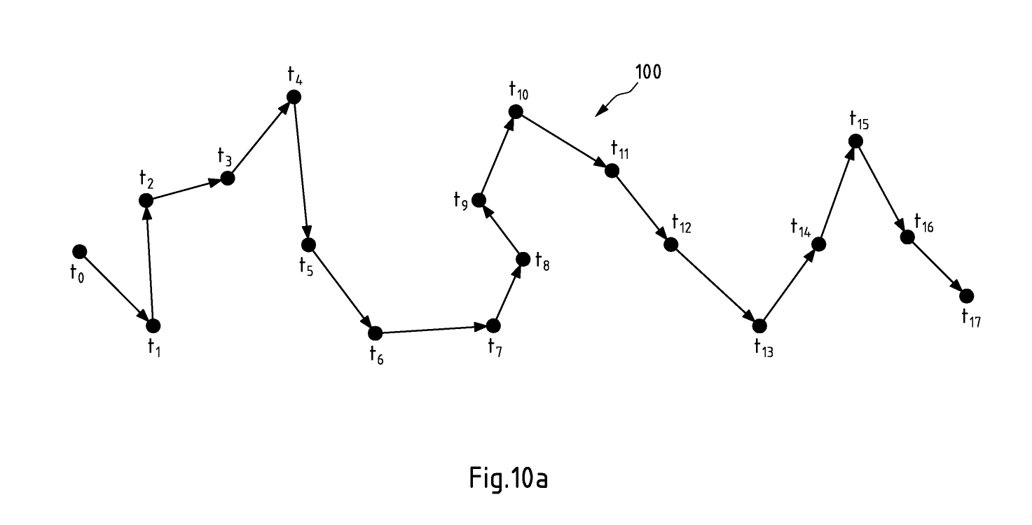

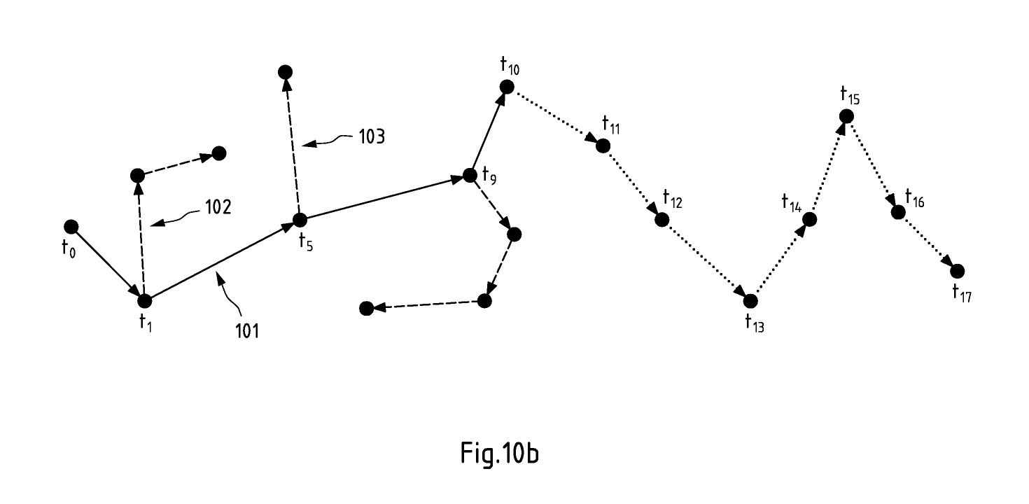

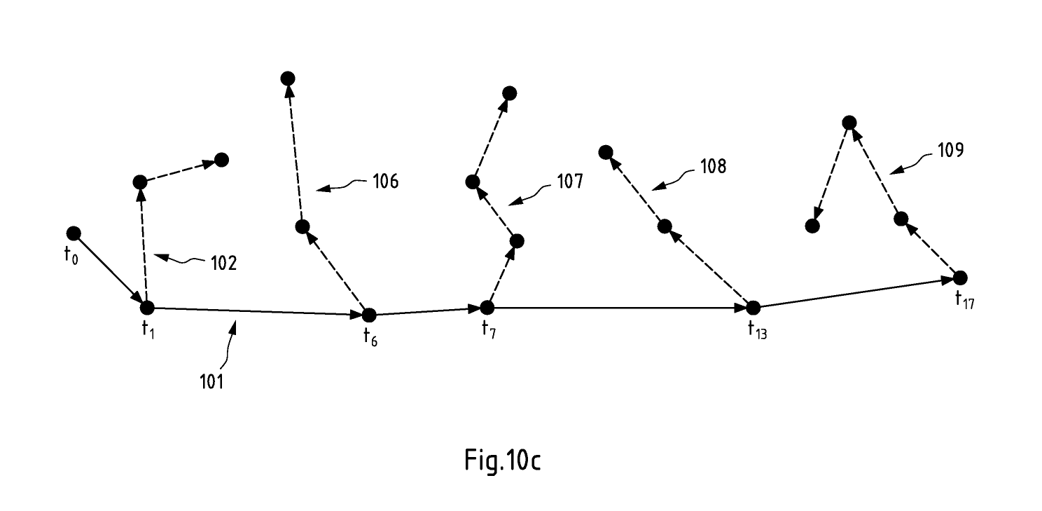

Post-optimization 503 may comprise intra-cluster optimization (e.g. re-optimization of TSP TRs within a cluster followed by a processing to identify opportunities for secondary TRs, see FIGS. 10a-10c below), and/or inter-cluster optimization (e.g. swapping subsets of TBTEs between clusters).

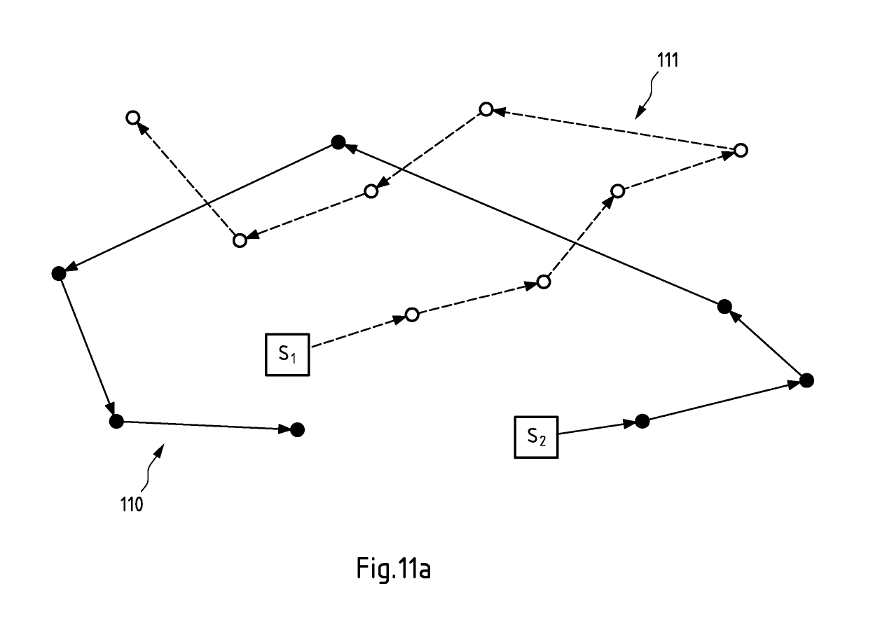

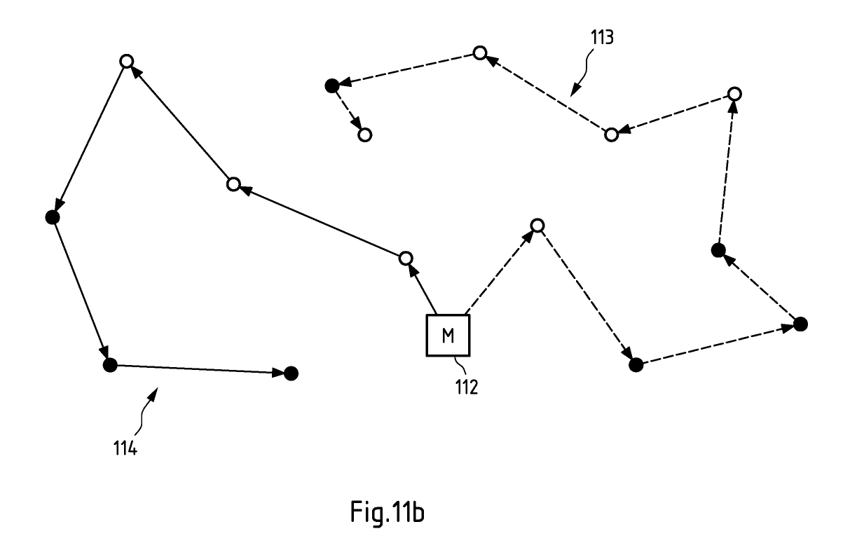

Merging 504 (also denoted as waypoint exchanging herein) will be further explained with reference to FIGS. 11a and 11b below.

FIG. 6 is a flowchart 600 showing an example embodiment of a bottom-up clustering method according to the fifth aspect of the invention. This approach is based on sequentially adding TBTEs 3 to already existing clusters as long as restrictions of the TRs of the clusters can be met, and if this is no longer the case, opening a new cluster. This method may for instance be performed by apparatus 20 (FIG. 2), in particular by clustering unit 211 thereof, and/or routing system 4 (FIG. 1).

One embodiment of this bottom-up clustering may take the shape reflected by FIG. 6:

In a step 601, one or more clusters are generated, and, for each of the one or more clusters, a respective TBTE 3 of the plurality of TBTEs 3 is selected, this respective TBTE 3 is assigned to the cluster, a respective TR is generated having respective positions associated with the pick-up and drop-off position of this respective TBTE 3 as waypoints, and the respective TR is associated with the cluster. Therein, the selection of the initial TBTE 3 may for instance be random, or in a way that the positions (e.g. the drop-off positions) of these initial TBTEs 3 are far away from each other, or according to a selection algorithm that takes the distribution of some or all of the TBTEs 3 of the plurality of TBTEs 3 into account.

In step 602, it is checked if, from the plurality of TBTEs 3, still not-assigned TBTEs 3 are left. If this is not the case, the flowchart 600 terminates. Otherwise, in step 603, a next not-assigned TBTE 3 is selected (e.g. randomly, or in sequence of storage).

In a step 604, the following is checked: Do one or more already generated clusters exist to which the not-assigned TBTE 3 can respectively be assigned in a way
that respective positions associated with its pick-up position and drop-off position are or become waypoints of an already generated TR associated with the respective cluster or
that a position associated with its pick-up position is or becomes a waypoint of an already generated first route associated with the respective cluster and a position associated with its drop-off position is or becomes a waypoint of a second already generated TR associated with the respective cluster and connected directly or indirectly via one or more other already generated TRs associated with the respective cluster to the first TR, and
that the respectively concerned already generated TRs associated with the respective cluster are still considered valid when being modified to account for the not-assigned TBTE 3?

If step 604 comes to a positive result, in step 605, the not-assigned TBTE 3 is added to that cluster of the one or more clusters for which it was determined that the TBTE 3 can be assigned, according to an optimization criterion, in an optimum way.

Otherwise, in step 606, a new cluster is generated, the not-assigned TBTE 3 is assigned to the new cluster, a TR having respective positions associated with the pick-up and drop-off position of the TBTE 3 as waypoints is generated, and the TR is associated with the new cluster.

The flowchart 600 then returns to step 602 and checks whether further not-assigned TBTEs 3 are left to be clustered.

After flowchart 600 has finished, thus all TBTEs 3 of the plurality of TBTEs 3 have been assigned to clusters, wherein in each cluster, one TR or more than one (connected) TRs (e.g. a main TR with one or more connected secondary TRs) take care of the TBTEs 3 of the respective cluster.

Therein, it is particularly advantageous that already after a single run of flowchart 600, a valid clustering and also a valid of assignment of TBTEs 3 to TRs is available, which is particularly advantageous for real-time applications with limited time budget

In step 605 of flowchart 600, a further (optional) optimization may be applied to improve the quality of the solution. Step 605 may then further comprise:
determining, according to an evaluation criterion, a first quality measure for the one or more already generated and possibly modified TRs associated with this cluster;
determining an alternative assignment of the pick-up positions and drop-off positions of all TBTEs 3 comprised by this cluster to one or more TRs, in which the one or more TRs are considered valid (e.g. do not exceed the respective capacity load of the respective TE, and/or do not exceed timing constraints associated with the TBTEs), and determining, according to the evaluation criterion, a second quality measure for the one or more TRs yield by the alternative assignment; and
if the second quality measure is better than the first quality measure, associating the one or more TRs yield by the alternative assignment with this cluster, and keeping the association of the one or more already generated and possibly modified TRs with this cluster otherwise.

The alternative assignment of the pick-up positions and drop-off positions of all TBTEs 3 comprised by this cluster to one or more TRs may for instance comprise applying a TSP algorithm to a single TR that comprises all pick-up positions and drop-off positions of the TBTEs 3 comprised by the cluster and applying a secondary TR identification algorithm (as explained with reference to FIGS. 10a-10c below) to this single route.

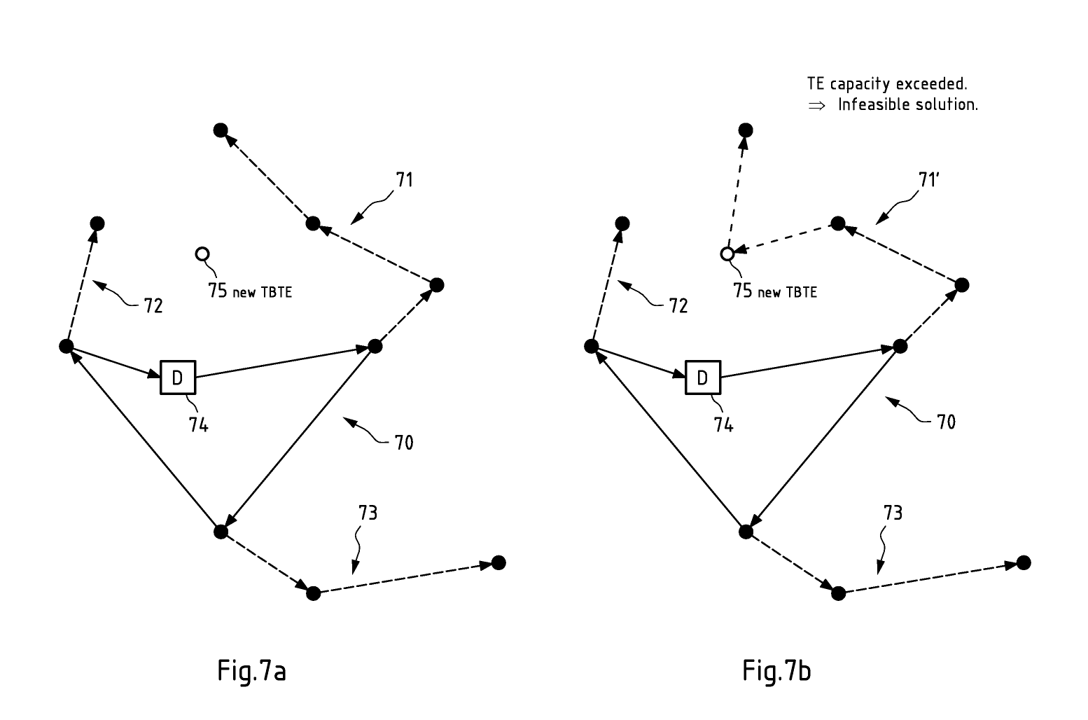

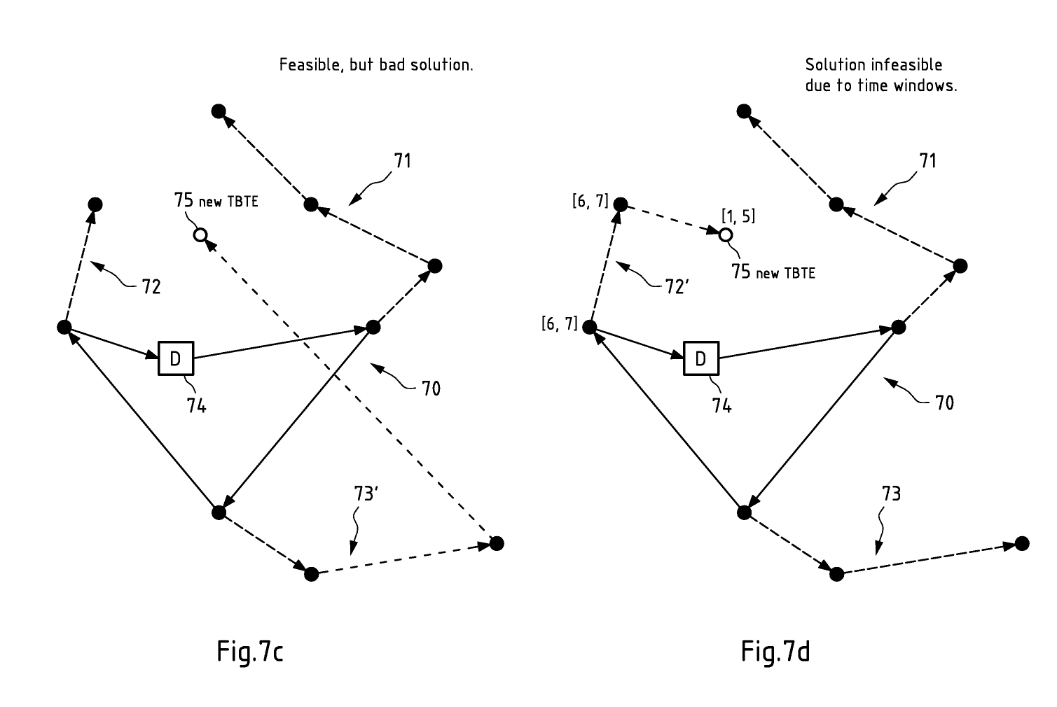

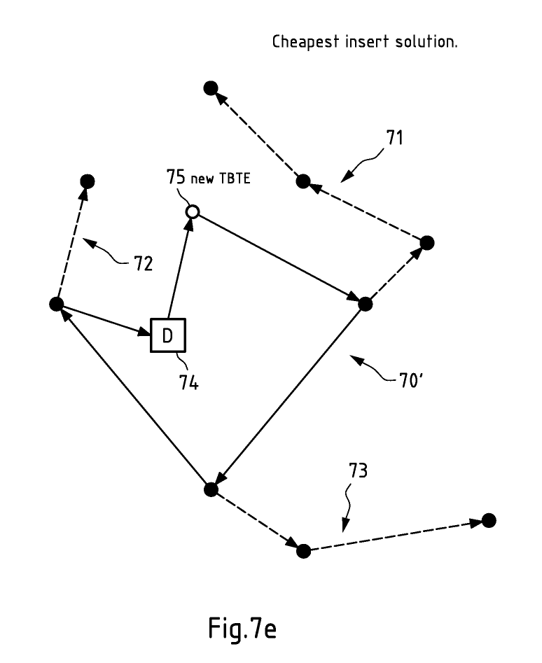

FIGS. 7a-7e are examples for inclusion of a new TBTE 3 into already determined TRs of a cluster according to step 604 of FIG. 6. The underlying inclusion algorithm is denoted as “cheapest insert” algorithm since it targets to find a TR for inclusion of the TBTEs 3 that minimizes a cost function (e.g. maximizes an optimization criterion).

In FIG. 7a, a main TR 70 is shown in solid lines, which starts and ends at depot 74. Three secondary TR (in dashed lines) 71, 72 and 73 branch off respectively from the main TR 70. As indicated by the arrows, the secondary TRs 71, 72 and 72 only comprise drop-off waypoints. The TBTEs are for instance all picked-up at depot 74, transported by the main TR to the branch-off (or exchange) waypoint of secondary TR 71, where the TBTEs associated with the waypoints of the secondary TR 71 are unloaded from a TE that conducts the main TR 70 into a TE that conducts the secondary TR 71. The TE that conducts the main TR 70 then continues to the next branch-off (or exchange) waypoint where the secondary TR 73 branches off, etc. As can be seen, in this example, all branch-off (or exchange) waypoints are also drop-off waypoints, but this is not a must. To this existing set of TRs 70, 71, 72 and 73, now the new TBTE 75 shall be added. The new TBTE 75 may in particular be a not-assigned TBTE as in step 604 of FIG. 6.

FIG. 7b illustrates a first attempt for inclusion of the new TBTE 75, in particular into secondary TR 71 resulting in a modified secondary TR 71′. However, this inclusion would exceed the load capacity of the TE that conducts the secondary TR 71, and thus is dismissed.

FIG. 7c illustrates a second attempt for inclusion of the new TBTE 75, in particular into secondary TR 73 resulting in a modified secondary TR 73′. However, this inclusion would exceed meet the load/time restrictions, but would result in a rather long modified secondary TR 73′, and thus is dismissed.

FIG. 7d illustrates a third attempt for inclusion of the new TBTE 75, in particular into secondary TR 72 resulting in a modified secondary TR 72′. However, this inclusion would violate the time restrictions, and thus is dismissed. The time restrictions of the drop-off positions of secondary TR 72′ are given in square brackets in FIG. 7d and indicate that the first and second drop-offs have to take place between 6 and 7 o'clock, while the third drop-off has to take place between 1 and 5 o'clock, which is not compatible with the previous drop-offs in the secondary TR 72′.

FIG. 7e illustrates a fourth attempt for inclusion of the new TBTE 75, in particular into the main TR 70 resulting in a modified main TR 70′. This inclusion works both with respect to the load capacity of the TE 2 associated with the modified main TR 70′ as well as with all time constraints, and is this considered as the “cheapest insert” solution.

As already indicated, there exists an alternative to the bottom-up clustering approach of FIG. 6, which is illustrated by the flowchart 800 of FIG. 8 and represents an example method of the fifth aspect of the invention. This method may for instance be performed by apparatus 20 (FIG. 2), in particular by clustering unit 211 thereof, and/or routing system 4 (FIG. 1).

In a first step 801, a plurality of secondary TRs is determined, each comprising respective waypoints that are associated with either a respective pick-up position or a respective drop-off position of one or more respective TBTEs 3 from a plurality of TBTEs 3.

In a second step 802, one or more main TRs are determined, each comprising, as respective waypoints, either a respective start position or a respective end position of one or more of said secondary TRs and thus being connected with these one or more secondary TRs.

In a third step 803, for each of the one or more main TRs, those TBTEs 3 having either their pick-up position or their drop-off position associated with a waypoint of a secondary TR connected to the respective main TR are assigned to a respective one of said one or more clusters.

This approach is particularly advantageous in e.g. grocery scenarios with small drop-off time windows, large pick-up transfer entities and few pick-up depots.

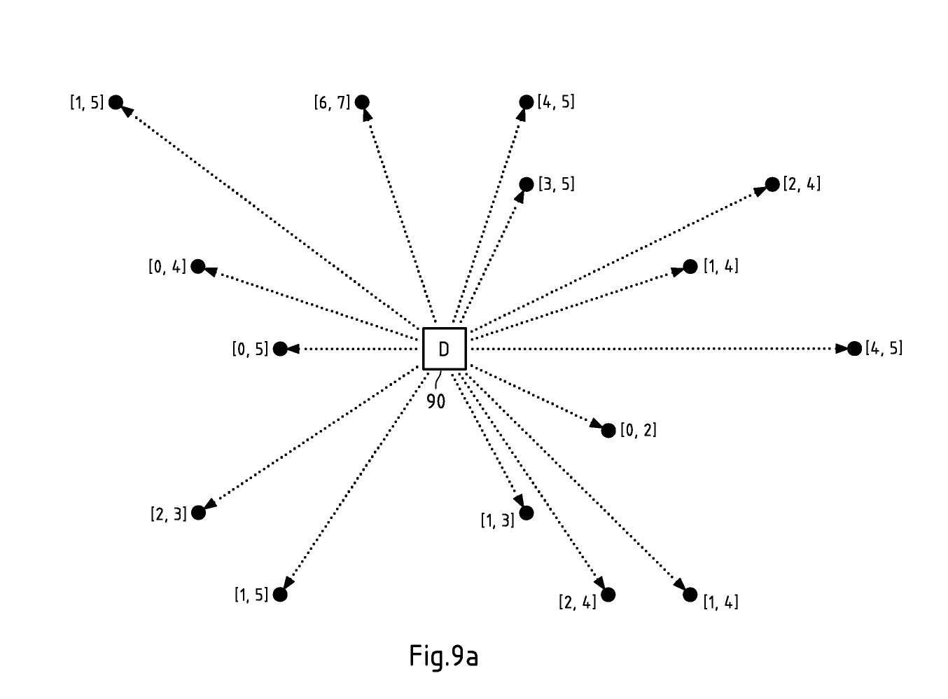

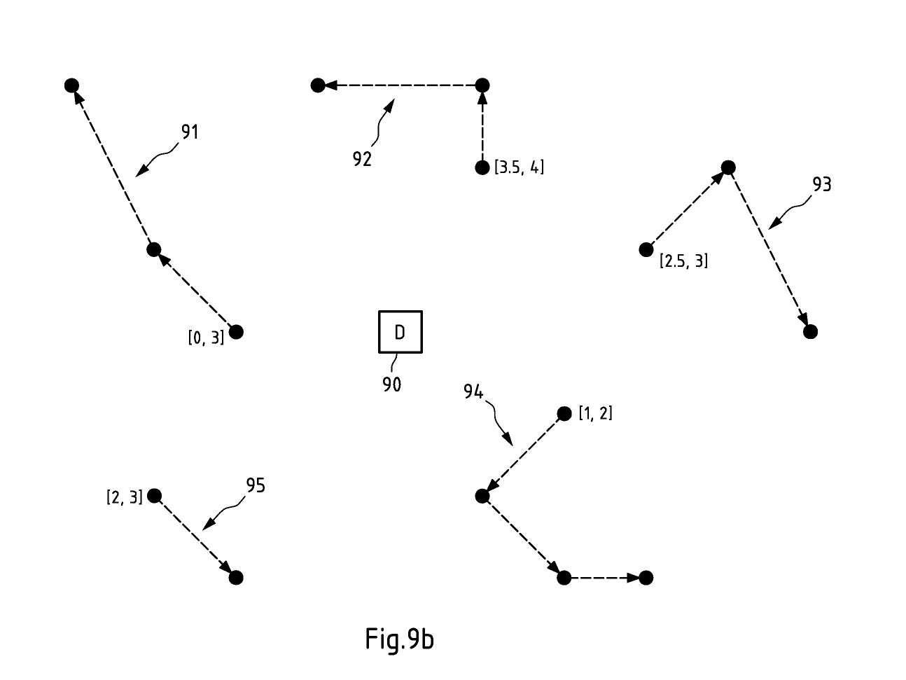

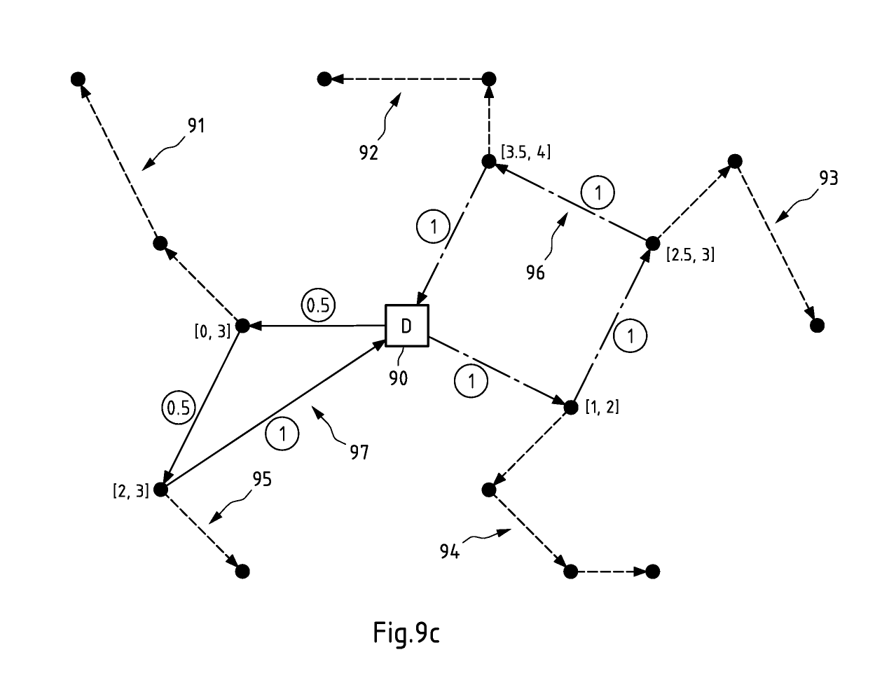

FIGS. 9a-9c show examples for the application of the clustering method of FIG. 8 to a plurality of TBTEs 3.

In FIG. 9a, a depot 90, representing the pick-up position for a plurality of TBTEs 3 of which only the respective drop-off positions, each with an associated drop-off time constraint in square brackets, is given, yet without any TRs.

FIG. 9b then shows the result of the application of step 801: A plurality of secondary TRs 91, 92, 93, 94 and 95 have been determined, each respectively comprising, as waypoints, respective drop-off positions of some of the TBTEs 3. At the start position of each of the secondary TRs, a time constraint is given that indicates in which time window this secondary TR has to be started so that the time constraints of its waypoints can all still be met.

Based on these respective start points and the associated time constraints, then, according to step 802 of FIG. 8, two main TRs 96 (dash-dotted line), 97 (solid line) are determined that have these start points as waypoints. This is illustrated in FIG. 9c. Main TR 96 supplies secondary TRs 94, 93 and 92 with TBTEs 3, and main TR 97 supplies secondary TRs 91 and 95 with TBTEs 3. Therein, the time it takes a TE 2 to follow a portion of a main TR is indicated by a respective number in a circle, respectively.

The main TR 96 and its connected secondary TRs 94, 93 and 92 form a first cluster of TBTEs (according to step 803 of FIG. 8), and the main TR 97 and its connected secondary TRs 91 and 95 form a second cluster of TBTEs (according to step 803 of FIG. 8).

FIG. 10a-10c shows an example for a transformation of a single TR (or a segment thereof) into a main TR and a couple of secondary TRs according to the sixth aspect of the invention. An algorithm for accomplishing this has already been discussed above in the context of the sixth aspect of the invention. It may for instance be deployed in the further optimization step that has been discussed with reference to step 604 of FIG. 6 above, or as part of the post-optimization 503 of FIG. 5, in particular in the intra-cluster optimization.

In FIG. 10a, the single TR 100 with a plurality of waypoints t₀ . . . t₁₇ is shown.

In FIG. 10b, the result of the secondary TR partitioning algorithm applied to the TR 100 of FIG. 10a up to position t₁₀ (i.e. j=10) is shown: a main TR 101 with three secondary TRs 102, 103 and 104.

In FIG. 10c, the result of the secondary TR partitioning algorithm applied to the TR 100 of FIG. 10a up to position t₁₇ (i.e. j=17) is shown: a main TR 105 with five secondary TRs 102, 106, 1107, 108 and 109. The main TR 105 may then for instance be associated with (e.g. conducted by) a TE 2 with larger capacities, and the secondary TRs 102, 106, 107, 108 and 109 may then for instance be associated with TEs with smaller load capacities.

From FIGS. 10a-10c, it can nicely be seen how the algorithm depends on the stage (waypoint tⱼ) up to which the optimization is considered. The final solution for j=17 (FIG. 10c) does for instance not comprise waypoints t₅, t₆ and t₁₀ on the main TR, while the intermediate solution for j=10 (FIG. 10b) did. It should be noted that, in the examples of FIGS. 10b and 10c, all waypoints of the main TR are branch-off waypoints for secondary TRs, this is however not mandatory, there could for instance be pick-up or drop-off waypoints that are not branch-off waypoints, for instance also several of them in sequence not being intermitted by secondary TR branch-off waypoints.

FIGS. 11a and 11b show an example for an exchange of waypoints (also denoted as merging herein) between a first TR and a second TR according to the seventh aspect of the invention. Such a waypoint exchange/merging may for instance be applied in sub-step 504 of FIG. 5 and may further contribute to improve the quality of the set of one or more TRs determined in steps 302 and 402 of FIGS. 3 and 4.

In FIG. 11a, two (main) TRs 110 and 111 are illustrated, which are closely situated and partially cross each other. By introducing a merging/exchange waypoint M, where the two TEs 2 respectively associated with TR 110 and TR 111 can respectively exchange at least some of their TBTEs 3, it becomes possible to define two new TRs, TR 113 for one of the TEs 2 and TR 114 for the other of the TEs 2, as shown in FIG. 11b. Both TRs 113 and 114 now comprise a mixture of waypoints that were previously exclusively assigned to either TR 110 or TR 111. It can be readily seen that the lengths of both TRs 113 and 114 is significantly shorter than the length of previous TRs 110 and 111, so that the energy consumption and pollution caused by the TRs has significantly been reduced. The TRs 113 and 114 may for instance be obtained by determining a single TR for all waypoints of the TRs 110 and 111 of FIG. 11a and then selecting a suited merging/exchange waypoint M that cuts the single TR into the two TRs 113 and 114.

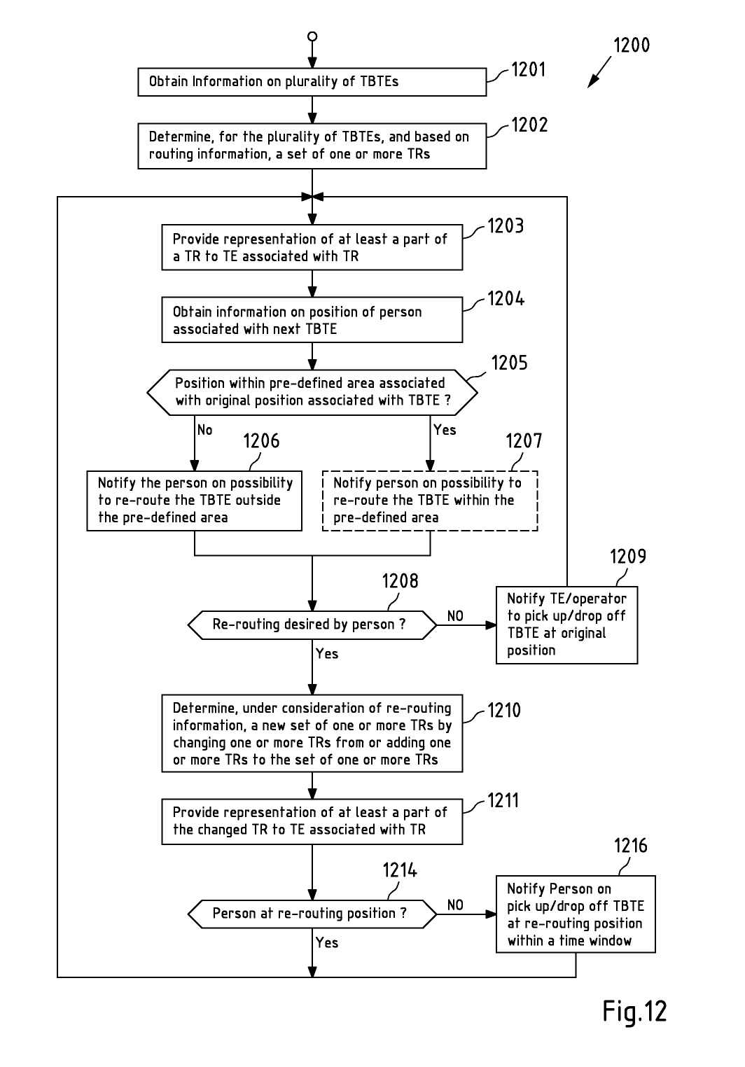

FIG. 12 is a flowchart 1200 showing an example embodiment of a method according to the ninth aspect of the invention. This method may for instance be performed by apparatus 20 (FIG. 2) and/or routing system 4 (FIG. 1) and constitutes a variant of the method of FIG. 4.

The first steps 1201 and 1202 correspond to the steps 401 and 402 of FIG. 4.

In a step 1203, a representation of at least a part of a TR (determined in step 1202) is provided (e.g. transmitted) to a TE 2 associated with the TR. For instance, information on the next waypoint (e.g. the next stop) may be provided to the TE 2.

In step 1204, information on a position of a person (e.g. customer 9 of FIG. 1) associated with a TBTE is obtained, e.g. from positioning server 8 (FIG. 1), e.g. based on an identifier of the person (that was e.g. provided by the person). Alternatively, the position of the TBTE itself (e.g. of a passenger) could be obtained, but this alternative is not further pursued in this exemplary flowchart

In step 1205, it is checked whether the obtained position is within a pre-defined area associated with an original position associated with the TBTE 3. The pre-defined area may for instance be a “geo-fence” around the original position. The original position may be the position that was associated with the TBTE 3 when the information on the TBTE 3 was obtained in step 1201.

If the obtained position is found to be not within the pre-defined area, step 1206 is carried out, and the person is notified (e.g. via his/her mobile device, e.g. mobile device 900 of FIG. 1) that a possibility for re-routing the TBTE 3 to another position outside the pre-defined area is possible.

If the obtained position is found to be within the pre-defined area, optional step 1207 is carried out, and the person is notified (e.g. via his/her mobile device, e.g. mobile device 900 of FIG. 1) that a possibility for re-routing the TBTE 3 to another position within the pre-defined area is possible. If step 1207 is not present, the flowchart would directly proceed to step 1208 instead.

In step 1208, it is checked if re-routing is desired by the person, for instance by checking if an according re-routing request has been received from the person. If this is not the case, TE 2 or an operator thereof may be notified to pick up or drop off the TBTE at the original position.

Otherwise, in step 1210, under consideration of the re-routing information (e.g. received with the re-routing request according to step 1208), a new set of one or more TRs is determined by changing one or more TRs from or adding one or more TRs to the set of one or more TRs (already determined in step 1202).

For instance, if the re-routing position is within the pre-defined area, the (already determined) TR of the TE 2 would potentially only be changed, for instance by replacing the changing the position of the waypoint associated with the original position to a waypoint associated with the re-routing position. A TSP algorithm may then for instance be used to optimize the changed route.

If the re-routing position is not within the pre-defined area, a slight change of the (already determined) TR of the TE 2 would potentially not be sufficient to still account for the re-routing position. Consequently, the determining in step 1210 may require the clustering algorithm (in particular the “cheapest insert” component thereof, see steps 602-604) to be run to determine to which cluster the re-routing position should be assigned. If the cluster has been identified (an existing cluster or a new one), optionally a TSP algorithm and/or a secondary TR partitioning algorithm may be run to further improve the solution. Even further, optional post-optimization and/or merging may be applied to further improve the quality of the TRs.

In step 1211, then a representation of at least a part of the changed TR (e.g. information on the next waypoint thereof) is provided to the TE 2. This changed TR may either comprise a waypoint associated with the re-routing position (as pick-up/drop-off position) or not. In the former case, TE 2 is responsible for the pick-up or drop-off. Otherwise, another TE 2 will be provided with a representation of at least a part of an accordingly changed or new TR and will handle the pick-up or drop-off. In the following, it is assumed that the TE 2 to which the representation of at least a part of the TR was provided in step 1203 also receives, in step 1211) the representation of at least a part of the changed TR, the re-routing position did not cause the TBTE 3 to be assigned to another TE 2.

In step 1214, it is checked if the person associated with the TBTE 3 is present at the re-routing position.

If this is the case, pick-up or drop-off takes place.

If this is not the case, in step 1216, the person is notified, e.g. via his/her mobile device, that pick-up or drop-off of the TBTE at the re-routing position is intended, optionally with an indication of a time window in which the TE or its operator can still be found at the re-routing position.

In both cases, the flowchart 1200 then returns to step 1203, where then a representation of at least a part of the TR to the TE 2 takes place, for instance the next waypoint of the TR as changed in step 1210.

The flowchart 1200 thus implements a kind of “stop-to-stop-routing”, where the TE 2 responsible for a TR is provided with the respectively next waypoint of the route and checks, e.g. before reaching this next waypoint, if a person associated with a TBTE 3 that is associated with this next waypoint is within a geo-fence of this waypoint and whether the person wants to re-route the TBTE 3 or not. If desired by the person, re-routing takes place. The TE 2 is then provided with the possibly changed next waypoint towards the re-routing position, or within another waypoint if the re-routing causes the re-routing position to be removed from the TE's TR. This approach increases the success probability of first-time pick-up/drop-off attempts.

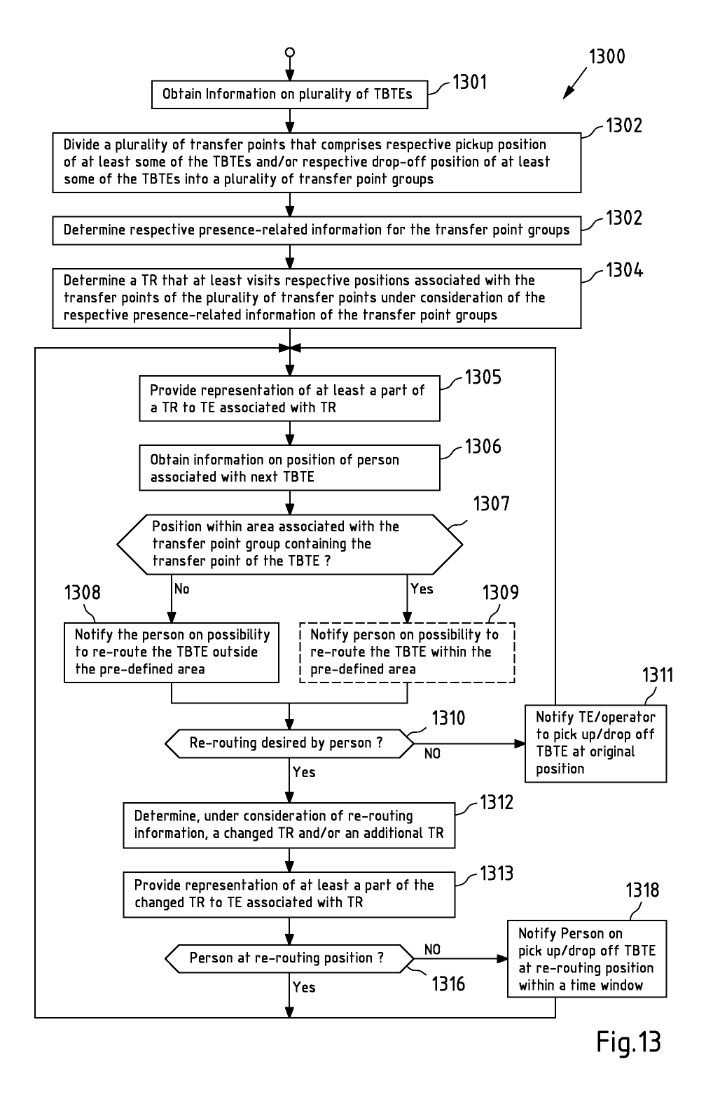

FIG. 13 is a flowchart showing an example embodiment of a method according to the tenth aspect of the invention. This method may for instance be performed by apparatus 20 (FIG. 2) and/or routing system 4 (FIG. 1).

In a first step 1301, information on a plurality of TBTEs is obtained (e.g. received from administration system 5 (FIG. 1)). In a step 1302, the plurality of transfer points that comprises respective pick-up positions of at least some of the TBTEs and/or respective drop-off positions of at least some of the TBTEs is divided into a plurality of transfer point groups (e.g. by using a clustering algorithm). The transfer point groups may for instance be formed based on a closeness of their pick-up/drop-off positions and/or based on timing constraints associated with the TBTEs.

In step 1303, then respective presence-related information for the transfer point groups is determined. This may involve determining a current position of respective persons associated with the TBTEs at the pick-up and/or drop-off positions or in an area associated with the transfer point group to which the pick-up/drop-off positions pertain. The presence-related information of a transfer point group is for instance indicative of the percentage of persons that are considered to be present at the respective pick-up/drop-off positions associated with the respective transfer points of the transfer point groups or in an area associated with the transfer point groups. For instance, a presence-related information amounting to 100% may indicate that for all transfer points of a transfer point group, the respectively associated persons are considered to be present at the respective pick-up/drop-off positions or in an area associated with the transfer point group, and in case of 50%, only for half of the transfer points, the respectively associated persons are considered to be present at the respective pick-u/drop-off positions or in an area associated with the transfer point group.

In step 1304, then a TR that at least visits respective positions associated with the transfer points of the plurality of transfer points under consideration of the respective presence-related information of the transfer point groups is determined (e.g. by using a TSP algorithm). This may involve putting positions of transfer points of transfer points groups with a higher presence-related information earlier in TRs than positions of transfer points of transfer points groups with a lower presence-related information.

In a step 1305, a representation of at least a part of a TR (determined in step 1304) is provided (e.g. transmitted) to a TE 2 associated with the TR. For instance, information on the next waypoint (e.g. the next stop) may be provided to the TE 2.

In step 1306, information on a position of a person (e.g. customer 9 of FIG. 1) associated with a TBTE 3 is obtained, e.g. from positioning server 8 (FIG. 1), e.g. based on an identifier of the person (that was e.g. provided by the person). Alternatively, the position of the TBTE itself (e.g. of a passenger) could be obtained, but this alternative is not further pursued in this exemplary flowchart

In step 1307, it is checked whether the obtained position is within an (e.g. pre-defined) area associated with the transfer point group containing the transfer point of the TBTE 3 (e.g. the transfer point that is associated with the next waypoint of the TR). The area may for instance be an area that comprises all transfer points of the transfer point group. Alternatively, it may be checked whether the obtained position is within a pre-defined area associated with the transfer point, e.g. within a pre-defined distance from the transfer point

If the obtained position is found to be not within the area, step 1308 is carried out, and the person is notified (e.g. via his/her mobile device, e.g. mobile device 900 of FIG. 1) that a possibility for re-routing the TBTE 3 to another position outside the area is possible.

If the obtained position is found to be within the area, optional step 1309 is carried out, and the person is notified (e.g. via his/her mobile device, e.g. mobile device 900 of FIG. 1) that a possibility for re-routing the TBTE 3 to another position within the area is possible. If step 1309 is not present, the flowchart would directly proceed to step 1310 instead.

In step 1310, it is checked if re-routing is desired by the person, for instance by checking if an according re-routing request has been received from the person (the person may for instance use an app on its mobile device (e.g. mobile device 900) to send such a request). If this is not the case, TE 2 or an operator thereof may be notified to pick up or drop off the TBTE at the pick-up/drop-off position of the transfer point.

Otherwise, in step 1312, under consideration of the re-routing information (e.g. received with the re-routing request according to step 1310), a changed TR and/or an additional TR is determined (by changing a TR determined in step 1304 or creating a new TR).

For instance, if the re-routing position is within the area, the (already determined) TR of the TE 2 would potentially only be changed, for instance by replacing the changing the position of the waypoint associated with the original position to a waypoint associated with the re-routing position. A TSP algorithm may then for instance be used to optimize the changed route.

If the re-routing position is not within the area, a slight change of the (already determined) TR of the TE 2 would potentially not be sufficient to still account for the re-routing position. Consequently, the determining in step 1312 may require the clustering algorithm (in particular the “cheapest insert” component thereof, see steps 602-604) to be run to determine to which cluster the re-routing position should be assigned. If the cluster has been identified (an existing cluster or a new one), optionally a TSP algorithm and/or a secondary TR partitioning algorithm may be run to further improve the solution. Even further, optional post-optimization and/or merging may be applied to further improve the quality of the TRs.

In step 1313, then a representation of at least a part of the changed TR (e.g. information on the next waypoint thereof) is provided to the TE 2. This changed TR may either comprise a waypoint associated with the re-routing position (as pick-up/drop-off position) or not. In the former case, TE 2 is responsible for the pick-up or drop-off. Otherwise, another TE 2 will be provided with a representation of at least a part of an accordingly changed or new TR and will handle the pick-up or drop-off. In the following, it is assumed that the TE 2 to which the representation of at least a part of the TR was provided in step 1305 also receives, in step 1313) the representation of at least a part of the changed TR, the re-routing position did not cause the TBTE 3 to be assigned to another TE 2.

In step 1316, it is checked if the person associated with the TBTE 3 is present at the re-routing position.

If this is the case, pick-up or drop-off takes place.

If this is not the case, in step 1318, the person is notified, e.g. via his/her mobile device, that pick-up or drop-off of the TBTE at the re-routing position is intended, optionally with an indication of a time window in which the TE or its operator can still be found at the re-routing position.

In both cases, the flowchart 1300 then returns to step 1305, where then a representation of at least a part of the TR to the TE 2 takes place, for instance the next waypoint of the TR as changed in step 1312.

The flowchart 1300 thus again implements a kind of “stop-to-stop-routing”, where the TE 2 responsible for a TR is provided with the respectively next waypoint of the route and checks, e.g. before reaching this next waypoint, if a person associated with a TBTE 3 that is associated with this next waypoint is within a certain geo-fence and whether the person wants to re-route the TBTE 3 or not. If desired by the person, re-routing takes place. The TE 2 is then provided with the possibly changed next waypoint towards the re-routing position, or within another waypoint if the re-routing causes the re-routing position to be removed from the TE's TR. These measures already increase the success probability of first-time pick-up/drop-off attempts similar as in the flowchart 1200 of FIG. 2. However, to even further increase this success probability and to reduce the amount of re-routing requests, presence of persons associated with the TBTEs 3 at the pick-up/drop-off positions (or an area associated with these positions) is considered when determining the basic TR (step 1304) that then may be subject to changes due to re-routing requests (step 1312). Avoidance of re-routing requests further contributes to reduce the computational complexity and leads to shorter and more energy-efficient TRs.

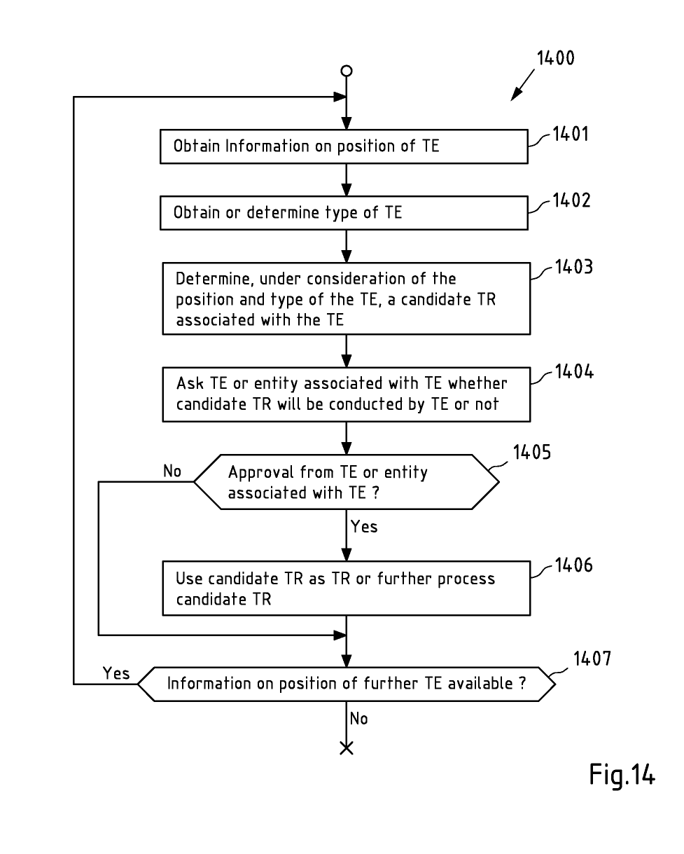

FIG. 14 is a flowchart showing an example embodiment of a method according to the eleventh aspect of the invention. This method may for instance be performed by apparatus 20 (FIG. 2) and/or routing system 4 (FIG. 1).

Flowchart 1400 may for instance represent step 302 of FIG. 3 or one or both of steps 402 and 405 of FIG. 4.

In a first step 1401 of flowchart 1400, information on a position of a TE 2 is obtained. This position may be provided by positioning server 8 (FIG. 1), e.g. based on cell-based positioning (where an infrastructure element of a cellular radio communication system reports a position based on one or more cells a mobile device operating according to the cellular radio communication system is currently associated with) or based on a position estimate provided by the TE 2 to the positioning server 8. Alternatively, the position (estimate) may be provided by the TE 2 to the routing system 4 itself, e.g. via a wireless connection. This may take place regularly, or whenever a position of the TE 2 changes significantly, or upon request.

In step 1402, then a type of the TE 2 is either determined, e.g. based on velocity information (e.g. derived from plural position estimate with associated timestamps) and/or sensor (e.g. a gyroscope and/or acceleration sensor) information that may for instance be provided by the TE 2 (either to positioning server 8 or to the routing system 4 itself), or obtained, e.g. from the TE 2 or from a device associated with the TE 2 (e.g. a device 200c of an operator 20c of TE 2c (FIG. 1)). The type of the TE may for instance be truck, van, car, motorbike/scooter, bicycle, person, for instance. Each type may be associated with a respective load capacity, i.e. how many TBTEs or up to which weight TBTEs can be transported by the TE 2. Alternatively, the type may be expressed by the load capacity itself.

In step 1403, then under consideration of the position and type of the TE, a candidate TR associated with the TE 2 is determined (e.g. as part of a set of one or more TRs as already described above). The position and type of the TE 2 may for instance be considered in the determining of the TR when possibilities for branching off a TR from a main TR are explored (e.g. in the further optimization possible in step 604 of FIG. 6), since such branching-off presupposes that a suited (e.g. with respect to load capacity and/or with respect to the type of roads available, e.g. narrow roads or roads forbidden for fossil-fuelled TEs 2) TE 2 is available in the vicinity of the branch-off position to take care of the secondary TR. Additionally or alternatively, the position and type of the TE 2 may be considered when searching for merging/waypoint exchange opportunities between TRs (see sub-step 504 of FIG. 5).

In step 1404, the TE 2 (e.g. TE 2d) or an entity (e.g. operator 2a or 20c) associated with the TE 2 is asked whether the candidate TR will be conducted by the TE 2 or not (this may be accomplished via wireless communication between the TE 2 or a device associated with the TE 2 and the routing system 4 (FIG. 1)).

Accordingly, in step 1405, if an approval from the TE 2 or the entity associated with the TE 2 is received, in step 1406, the candidate TR is used as TR (i.e. at least partially provided to the TE 2, etc.), or further processed (e.g. optimized).

In step 1407, it is then checked if information on a position of a further TE 2 is available. If not, the flowchart terminates. If yes, the flowchart jumps to step 1401, and the flowchart 1400 starts anew by obtaining a position of the further TE 2.

It should be noted that the flowchart 1400 may alternatively obtain respective positions and obtain/determine several respective types of TEs 2 for several TEs 2 in parallel, and may then considers their positions and types jointly when determining a TR (or several TRs) in step 1403.

The process in the flowchart 1400 allows to dynamically and more flexibly deploy TEs 2, e.g. for secondary TRs and/or merged TRs, which contribute to reduced length of TRs. In particular, TEs with small load capacities, such as bicycles 2c or persons 2d (FIG. 1) can be flexibly deployed for pick-up/drop-off positions in area that have traffic restrictions or are otherwise hardly accessible, such as for instance one-way roads, blocked city centres, backyards, etc.

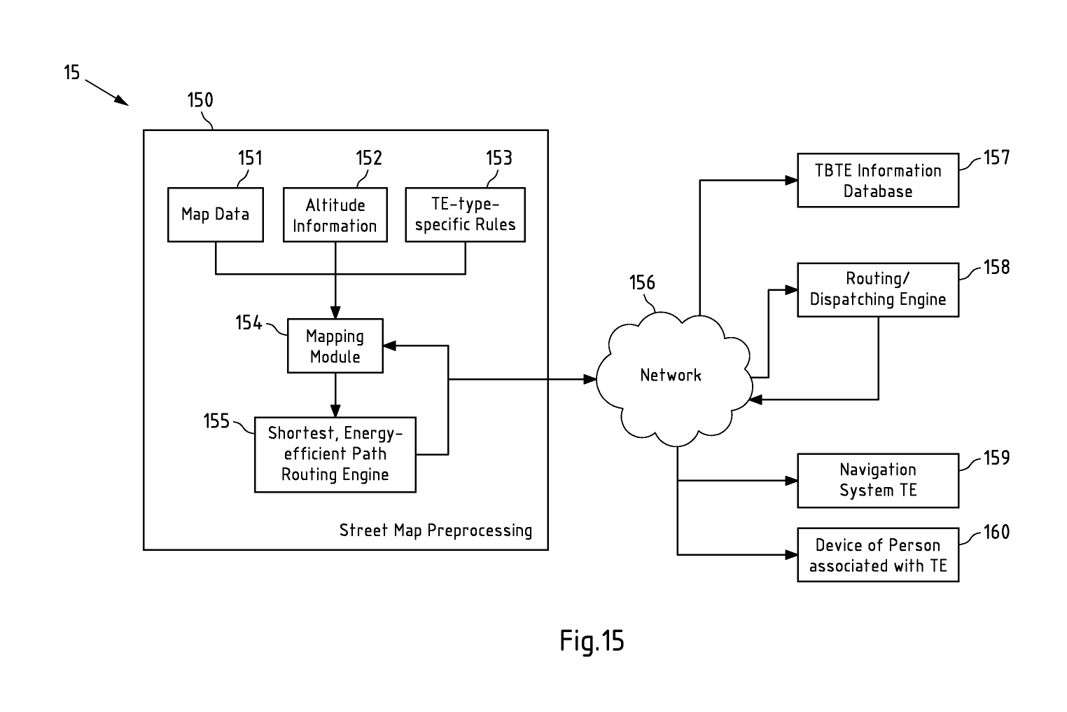

FIG. 15 is a schematic block diagram showing functional blocks of a system 15 according to the twelfth aspect of the invention. This method may for instance be performed by apparatus 20 (FIG. 2) and/or routing system 4 (FIG. 1). In the twelfth aspect of the invention, the TRs are determined to reduce an energy consumption and/or to increase a range of at least one TE associated with a respective TR of the set of TRs.

System 15 comprises a street map pre-processing block 150, a TBTE information database 157 (comparable to the administration system 5 of FIG. 1), a routing/dispatching engine 158 configured to determine a set of one or more TRs, a navigation system 159 of a TE 2 and a device 160 associated with a TE 2. Units 150 and 157-160 are communicatively connected by a network 156, e.g. the Internet

Street map pre-processing block 150 comprises a map data unit 151 storing map data, an altitude information unit 152 storing altitude information (may be integrated with the map data unit 151) and a unit 153 for storing TE-type specific rules, e.g. rules specifying that ascents or altitude differences above a pre-defined threshold should be avoided for certain types of TEs. Such rules may for instance be included into the restrictions Rₖ discussed for the fourth aspect of the invention already above. Furthermore, pre-processing block 150 comprises a mapping module 154 that receives and combines according information from units 151-153 and outputs TE-specific map information to the shortest/energy-efficient path routing engine 155. The information provided from mapping module 154 to routing engine 155 may for instance be the graph GkT already described above. Based on this information, routing engine 155 determines, according to the optimization criterion “shortest route with low energy consumption” (for instance corresponding to the optimization criterion “shortest route avoiding ascents and/or altitude changes above respective pre-defined thresholds”), a matrix D with characteristic values for the respectively optimized routes between any two points t₁, t₂ of a set T of points t, wherein each point t is a pick-up and/or drop-off position of a TBTE. Alternatively, ascents and/or altitude information may not be considered in the optimization, but nevertheless information on the (e.g. average or maximum ascent/altitude difference) of the route between points t₁, t₂ provided in matrix D. The set T may for instance be provided to routing engine 155 via network 156 from routing/dispatching engine 158 or TBTE information database 157. Routing engine 155 may then for instance provide the matrix D with the characteristic values (e.g. length of the route from t₁ to t₂, ascent of the route from t₁ to t₂, and/or altitude difference of the route from t₁ to t₂) for the respectively optimized routes between any two points t₁, t₂ to routing engine 158, to be used in the determining of the set of one or more TRs. As already stated, matrix D may not only comprise information for one respectively optimized route between any pointes tᵢ, t₂, but also two or more differently optimized route to allow for more degrees of freedom in the determining of the actual TRs by routing/dispatching engine 158.

For instance, in routing/dispatching engine 158, TRs may be determined under consideration of an optimization criterion that considers both the current weight of the TE 2 (including all TBTEs 3 currently contained in the TE 2) and the ascent and/or altitude information of each segment of the route (wherein a segment for instance corresponds to a route between two points t₁, t₂ with related characteristic values taken from matrix D, accordingly). A metric for the optimization criterion may for instance be defined as the product of the current weight of the TE 2 at a route segment and the ascent or altitude difference associated with this route segment. For an entire TR, the respective metrics for the segments would then be added, and the smaller the resulting sum metric would be, the more preferred (e.g. less energy-consuming) the TR would be. This may for instance results in TRs where large ascents or altitude changes only occur when the load of the TE 2 is low, e.g. at the end of a TR. The length information could also be reasonably be included into the metric for the optimization criterion to account for the fact that a short TR with a high ascent or altitude difference may nevertheless be more energy-efficient than a long route with small ascents or altitude changes. Alternatively, the length of a route could be considered in path routing engine 155 by attempting to find a shortest route or at least a shortest route that avoids ascents or altitude differences above respective pre-defined thresholds.

Ascent information may for instance be available for each edge of the base graph, or may be derived from altitude information associated with the nodes of the base graph. Altitude difference information may for instance be derived from altitude information available for the nodes of the base graph, or from information on an ascent of an edge and the distance between the points that are connected by the edge.

The TR determined in routing/dispatching engine is then provided to navigation system 159 of TE 2 (e.g. for presentation to the operator of TE 2, or to cause the TE 2 to drive autonomously or semi-autonomously according to this TR), or to device 160 for presentation to the person associated with the TE 2 to cause the person to steer the TE 2 according to the TR.

In the specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only exemplary, and that any feature presented for a particular example embodiment may be used with any aspect of the invention on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program) may also be used in a corresponding manner in an example embodiment of any other category. It should also be understood that presence of a feature in the presented example embodiments shall not necessarily mean that this feature forms an essential feature of the invention and cannot be omitted or substituted.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The invention has been described above by means of example embodiments. It should be noted that there are alternative ways and variations which are obvious to a skilled person in the art and can be implemented without deviating from the scope of the appended claims.

The following example embodiments of the invention are further disclosed:

### Embodiment 1

A method for routing, performed by one or more apparatuses, the method comprising:
obtaining information on a plurality of to-be-transported entities that are each associated with a respective pick-up position and a respective drop-off position;
determining, for the plurality of to-be-transported entities and based on routing information, a set of one or more transport routes, each of the transport routes of the set of transport routes associated with a respective transport entity and defining a respective sequence of waypoints, wherein the set of transport routes is determined to at least fulfil a criterion that, for each of the to-be-transported entities of the plurality of to-be-transported entities, the pick-up position and drop-off position are associated with respective waypoints of the same respective transport route of the set of transport routes or the pick-up position is associated with a respective waypoint of one transport route of the set of transport routes and the drop-off position is associated with a respective waypoint of another transport route of the set of transport routes that is directly connected or connected via one or more other transport routes of the set of transport routes with the one transport route; and
providing respective representations of at least a part of the transport routes of the set of one or more transport routes to the respective transport entities associated with the transport routes of the set of transport routes or to respective devices associated with the respective transport entities, in particular to cause that the transport entities follow or are operated, by respective operators, to follow the respective transport routes of the set of transport routes.

### Embodiment 2

The method according to embodiment 1, further comprising:
obtaining further information;
determining, under consideration of the further information, a new set of one or more transport routes by changing one or more transport routes of the set of one or more transport routes and/or by adding one or more transport routes, each associated with a respective transport entity and defining a respective sequence of waypoints, to the set of one or more transport routes;
providing at least respective representations of at least a part of the one or more changed transport routes and/or of the one or more added transport routes to the respective transport entities associated with the one or more changed transport routes and/or the one or more added transport routes or to respective devices associated with the respective transport entities.

### Embodiment 3

The method according to embodiment 2, wherein new set of one or more transport routes is determined while one or more transport routes of the set of transport routes have already begun and not yet ended.

### Embodiment 4

The method according to any of the embodiments 2-3, wherein the further information comprises
information on one or more further to-be-transported entities that are each associated with a respective pick-up position and a respective drop-off position,
change information affecting at least one to-be-transported entity of the plurality of to-be-transported entities, and/or
information for updating the routing information.

### Embodiment 5

The method according to embodiment 4, wherein the determining of the new set of transport routes is based on the updated routing information.

### Embodiment 6

The method according to any of embodiments 4-5, wherein
the plurality of to-be-transported entities and the one or more further to-be-transported entities, or
the plurality of to-be-transported entities including the at least one to-be-transported entity affected by the change information, or
the plurality of to-be-transported entities including the at least one to-be-transported entity affected by the change information and the one or more further to-be-transported entities
   constitute a new plurality of to-be-transported entities, and wherein the new set of one or more transport routes is determined for the new set of to-be-transported entities to at least fulfil a criterion that, for each of the to-be-transported entities of the new plurality of to-be-transported entities, the pick-up position and drop-off position are associated with respective waypoints of the same respective transport route of the new set of transport routes or the pick-up position is associated with a respective waypoint of one transport route of the new set of transport routes and the drop-off position is associated with a respective waypoint of another transport route of the new set of transport routes that is directly connected or connected via one or more other transport routes of the new set of transport routes with the one transport route.

### Embodiment 7

The method according to any of the preceding embodiments, wherein at least one of the to-be-transported entities is associated with one or more respective timing constraints, and wherein the set of one or more transport routes is determined to further fulfil a criterion that the one or more respective timing constraints of the at least one to-be-transported entity that is associated with one or more respective timing constraints are met

### Embodiment 8

The method according to embodiment 7 as far as it depends on embodiment 6, wherein also the new set of transport routes is determined to further fulfil a criterion that the one or more respective timing constraints of the at least one to-be-transported entity that is associated with one or more respective timing constraints are met.

### Embodiment 9

The method according to any of the preceding embodiments, wherein at least one of the transport entities has a respective limited load capacity, and wherein the set of one or more transport routes is determined to further fulfil a criterion that the respective limited load capacity of the at least one of the transport entities is not exceeded when the at least one of the transport entities conducts the respective transport route it is associated with.

### Embodiment 10

The method according to any of the preceding embodiments, further comprising:
receiving, at at least one transport entity of the transport entities associated with the transport routes of the set of transport routes, or at the respective device associated with the at least one transport entity, the respective representation of at least a part of the respective transport route associated with the at least one transport entity, and
controlling, based on the received respective representation of at least a part of the respective transport route, the at least one transport entity to follow the respective transport route, or presenting, based on the received respective representation of at least a part of the respective transport route, to a respective operator of the at least one transport entity, navigation instructions for following the respective transport route, in particular at least via a respective navigation device of the at least one transport entity.

### Embodiment 11

The method according to any of the preceding embodiments, wherein a plurality of transfer points comprises, as the transfer points, at least respective positions associated with the respective pick-up positions of the to-be-transported entities and respective positions associated with the respective drop-off positions of the to-be-transported entities, and wherein the determining of the set of one or more transport routes is based on a data structure that comprises, for each of a plurality of pairs of transfer points from the plurality of transfer points, a respective characteristic value of a respective optimized route between a respective first transfer point and a respective second transfer point of the pair of transfer points.

### Embodiment 12

The method according to embodiment 11 as far as it depends on embodiment 4, wherein the further information considered in the determining of the new set of one or more transport routes comprises the information on the one or more further to-be-transported entities and/or the change information, wherein the change information indicates that one or more to-be-transported entities of the plurality of to-be-transported entities have been assigned a respective new pick-up position and/or a respective new drop-off position, and wherein the determining of the new set of one or more transport routes is based on a new data structure, wherein the new data structure is determined by adding, to the already available data structure that is not computed anew, for each pair of transfer points of at least one additional pair of transfer points, a respective characteristic value of a respective optimized route between a respective first transfer point and a respective second transfer point of the pair of transfer points, wherein one respective transfer point of the at least one additional pair of transfer points stems from the plurality of transfer points and a respective other transfer point of the pair of transfer points stems from a set of transfer points that at least comprises a respective position associated with the respective pick-up position and a respective position associated with the respective drop-off position of the one or more further to-be-transported entities and/or a respective position associated with the respective new pick-up position and/or a respective position associated with the respective new drop-off position of the one or more to-be-transported entities that have been assigned a respective new pick-up position and/or a respective new drop-off position.

### Embodiment 13

The method according to any of the embodiments 11-12, wherein the transport routes of the set of one or more transport routes are associated with at least two different types of transport entities, and wherein the data structure is specific for one of the types of transport entities and is used at least for determining those transport routes of the set of one or more transport routes that are associated with a transport entity of this type.

### Embodiment 14

The method according to embodiment 13, wherein the data structure that is specific for one of the types of transport entities is determined based on a fourth graph (GkT) that is obtainable by applying a restriction set (Rk) that is specific for the one of the types of transport entities to a third graph (GT), wherein the third graph (GT) is obtainable from a first graph (G) by projecting the transfer points of the plurality of transfer points to respective closest edges of a largest strongly connected component (L) of a second graph (Gallrestr), in particular by subdividing the respective closest edges at respective projection points or assigning the transfer points to respective edge points of the respective closest edges, wherein the second graph (Gallrestr) is obtainable by applying a union of restriction sets to a first graph (G), each of said restriction sets being specific for a respective type of the types of transport entities (and the restriction sets including the restriction set that is specific for the one of the types of transport entities), wherein the first graph (G) is representative of map data.

### Embodiment 15

The method according to any of the preceding embodiments, wherein the determining of the set of one or more transport routes comprises
clustering the plurality of to-be-transported entities into one or more clusters so that each of the one or more clusters comprises a respective sub-set of to-be-transported entities of the plurality of to-be-transported entities,
   wherein each of the one or more clusters is associated with a respective set of one or more respective transport routes, each associated with a respective transport entity and defining a respective sequence of waypoints, wherein in case the respective set of one or more respective transport routes comprises two or more respective transport routes, each transport route of the two or more respective transport routes is connected with at least one other respective transport route of the two or more respective transport routes,
   wherein for each cluster of the one or more clusters, the respective set of one or more respective transport routes associated with the cluster at least fulfils a criterion that, for each of the to-be-transported entities of the sub-set of to-be-transported entities comprised by the cluster, the pick-up position and drop-off position are associated with respective waypoints of the same respective transport route of the set of one or more respective transport routes associated with the cluster or the pick-up position is associated with a respective waypoint of one respective transport route of the set of one or more respective transport routes associated with the cluster and the drop-off position is associated with a respective waypoint of another respective transport route of the set of one or more respective transport routes associated with the cluster that is directly connected or connected via one or more other respective transport routes of the set of one or more respective transport routes associated with the cluster with the one respective transport route, and
   wherein the transport routes of the respective sets of one or more respective transport routes associated with the one or more clusters constitute the transport routes of the set of one or more transport routes produced by the determining of the set of one or more transport routes or are considered in the determining of the set of one or more transport routes.

### Embodiment 16

The method according to embodiment 15, wherein for each cluster of the one or more clusters, the respective set of one or more respective transport routes associated with the cluster at least fulfils a further criterion that a respective load capacity of the respective transport entities associated with the respective transport routes is not exceeded when conducting the respective transport routes.

### Embodiment 17

The method according to any of embodiments 15-16 as far as it depends on embodiment 7, wherein for each cluster of the one or more clusters, the respective set of one or more respective transport routes associated with the cluster at least fulfils a further criterion that the one or more respective timing constraints of the at least one to-be-transported entity that is associated with one or more respective timing constraints are met.

### Embodiment 18

The method according to any of embodiments 15-17, wherein the clustering of the plurality of to-be-transported entities into one or more clusters comprises:
generating one or more clusters, and, for each of the one or more clusters, performing: selecting a respective to-be-transported entity of the plurality of to-be-transported entities, assigning this respective to-be-transported entity to the cluster, generating a respective transport route having respective positions associated with the pick-up and drop-off position of this respective to-be-transported entity as waypoints, and associating the respective transport route with the cluster;
for each of the remaining to-be-transported entities of the plurality of to-be-transported entities:
   checking if one or more already generated clusters exist to which the to-be-transported entity can respectively be assigned in a way
      that respective positions associated with its pick-up position and drop-off position are or become waypoints of an already generated transport route associated with the respective cluster or that a position associated with its pick-up position is or becomes a waypoint of an already generated first route associated with the respective cluster and a position associated with its drop-off position is or becomes a waypoint of a second already generated transport route associated with the respective cluster and connected directly or indirectly via one or more other already generated transport routes associated with the respective cluster to the first transport route, and
      that the respectively concerned already generated transport routes associated with the respective cluster, i.e.:
         the already generated transport route, or
         the first already generated transport route and the second already generated transport route if connected directly, or
         the first already generated transport route, the second already generated transport route and the one or more other already generated transport routes indirectly connecting the first already generated transport route and the second already generated transport route, are still considered valid when being modified to account for the to-be-transported entity;
   if the checking yields a positive result, adding the to-be-transported entity to that cluster of the one or more clusters for which it was determined that the to-be-transported entity can be assigned, according to an optimization criterion, in an optimum way, and modifying the one or more concerned already generated transport routes associated with this cluster to account for the to-be-transported entity;
   if the checking yields a negative result, generating a new cluster, assigning the to-be-transported entity to the new cluster, generating a transport route having respective positions associated with the pick-up and drop-off position of the to-be-transported entity as waypoints, and associating the transport route with the new cluster.

### Embodiment 19

The method according to embodiment 18,
wherein, if the checking yields a positive result, in addition to modifying the one or more concerned already generated transport routes associated with this cluster to account for the to-be-transported entity, the following is carried out:
determining, according to an evaluation criterion, a first quality measure for the one or more already generated and possibly modified transport routes associated with this cluster;
determining an alternative assignment of the pick-up positions and drop-off positions of all to-be-transported entities of the sub-set of to-be-transported entities comprised by this cluster to one or more transport routes, in which the one or more transport routes are considered valid, and determining, according to the evaluation criterion, a second quality measure for the one or more transport routes yield by the alternative assignment; and
if the second quality measure is better than the first quality measure, associating the one or more transport routes yield by the alternative assignment with this cluster, and keeping the association of the one or more already generated and possibly modified transport routes with this cluster otherwise.

### Embodiment 20

The method according to any of embodiments 15-17, wherein the clustering of the plurality of to-be-transported entities into one or more clusters comprises:
determining a plurality of secondary transport routes, each comprising respective waypoints that are associated with either a respective pick-up position or a respective drop-off position of one or more respective to-be-transported entities from the plurality of to-be-transported entities;
determining one or more main transport routes, each comprising, as respective waypoints, either a respective start position or a respective end position of one or more of said secondary transport routes and thus being connected with these one or more secondary transport routes;
assigning, for each of the one or more main transport routes, those to-be-transported entities having either their pick-up position or their drop-off position associated with a waypoint of a secondary transport route connected to the respective main transport route to a respective one of said one or more clusters.

### Embodiment 21

The method according to any of the preceding embodiments, wherein the set of one or more transport routes comprises or is derived under consideration of a main transport route, which is associated with a transport entity and defines a sequence of waypoints, and one or more secondary transport routes that respectively define sequences of waypoints, begin at, end at or traverse respective waypoints of the main transport route, are associated with respective transport entities that are meant to exchange, at the respective waypoints of the main transport route, one or more to-be-transported entities with the transport entity that is associated with the main transport route, and wherein the respective pick-up positions and the respective drop-off positions of the one or more to-be-transported entities are associated with respective waypoints of the main transport route or of any of the one or more secondary transport routes.

### Embodiment 22

The method according to embodiment 21, wherein the main transport route and the one or more secondary transport routes are derived from at least a portion of an already determined transport route, wherein all to-be-transported entities that had respective pick-up positions and respective drop-off positions associated with respective waypoints of the at least a portion of the already determined transport route have the respective pick-up positions now associated with respective waypoints of the main transport route or of the one or more secondary transport routes, and have the respective drop-off positions now associated with respective waypoints of the main transport route or of the one or more secondary transport routes.

### Embodiment 23

The method according to embodiment 22, wherein the at least a portion of the already determined transport route comprised n waypoints t₀, t₁, . . . , tₙ₋₁, tₙ that are either associated with a respective pick-up position of one or more of said all to-be-transported entities and/or with a respective drop-off position of one or more of said all to-be-transported entities, with n being an integer number, and wherein a derivation of the main transport route and the one or more secondary transport routes from the at least a portion of an already determined transport route comprises:
for each j=1, . . . , n, determine and store an—according to an optimization criterion—optimum solution for a main transport route and one or more secondary transport routes that handle(s) all pick-up and drop-offs of respective to-be-transported entities that were associated with t₀, t₁, . . . , tⱼ₋₁, tⱼ in the at least a portion of the already determined transport route,
   up to tⱼ₋₁ (by main transport route or by one or more secondary transport routes), the solution being denoted as Aⱼ; and
   up to tⱼ (by main transport route or by one or more secondary transport routes), the solution being denoted as Bⱼ;
wherein, to compute Aⱼ and Bⱼ, all i∈{0, . . . , j−1} are tried and then:
   Aⱼ results from
      Aᵢ and a secondary transport route handling tⱼ, . . . , tⱼ₋₁, or
      Bᵢ and a secondary transport route handling tᵢ₊₁, . . . , tⱼ₋₁ (if nonempty).
   Bⱼ results from
      Aᵢ and a secondary transport route handling tᵢ, . . . , tⱼ, or
      Aᵢ and a secondary transport route handling tᵢ, . . . , tⱼ₋₁ and the main transport route handling t₁, or
      Bᵢ and a secondary transport route handling tᵢ₊₁, . . . , tⱼ, or
      Bᵢ and a secondary transport route handling tᵢ₊₁, . . . , tⱼ₋₁ (if nonempty) and the main transport route handling

### Embodiment 24

The method according to embodiment 23, wherein at least one of said all to-be-transported entities is associated with one or more respective time constraints that have to be met, and wherein for each j=1, . . . , n, not only the—according to an optimization criterion—optimum solution for a main transport route and one or more secondary transport routes that handle(s) all pick-up and drop-offs of respective to-be-transported entities that were associated with t₀, t₁, . . . , tⱼ₋₁, tⱼ in the at least a portion of the already determined transport route is stored up tⱼ₋₁ (Aⱼ) and up to tⱼ (Bⱼ), but respective sets Aⱼ and Bⱼ of non-dominated solutions.

### Embodiment 25

The method according to embodiment 21, wherein the main transport route and the one or more secondary transport routes are obtained as follows:
determining a plurality of secondary transport routes that at least comprises said one or more secondary transport routes,
determining the main transport route as a transport route that comprises, as waypoints, either a respective start position or a respective end position of each of said one or more secondary transport routes.

### Embodiment 26

The method according to any of the preceding embodiments, wherein the determining of the set of one or more transport routes comprises:
removing, from a first already determined transport route, at least one waypoint that is associated with at least a respective pick-up or drop-off position of a respective to-be-transported entity, and making the at least one waypoint a waypoint of a second already determined transport route while keeping the waypoint's association with the respective pick-up or drop-off position of the respective to-be-transported entity, and
if at least one of the at least one waypoint is associated with one of a respective pick-up position and a respective drop-off position of a respective to-be-transported entity and the other one of the respective pick-up position and the respective drop-off position remains associated with a respective waypoint of the first already determined transport route, allowing the respective to-be-transported entity to be exchanged between a first transport entity associated with the first transport route and a second transport entity associated with the second transport route at a joint exchange waypoint that is selected or newly created in both the first transport route and the second transport route.

### Embodiment 27

The method according to any of the preceding embodiments, wherein the determining of the set of one or more transport routes comprises:
pre-clustering two or more positions that are respective pick-up positions of one or more to-be-transported entities of the plurality of to-be-transported entities and/or respective drop-off positions of one or more to-be-transported entities of the plurality of to-be-transported entities into a local cluster,
   wherein, in the determining of the transport routes of the set of transport routes, a single position associated with the local cluster is then used rather than the individual two or more positions.

### Embodiment 28

The method according to any of the embodiments 4-27, wherein the further information at least comprises the change information affecting the at least one to-be-transported entity of the plurality of to-be-transported entities, wherein the change information is representative of a new position to which an original position, which is the pick-up position or the drop-off position associated with the at least one to-be-transported entity, has been changed, and/or of a new timing constraint to which an original timing constraint associated with the at least one to-be-transported entity has been changed, wherein the method further comprises, before the obtaining of the further information:
determining or learning that a position, which is a position of a person associated with the at least one to-be-transported entity or is a position of the at least one to-be-transported entity itself, is not within a pre-defined area associated with the original position; and
   wherein the obtaining of the further information comprises receiving or establishing the new position and/or the new timing constraint.

### Embodiment 29

The method according to embodiment 28, wherein the new position and/or the new timing constraint is received or established after it has been learned, in response to an inquiry, that the original position and/or the original timing constraint shall be changed.

### Embodiment 30

The method according to any of the embodiments 28-29, wherein the original position is the pick-up position, and wherein the person associated with the at least one to-be-transported entity is a person that provides the at least one to-be-transported entity for pick-up, or wherein the original position is the drop-off position, and wherein the person associated with the at least one to-be-transported entity is a person to which the at least one to-be-transported entity shall be provided.

### Embodiment 31

The method according to any of the preceding embodiments, wherein the determining of the set of one or more transport routes comprises:
dividing a plurality of transfer points that comprises respective pick-up positions of at least some of the to-be-transported entities and/or respective drop-off positions of at least some of the to-be-transported entities, into a plurality of transfer point groups,
determining respective presence-related information for the transfer point groups, wherein the presence-related information of a transfer point group is related to presence of persons, which are or are associated with respective to-be-transported entities associated with the respective transfer points, at the respective transfer points of the transfer point group or in an area associated with the transfer point group;
determining a transport route that at least visits respective positions associated with the transfer points of the plurality of transfer points under consideration of the respective presence-related information of the transfer point groups, wherein the determined transport route is a transport route of the set of transport routes or serves as a basis for determining one or more transport routes of the set of transport routes.

### Embodiment 32

The method according to any of embodiments 2-31, as far as it depends on embodiment 2, wherein the determining of the new set of one or more transport routes comprises:
dividing a plurality of transfer points that comprises respective pick-up positions of at least some of the to-be-transported entities and/or respective drop-off positions of at least some of the to-be-transported entities, into a plurality of transfer point groups,
determining respective presence-related information for the transfer point groups, wherein the presence-related information of a transfer point group is related to presence of persons, which are or are associated with respective to-be-transported entities associated with the respective transfer points, at the respective transfer points of the transfer point group or in an area associated with the transfer point group;
determining a transport route that at least visits respective positions associated with the transfer points of the plurality of transfer points under consideration of the respective presence-related information of the transfer point groups, wherein the determined transport route is a transfer route of the new set of transport routes or serves as a basis for determining one or more transport routes of the new set of transport routes.

### Embodiment 33

The method according to any of embodiments 31-32, wherein determining respective presence-related information for the transfer point groups comprises:
determining or learning whether respective positions of the persons, which are or are associated with the respective to-be-transported entities associated with the respective transfer points of the transfer point group, are respectively within a respective pre-defined area associated with the respective transfer points of the transfer point group, or in an area associated with the transfer point group.

### Embodiment 34

The method according to embodiment 33, wherein the presence-related information of a transfer point group represents a ratio between the number of persons for which it has been determined or learned that their respective position is within the respective pre-defined area associated with the respective transfer point or with the transfer point group and the total number of transfer points of the transfer point group.

### Embodiment 35

The method according to any of the embodiments 31-34, wherein the respective presence-related information of the transfer point groups is considered in the determining of the transfer route that at least visits the transfer points of the plurality of transfer points by planning transfer points of transfer point groups having respective higher presence-related information as earlier waypoints in the transport route than transfer points of transfer point groups having respective smaller presence-related information.

### Embodiment 36

The method according to any of the embodiments 31-35, further comprising:
determining or learning that a position, which is a position of a person associated with a to-be-transported entity or is a position of the to-be-transported entity itself, is not within an area associated with one of the transfer point groups that comprises a transfer point associated with the to-be-transported entity, or is not within a pre-defined area associated with the transfer point;
receiving or establishing a new transfer point and/or a new timing constraint for the to-be-transported entity, wherein the new transfer point is either a new pick-up position or a new drop-off position for the to-be-transported entity;
determining, under consideration of the new pick-up position or the new drop-off position of the to-be-transported entity and/or the new timing constraint, a new set of one or more transport routes by changing one or more transport routes of the set of transport routes and/or by adding one or more transport routes, each associated with a respective transport entity and defining a respective sequence of waypoints, to the set of transport routes; and
providing at least respective representations of at least a part of the one or more changed transport routes and/or of the one or more added transport routes to the respective transport entities associated with the one or more changed transport routes and/or the one or more added transport routes.

### Embodiment 37

The method according to any of the preceding embodiments, wherein the determining of the set of one or more transport routes comprises:
obtaining information on a position of a transport entity;
obtaining or determining a type of the transport entity;
determining, under consideration of the position of the transport entity and the type of the transport entity, a transport route that is associated with the transport entity and defines a sequence of waypoints, wherein respective pick-up positions of one or more of the to-be-transported entities and/or respective drop-off positions of one or more of the to-be-transported entities are associated with waypoints of the transport route;
inquiring whether the transport entity or an entity associated with the transport entity accepts that the transport route is conducted by the transport entity;
   wherein the transport route, in case its conductance by the transport entity is accepted, constitutes one of the transport routes of the set of transport routes or serves as a basis for determining one or more transfer routes of the set of transfer routes.

### Embodiment 38

The method according to any of the embodiments 2-37, wherein the determining of the new set of one or more transport routes comprises:
obtaining information on a position of a transport entity;
obtaining or determining a type of the transport entity;
determining, under consideration of the position of the transport entity and the type of the transport entity, a transport route that is associated with the transport entity and defines a sequence of waypoints, wherein respective pick-up positions of one or more of the to-be-transported entities and/or respective drop-off positions of one or more of the to-be-transported entities are associated with waypoints of the transport route;
inquiring whether the transport entity or an entity associated with the transport entity accepts that the transport route is conducted by the transport entity;
   wherein the transport route, in case its conductance by the transport entity is accepted, constitutes one of the transport routes of the new set of transport routes or serves as a basis for determining one or more transfer routes of the new set of transfer routes.

### Embodiment 39

The method according to embodiment 38, wherein at least one of the one or more to-be-transported entities whose respective pick-up positions and/or drop-off positions are associated with waypoints of the transport route is directly or indirectly affected or represented by at least a part of the further information that is obtained and considered in the determining of the new set of one or more transport routes.

### Embodiment 40

The method according to embodiment 38 as far as it depends on embodiment 4, wherein at least one of the one or more to-be-transported entities whose respective pick-up positions and/or drop-off positions are associated with waypoints of the transport route is at least one of the one or more further to-be-transported entities or is at least one of the at least one to-be-transported entity affected by the change information.

### Embodiment 41

The method according to any of the preceding embodiments, wherein in the determining of the set of transport routes, at least one routing restriction is applied that targets to reduce an energy consumption and/or to increase a range of at least one transport entity associated with a respective transport route of the set of transport routes.

### Embodiment 42

The method according to embodiment 41, wherein the at least one routing restriction is specific for a type of the at least one transport entity, in particular a type of energy required for movement of the transport entity.

### Embodiment 43

The method according to any of the embodiments 41-42, wherein the routing restriction takes into account ascents, in particular with a gradient above a pre-defined threshold, and/or positive altitude differences, in particular above a pre-defined threshold, in the transport route associated with the at least one transport entity and a respective loading condition of the at least one transport entity at least during the ascents and/or during the positive altitude differences of the transport route associated with the at least one transport entity.

### Embodiment 44

The method according to any of the embodiments 41-43, wherein the at least one routing restriction requires one or more of the following:
avoiding or reducing ascents, in particular with a gradient above a pre-defined threshold, in the transport route associated with the at least one transport entity;
avoiding or reducing positive altitude differences (in particular above a pre-defined threshold), in the transport route associated with the at least one transport entity;
avoiding or reducing ascents, in particular with a gradient above a pre-defined threshold, in the transport route associated with the at least one transport entity at least when the at least one transport entity has a respective loading condition during the ascents that is above a pre-defined threshold;
avoiding or reducing positive altitude differences (in particular above a pre-defined threshold), in the transport route associated with the at least one transport entity at least when the at least one transport entity has a respective loading condition during the occurrence of the positive altitude differences that is above a pre-defined threshold;
favoring descents, in particular with a gradient above a pre-defined threshold, in the transport route associated with the at least one transport entity;
favoring descents, in particular with a gradient above a pre-defined threshold, in the transport route associated with the at least one transport entity when the at least one transport entity has a respective loading condition at the descents that is above a pre-defined threshold;
favoring negative altitude differences (in particular above a pre-defined threshold), in the transport route associated with the at least one transport entity;
favoring negative altitude differences (n particular above a pre-defined threshold), in the transport route associated with the at least one transport entity when the at least one transport entity has a respective loading condition at the negative altitude differences that is above a pre-defined threshold;
avoiding or reducing stop-and-go situations in the transport route associated with the at least one transport entity.

### Embodiment 45

A computer program, the computer program when executed by a processor causing an apparatus to perform and/or control the method of any of the preceding embodiments.

### Embodiment 46

An apparatus configured to perform and/or control or comprising respective means for performing and/or controlling the method of any of the embodiments 1-44.

### Embodiment 47

A system comprising a plurality of apparatuses, the system configured to perform and/or control or comprising respective means for performing and/or controlling the method of any of the embodiments 1-44.

### Embodiment 48

A transport entity configured to be used in a system according to embodiment 47.

### Embodiment 49

A device associable with a transport entity, the device configured to be used in a system according to embodiment 47.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for routing, performed by one or more apparatuses, the method comprising:
obtaining information on a plurality of to-be-transported entities that are each associated with a respective pick-up position and a respective drop-off position;
determining, for the plurality of to-be-transported entities and based on routing information, a set of one or more transport routes, each of the transport routes of the set of transport routes associated with a respective transport entity and defining a respective sequence of waypoints, wherein the set of transport routes is determined to at least fulfil a criterion that, for each of the to-be-transported entities of the plurality of to-be-transported entities, the pick-up position and drop-off position are associated with respective waypoints of the same respective transport route of the set of transport routes or the pick-up position is associated with a respective waypoint of one transport route of the set of transport routes and the drop-off position is associated with a respective waypoint of another transport route of the set of transport routes that is directly connected or connected via one or more other transport routes of the set of transport routes with the one transport route; and
providing respective representations of at least a part of the transport routes of the set of one or more transport routes to the respective transport entities associated with the transport routes of the set of transport routes or to respective devices associated with the respective transport entities, in particular to cause that the transport entities follow or are operated, by respective operators, to follow the respective transport routes of the set of transport routes.

2. The method according to claim 1, further comprising:
obtaining further information;
determining, under consideration of the further information, a new set of one or more transport routes by changing one or more transport routes of the set of one or more transport routes and/or by adding one or more transport routes, each associated with a respective transport entity and defining a respective sequence of waypoints, to the set of one or more transport routes;
providing at least respective representations of at least a part of the one or more changed transport routes and/or of the one or more added transport routes to the respective transport entities associated with the one or more changed transport routes and/or the one or more added transport routes or to respective devices associated with the respective transport entities.

3. The method according to claim 2, wherein the further information comprises
information on one or more further to-be-transported entities that are each associated with a respective pick-up position and a respective drop-off position,
change information affecting at least one to-be-transported entity of the plurality of to-be-transported entities, and/or
information for updating the routing information.

4. The method according to claim 1, wherein at least one of the to-be-transported entities is associated with one or more respective timing constraints, and wherein the set of one or more transport routes is determined to further fulfil a criterion that the one or more respective timing constraints of the at least one to-be-transported entity that is associated with one or more respective timing constraints are met.

5. The method according to claim 1, further comprising:
receiving, at at least one transport entity of the transport entities associated with the transport routes of the set of transport routes, or at the respective device associated with the at least one transport entity, the respective representation of at least a part of the respective transport route associated with the at least one transport entity, and
controlling, based on the received respective representation of at least a part of the respective transport route, the at least one transport entity to follow the respective transport route, or presenting, based on the received respective representation of at least a part of the respective transport route, to a respective operator of the at least one transport entity, navigation instructions for following the respective transport route, in particular at least via a respective navigation device of the at least one transport entity.

6. The method according to claim 1, wherein a plurality of transfer points comprises, as the transfer points, at least respective positions associated with the respective pick-up positions of the to-be-transported entities and respective positions associated with the respective drop-off positions of the to-be-transported entities, and wherein the determining of the set of one or more transport routes is based on a data structure that comprises, for each of a plurality of pairs of transfer points from the plurality of transfer points, a respective characteristic value of a respective optimized route between a respective first transfer point and a respective second transfer point of the pair of transfer points.

7. The method according to claim 3,
wherein a plurality of transfer points comprises, as the transfer points, at least respective positions associated with the respective pick-up positions of the to-be-transported entities and respective positions associated with the respective drop-off positions of the to-be-transported entities, and wherein the determining of the set of one or more transport routes is based on a data structure that comprises, for each of a plurality of pairs of transfer points from the plurality of transfer points, a respective characteristic value of a respective optimized route between a respective first transfer point and a respective second transfer point of the pair of transfer points,
wherein the further information considered in the determining of the new set of one or more transport routes comprises the information on the one or more further to-be-transported entities and/or the change information, wherein the change information indicates that one or more to-be-transported entities of the plurality of to-be-transported entities have been assigned a respective new pick-up position and/or a respective new drop-off position, and wherein the determining of the new set of one or more transport routes is based on a new data structure, wherein the new data structure is determined by adding, to the already available data structure that is not computed anew, for each pair of transfer points of at least one additional pair of transfer points, a respective characteristic value of a respective optimized route between a respective first transfer point and a respective second transfer point of the pair of transfer points,
wherein one respective transfer point of the at least one additional pair of transfer points stems from the plurality of transfer points and a respective other transfer point of the pair of transfer points stems from a set of transfer points that at least comprises a respective position associated with the respective pick-up position and a respective position associated with the respective drop-off position of the one or more further to-be-transported entities and/or a respective position associated with the respective new pick-up position and/or a respective position associated with the respective new drop-off position of the one or more to-be-transported entities that have been assigned a respective new pick-up position and/or a respective new drop-off position.

8. The method according to claim 6, wherein the transport routes of the set of one or more transport routes are associated with at least two different types of transport entities, and wherein the data structure is specific for one of the types of transport entities and is used at least for determining those transport routes of the set of one or more transport routes that are associated with a transport entity of this type.

9. The method according to claim 8, wherein the data structure that is specific for one of the types of transport entities is determined based on a fourth graph (GkT) that is obtainable by applying a restriction set (Rk) that is specific for the one of the types of transport entities to a third graph (GT), wherein the third graph (GT) is obtainable from a first graph (G) by projecting the transfer points of the plurality of transfer points to respective closest edges of a largest strongly connected component (L) of a second graph (Gallrestr), in particular by subdividing the respective closest edges at respective projection points or assigning the transfer points to respective edge points of the respective closest edges, wherein the second graph (Gallrestr) is obtainable by applying a union of restriction sets to a first graph (G), each of said restriction sets being specific for a respective type of the types of transport entities (and the restriction sets including the restriction set that is specific for the one of the types of transport entities), wherein the first graph (G) is representative of map data.

10. The method according to claim 1, wherein the determining of the set of one or more transport routes comprises
clustering the plurality of to-be-transported entities into one or more clusters so that each of the one or more clusters comprises a respective sub-set of to-be-transported entities of the plurality of to-be-transported entities,
wherein each of the one or more clusters is associated with a respective set of one or more respective transport routes, each associated with a respective transport entity and defining a respective sequence of waypoints, wherein in case the respective set of one or more respective transport routes comprises two or more respective transport routes, each transport route of the two or more respective transport routes is connected with at least one other respective transport route of the two or more respective transport routes,
wherein for each cluster of the one or more clusters, the respective set of one or more respective transport routes associated with the cluster at least fulfils a criterion that, for each of the to-be-transported entities of the sub-set of to-be-transported entities comprised by the cluster, the pick-up position and drop-off position are associated with respective waypoints of the same respective transport route of the set of one or more respective transport routes associated with the cluster or the pick-up position is associated with a respective waypoint of one respective transport route of the set of one or more respective transport routes associated with the cluster and the drop-off position is associated with a respective waypoint of another respective transport route of the set of one or more respective transport routes associated with the cluster that is directly connected or connected via one or more other respective transport routes of the set of one or more respective transport routes associated with the cluster with the one respective transport route, and
wherein the transport routes of the respective sets of one or more respective transport routes associated with the one or more clusters constitute the transport routes of the set of one or more transport routes produced by the determining of the set of one or more transport routes or are considered in the determining of the set of one or more transport routes.

11. The method according to claim 10, wherein the clustering of the plurality of to-be-transported entities into one or more clusters comprises:
generating one or more clusters, and, for each of the one or more clusters, performing: selecting a respective to-be-transported entity of the plurality of to-be-transported entities, assigning this respective to-be-transported entity to the cluster, generating a respective transport route having respective positions associated with the pick-up and drop-off position of this respective to-be-transported entity as waypoints, and associating the respective transport route with the cluster;
for each of the remaining to-be-transported entities of the plurality of to-be-transported entities:
checking if one or more already generated clusters exist to which the to-be-transported entity can respectively be assigned in a way
that respective positions associated with its pick-up position and drop-off position are or become waypoints of an already generated transport route associated with the respective cluster or that a position associated with its pick-up position is or becomes a waypoint of an already generated first route associated with the respective cluster and a position associated with its drop-off position is or becomes a waypoint of a second already generated transport route associated with the respective cluster and connected directly or indirectly via one or more other already generated transport routes associated with the respective cluster to the first transport route, and
that the respectively concerned already generated transport routes associated with the respective cluster, i.e.:
the already generated transport route, or
the first already generated transport route and the second already generated transport route if connected directly, or
the first already generated transport route, the second already generated transport route and the one or more other already generated transport routes indirectly connecting the first already generated transport route and the second already generated transport route,
are still considered valid when being modified to account for the to-be-transported entity;
if the checking yields a positive result, adding the to-be-transported entity to that cluster of the one or more clusters for which it was determined that the to-be-transported entity can be assigned, according to an optimization criterion, in an optimum way, and modifying the one or more concerned already generated transport routes associated with this cluster to account for the to-be-transported entity;
if the checking yields a negative result, generating a new cluster, assigning the to-be-transported entity to the new cluster, generating a transport route having respective positions associated with the pick-up and drop-off position of the to-be-transported entity as waypoints, and associating the transport route with the new cluster.

12. The method according to claim 10, wherein the clustering of the plurality of to-be-transported entities into one or more clusters comprises:
determining a plurality of secondary transport routes, each comprising respective waypoints that are associated with either a respective pick-up position or a respective drop-off position of one or more respective to-be-transported entities from the plurality of to-be-transported entities;
determining one or more main transport routes, each comprising, as respective waypoints, either a respective start position or a respective end position of one or more of said secondary transport routes and thus being connected with these one or more secondary transport routes;
assigning, for each of the one or more main transport routes, those to-be-transported entities having either their pick-up position or their drop-off position associated with a waypoint of a secondary transport route connected to the respective main transport route to a respective one of said one or more clusters.

13. The method according to claim 1, wherein the set of one or more transport routes comprises or is derived under consideration of a main transport route, which is associated with a transport entity and defines a sequence of waypoints, and one or more secondary transport routes that respectively define sequences of waypoints, begin at, end at or traverse respective waypoints of the main transport route, are associated with respective transport entities that are meant to exchange, at the respective waypoints of the main transport route, one or more to-be-transported entities with the transport entity that is associated with the main transport route, and wherein the respective pick-up positions and the respective drop-off positions of the one or more to-be-transported entities are associated with respective waypoints of the main transport route or of any of the one or more secondary transport routes.

14. The method according to claim 13, wherein the main transport route and the one or more secondary transport routes are derived from at least a portion of an already determined transport route, wherein all to-be-transported entities that had respective pick-up positions and respective drop-off positions associated with respective waypoints of the at least a portion of the already determined transport route have the respective pick-up positions now associated with respective waypoints of the main transport route or of the one or more secondary transport routes, and have the respective drop-off positions now associated with respective waypoints of the main transport route or of the one or more secondary transport routes.

15. The method according to claim 14, wherein the at least a portion of the already determined transport route comprised n waypoints t₀, t₁, . . . , tₙ₋₁, tₙ that are either associated with a respective pick-up position of one or more of said all to-be-transported entities and/or with a respective drop-off position of one or more of said all to-be-transported entities, with n being an integer number, and wherein a derivation of the main transport route and the one or more secondary transport routes from the at least a portion of an already determined transport route comprises:
for each j=1, . . . , n, determine and store an—according to an optimization criterion—optimum solution for a main transport route and one or more secondary transport routes that handle(s) all pick-up and drop-offs of respective to-be-transported entities that were associated with t₀, t₁, . . . , tⱼ₋₁, tⱼ in the at least a portion of the already determined transport route,
up to tⱼ₋₁ (by main transport route or by one or more secondary transport routes), the solution being denoted as Aⱼ; and
up to tⱼ (by main transport route or by one or more secondary transport routes), the solution being denoted as Bⱼ;
wherein, to compute Aⱼ and Bⱼ all i∈{0, . . . , j−1} are tried and then:
Aⱼ results from
Aᵢ and a secondary transport route handling tᵢ, . . . , tⱼ₋₁, or
Bᵢ and a secondary transport route handling tᵢ₊₁, . . . , tⱼ₋₁ (if nonempty).
Bⱼ results from
Aᵢ and a secondary transport route handling tᵢ, . . . , tⱼ, or
Aᵢ and a secondary transport route handling tᵢ, . . . , tⱼ₋₁ and the main transport route handling tᵢ, or
Bᵢ and a secondary transport route handling tᵢ₊₁, . . . , tⱼ, or
Bᵢ and a secondary transport route handling tᵢ₊₁, . . . , tⱼ₋₁ (if nonempty) and the main transport route handling tⱼ.

16. The method according to claim 13, wherein the main transport route and the one or more secondary transport routes are obtained as follows:
determining a plurality of secondary transport routes that at least comprises said one or more secondary transport routes,
determining the main transport route as a transport route that comprises, as waypoints, either a respective start position or a respective end position of each of said one or more secondary transport routes.

17. The method according to claim 1, wherein the determining of the set of one or more transport routes comprises:
removing, from a first already determined transport route, at least one waypoint that is associated with at least a respective pick-up or drop-off position of a respective to-be-transported entity, and making the at least one waypoint a waypoint of a second already determined transport route while keeping the waypoint's association with the respective pick-up or drop-off position of the respective to-be-transported entity, and
if at least one of the at least one waypoint is associated with one of a respective pick-up position and a respective drop-off position of a respective to-be-transported entity and the other one of the respective pick-up position and the respective drop-off position remains associated with a respective waypoint of the first already determined transport route, allowing the respective to-be-transported entity to be exchanged between a first transport entity associated with the first transport route and a second transport entity associated with the second transport route at a joint exchange waypoint that is selected or newly created in both the first transport route and the second transport route.

18. The method according to claim 1, wherein the determining of the set of one or more transport routes comprises:
pre-clustering two or more positions that are respective pick-up positions of one or more to-be-transported entities of the plurality of to-be-transported entities and/or respective drop-off positions of one or more to-be-transported entities of the plurality of to-be-transported entities into a local cluster,
wherein, in the determining of the transport routes of the set of transport routes, a single position associated with the local cluster is then used rather than the individual two or more positions.

19. The method according to claim 3, wherein the further information at least comprises the change information affecting the at least one to-be-transported entity of the plurality of to-be-transported entities, wherein the change information is representative of a new position to which an original position, which is the pick-up position or the drop-off position associated with the at least one to-be-transported entity, has been changed, and/or of a new timing constraint to which an original timing constraint associated with the at least one to-be-transported entity has been changed, wherein the method further comprises, before the obtaining of the further information:
determining or learning that a position, which is a position of a person associated with the at least one to-be-transported entity or is a position of the at least one to-be-transported entity itself, is not within a pre-defined area associated with the original position; and
wherein the obtaining of the further information comprises receiving or establishing the new position and/or the new timing constraint.

20. The method according to claim 19, wherein the new position and/or the new timing constraint is received or established after it has been learned, in response to an inquiry, that the original position and/or the original timing constraint shall be changed.

21. The method according to claim 1, wherein the determining of the set of one or more transport routes comprises:
dividing a plurality of transfer points that comprises respective pick-up positions of at least some of the to-be-transported entities and/or respective drop-off positions of at least some of the to-be-transported entities, into a plurality of transfer point groups,
determining respective presence-related information for the transfer point groups, wherein the presence-related information of a transfer point group is related to presence of persons, which are or are associated with respective to-be-transported entities associated with the respective transfer points, at the respective transfer points of the transfer point group or in an area associated with the transfer point group;
determining a transport route that at least visits respective positions associated with the transfer points of the plurality of transfer points under consideration of the respective presence-related information of the transfer point groups, wherein the determined transport route is a transport route of the set of transport routes or serves as a basis for determining one or more transport routes of the set of transport routes.

22. The method according to claim 21, wherein determining respective presence-related information for the transfer point groups comprises:
determining or learning whether respective positions of the persons, which are or are associated with the respective to-be-transported entities associated with the respective transfer points of the transfer point group, are respectively within a respective pre-defined area associated with the respective transfer points of the transfer point group, or in an area associated with the transfer point group.

23. The method according to claim 22, wherein the presence-related information of a transfer point group represents a ratio between the number of persons for which it has been determined or learned that their respective position is within the respective pre-defined area associated with the respective transfer point or with the transfer point group and the total number of transfer points of the transfer point group.

24. The method according to claim 21, wherein the respective presence-related information of the transfer point groups is considered in the determining of the transfer route that at least visits the transfer points of the plurality of transfer points by planning transfer points of transfer point groups having respective higher presence-related information as earlier waypoints in the transport route than transfer points of transfer point groups having respective smaller presence-related information.

25. The method according to claim 21, further comprising:
determining or learning that a position, which is a position of a person associated with a to-be-transported entity or is a position of the to-be-transported entity itself, is not within an area associated with one of the transfer point groups that comprises a transfer point associated with the to-be-transported entity, or is not within a pre-defined area associated with the transfer point;
receiving or establishing a new transfer point and/or a new timing constraint for the to-be-transported entity, wherein the new transfer point is either a new pick-up position or a new drop-off position for the to-be-transported entity;
determining, under consideration of the new pick-up position or the new drop-off position of the to-be-transported entity and/or the new timing constraint, a new set of one or more transport routes by changing one or more transport routes of the set of transport routes and/or by adding one or more transport routes, each associated with a respective transport entity and defining a respective sequence of waypoints, to the set of transport routes; and
providing at least respective representations of at least a part of the one or more changed transport routes and/or of the one or more added transport routes to the respective transport entities associated with the one or more changed transport routes and/or the one or more added transport routes.

26. The method according to claim 1, wherein the determining of the set of one or more transport routes comprises:
obtaining information on a position of a transport entity;
obtaining or determining a type of the transport entity;
determining, under consideration of the position of the transport entity and the type of the transport entity, a transport route that is associated with the transport entity and defines a sequence of waypoints, wherein respective pick-up positions of one or more of the to-be-transported entities and/or respective drop-off positions of one or more of the to-be-transported entities are associated with waypoints of the transport route;
inquiring whether the transport entity or an entity associated with the transport entity accepts that the transport route is conducted by the transport entity;
wherein the transport route, in case its conductance by the transport entity is accepted, constitutes one of the transport routes of the set of transport routes or serves as a basis for determining one or more transfer routes of the set of transfer routes.

27. The method according to claim 1, wherein in the determining of the set of transport routes, at least one routing restriction is applied that targets to reduce an energy consumption and/or to increase a range of at least one transport entity associated with a respective transport route of the set of transport routes.

28. The method according to claim 27, wherein the routing restriction takes into account ascents, in particular with a gradient above a pre-defined threshold, and/or positive altitude differences, in particular above a pre-defined threshold, in the transport route associated with the at least one transport entity and a respective loading condition of the at least one transport entity at least during the ascents and/or during the positive altitude differences of the transport route associated with the at least one transport entity.

29. A tangible computer readable storage medium storing a computer program, the computer program when executed by a processor causing an apparatus to perform and/or control the method of claim 1.

30. An apparatus or a system comprising a plurality of apparatuses, the apparatus or system configured to perform and/or the method of claim 1.
